(19) United States
(12) Patent Application Publication
(10) Pub. No.: US 2014/0370972 A1
(43) Pub. Date: Dec. 18, 2014

(54) METHODS AND SYSTEMS FOR ACTIVITY-BASED FUNDRAISING

(71) Applicant: SAS Games, Inc., Cocoa, FL (US)

(72) Inventors: Siobhan Marie MULLEN, Cocoa, FL (US); Stephen Patrick SCULLY, Cocoa, FL (US)

(21) Appl. No.: 14/305,870

(22) Filed: Jun. 16, 2014

Related U.S. Application Data
(60) Provisional application No. 61/835,231, filed on Jun. 14, 2013.

(51) Int. Cl. A63F 13/30

(52) U.S. Cl. CPC A63F 13/12
USPC 463/25

(57) ABSTRACT

Methods and apparatus for online fundraising may include receiving a solicited pledge. The methods and apparatus may also include receiving an indication that the pledge has been triggered. The methods and apparatus may include collecting payment of the pledge and disbursing the collected payment.

### RELATED APPLICATIONS

This application claims priority to U.S. Application No. 61/835,231 titled “Methods and Systems for Game-Based Fundraising,” filed Jun. 14, 2013, which is incorporated herein by reference in its entirety.

### BACKGROUND

During the past several decades, higher education in general, and private higher education in particular, has become increasingly more expensive and unaffordable. Federal student loans are essentially available to anyone, and institutions of higher learning, such as colleges and universities have no incentive to lower tuition costs because all students are effectively ensured to receive federal student aid. Furthermore, the United States is facing an educational crisis, particularly in the area of Science, Technology, Engineering and Math (STEM). The traditional blackboard-style of education is no longer enough to keep students' attention and interest. Students today are drawn to fast-paced technology, and specialists suggest that students benefit more from hands-on learning using computers and other advanced technology.

Nevertheless, because many students lack the necessary STEM skills, in particular, excessive college remedial work is required. Statistically, more than 70% of college students require remedial work in general. Thus, many students fail to graduate during the standard four-year course required for a Bachelor's degree, some earning their degrees in five, six, or more years. Due to a similar problem, many community college students graduate in three years or more, rather than the standard two.

Thus, college graduates leave colleges and universities with an exorbitant amount of debt. Given the state of the job market, many of them are not able to find jobs upon graduation, and are thus unable to pay off their college loans, and the amount of educational debt in this country is mounting. In addition, due to the amount of educational debt, recent college graduates are not buying first homes nor having children as early causing an impact on the economy.

There is a need in the art, therefore, for methods and systems for improving students' STEM skills. There is a further need in the art for methods and systems that provide assistance to students to raise funds for their college educations, and to help them cope with exorbitantly high tuition costs and to avoid as much educational debt as possible.

### SUMMARY

Aspects of the present invention relate to methods and systems that, among other things, provide methods and systems for improving students' STEM skills. In addition, aspects of the present invention relate to methods and systems that provide assistance to students to raise funds for their college educations and to help them cope with exorbitantly high tuition costs and to avoid as much educational debt as possible.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates an example system in accordance with an aspect of the present invention;

FIG. 2 illustrates an example method in accordance with an aspect of the present invention;

FIG. 3 illustrates an example method for creating a fundraiser in accordance with an aspect of the present invention;

FIG. 4 illustrates an example method for managing a fundraiser by an administrator in accordance with an aspect of the present invention;

FIG. 5 illustrates an example method for managing a fundraiser by a participant in accordance with an aspect;

FIG. 6 illustrates an example system in accordance with an aspect of the present invention;

FIGS. 7A-7V illustrate example participant interfaces for use with aspects of the present invention;

FIGS. 8A-8AB illustrate example administrator interfaces for use with aspects of the present invention;

FIG. 9 illustrates various features of an example computer system for use in conjunction with aspects of the present invention; and

FIG. 10 illustrates an example system diagram of various hardware components and other features for use in accordance with aspects of the present invention.

### DETAILED DESCRIPTION

Aspects of the present invention relate to methods and systems that, among other things, provide methods and systems for improving students' STEM skills. In addition, aspects of the present invention relate to methods and systems that provide assistance to students to raise funds for their college educations and to help them cope with exorbitantly high tuition costs and to avoid as much educational loan debt as possible. However, it will be understood that aspects of the present invention are directed not only to raising funds for a traditional college education, but to any type of education provided by post-secondary educational institutions, such as academies, universities, seminaries, institutes of technology, two-year colleges, vocational schools and career colleges, among other educational institutions. In fact, it will be understood that aspects of the present invention may be implemented for any type of goal-oriented savings, such as saving for a car, family vacation, home or office refurbishment, and/or down payment on a house, among other goal-oriented savings for individuals. Aspects of the present invention may also be implemented for any type of goal-oriented savings for organizations such as a children's hospital or children's medical society, among other organizations.

Aspects of the present invention relate, for example, to an activity-based fundraiser such as a gameathon, or other game contest or competition played by students via the Internet or other network, for example, during which students who have not yet entered college (e.g., elementary, middle and high school students) solicit pledges for games played from parents, grandparents, relatives and friends, among other donors. Soliciting pledges may include, but is not limited to, soliciting gifts, donations, contributions, grants and rewards, among other benefits. The gameathon may be educational, in accordance with one aspect, and may be used to improve, e.g., participants' academic skills, such as STEM skills, among others. In one variation, the gameathon may be played via Facebook® or other social media. Well-known sports personalities and other celebrities or national corporate and foundation sponsors or strategic partners may assist in promoting the gameathon, for example, to help make it popular among participants. The games and gameathon may also be played and used upon other electronic platforms such as tablets, consoles, mobile phones and other standalone or portable electronic devices.

In one aspect, the gameathon may comprise a computer-implemented fundraiser, for example. The pledged funds may be contributed to students' college savings accounts, for example. In one example aspect, participants may not be able to use the funds in the college savings accounts, unless the funds are used for furthering their education beyond the high school level. However, those of ordinary skill in the art will recognize that the pledged funds from another type of fundraiser or gameathon may also be used to finance participants' sports teams, extracurricular clubs, or schools, or various charities or foundations, among other uses. In addition, the pledged funds may be contributed to a bank account, such as a credit, checking or savings account, to an account such as a PayPal account, to the repayment of a loan, to a savings registry for distribution, to a money market account, to an investment account or to a gift card, among other types of accounts. In one aspect, the pledged funds may be split between several different accounts, such as accounts for long-term savings or immediate use, such as checking or debit accounts, for example.

In addition, the online gameathon and fundraiser, in accordance with aspects of the present invention, may attract much attention, because kids today are drawn to technology, and are interested in participating in online games, competing, winning and being rewarded. Moreover, if such a gameathon combines technology with participants' desire for competing and winning, and with educational content, it will achieve the dual goal of improving participants' academic skills, while allowing them to contribute pledged funds to their college savings accounts. As an example, the educational game may be the type of game described in U.S. Pat. Nos. 5,366,226 and 5,149,102, the entirety of each of which is incorporated by reference herein. The participants in the gameathon may play the game via a traditional board game, for example, or online over multiple platforms. However, any other game or competition may serve as the basis for the gameathon. Such other games or competitions may be education-based (e.g., based on science, history, geography, literature and spelling) or entertainment based (e.g., trivia or card games or traditional games, such as Monopoly® and Trivial Pursuit®), according to an aspect of the present invention.

In accordance with one aspect, the present invention may be implemented in any manner that requires a user to perform an online activity, such as a task, game, location check-in or other action, where proof of execution of the action may trigger collection of a pledge, gift, reward or other benefit. It should also be understood that aspects of the present invention may be implemented by a participant of any age.

In accordance with aspects of the present invention, an online web page (interchangeably referred to herein as a portal) may be provided, which allows participants to play available educational or other games or competitions, for example, to enhance their practice strategy and skills in playing the games. In addition, the web page may allow participants to participate in online competitions to compete with other participants, applying their skills and strategy to win rewards and prizes, for example. In one variation, the available educational or other games or competitions may be played in 2D or 3D. In one aspect, the available educational or other games may be played in a variety of languages. Further, the online portal may allow participants to participate in an online fundraiser, using their skills to raise funds by soliciting pledges for games played.

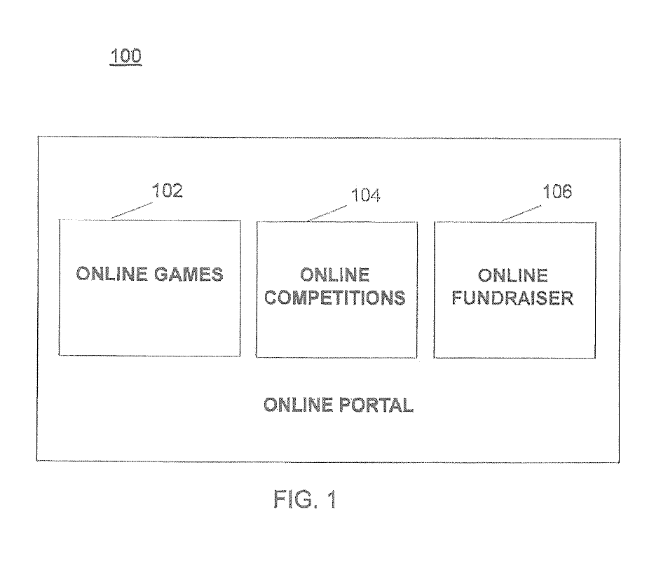

Referring now to FIG. 1, therein shown is an example system 100 in accordance with an aspect of the present invention. The system 100 comprises an online portal that has several modules 102, 104 and 106, among others. Module 102 may be configured for playing online games. Module 104 may be configured for online competitions. Module 106 may be configured to perform an online fundraiser.

The web page may provide information about how to play the available educational or other games or competitions, information on the fundraiser, promotional information, as well as information on partnerships with national sponsors, famous sports personalities, celebrities or food chains or other strategic partners, for example, among other information. Moreover, the web page may provide access to an online store, for example, for redeeming reward points and for purchasing game-related products and souvenirs, virtual products and other items. The web page may also provide access to the available educational or other games or competitions.

In accordance with one aspect, the online games or competitions available via the webpage may have a tournament structure. For example, there may be school-level competitions, local competitions, district or regional tournaments, qualifying tournaments and a championship event. In addition, the web page may provide recurring tournament challenges (e.g., on daily, weekly and monthly basis). Moreover, a reward system may be provided that allows participants to gather points, virtual funds or other incentives, such as gift cards or coupons, which may later be used to purchase game-related products and souvenirs and virtual products among other items, or to receive discounts at bookstores or on other online game sites, for example. Furthermore, participants may qualify for seats at a live-action tournament, where grand prizes such as college scholarships may be awarded. However, those of ordinary skill in the art will recognize that the online games or competitions may have a structure difference from a tournament structure.

In one variation, participants may meet at a local fast food, a casual dining restaurant, a bookstore, or library, among other locations, for live meetings to practice their game-related skills and strategy, and to prepare for tournaments. Such meetings may be organized at the school level or by parents, for example. In addition, such meetings may be organized via the online portal, where participants may select their skill level to play with other participants of a similar or different skill level at a particular partner location.

The webpage may provide participants information about games played by the participant. For example, the webpage may provide participants with game statistics, such as, a total number of games played by a participant, a win-loss record of a participant, a list of games played by a participant, an average score of a participant, a total number of perfect scores by a participant, a total number of games played by all participants, a win-loss record of all participants, a total number of perfect scores of all participants and an average score of all participants. In an aspect, the games played by a participant or all participants may be sorted, for example, by score percentage (e.g., a percentage of a maximum score possible), date played, game sheet name, game level, and game category (e.g., math, science, reading, history, geography).

In one variation, participants may be able to view how they rank against other participants via Leader Boards, for example. Rankings may be displayed as most games played, best win-loss records, most perfect scores and best participant performance (e.g., score average). The rankings of participant results may be sorted, for example, on a nationwide, statewide, county, citywide or zip code level. In one aspect, the ranking may be on a school level.

Furthermore, the webpage may provide participants, e.g., via an application, link or other mechanism, access to a module known as the fundraiser application that may be used to solicit pledges for their participation in a gameathon, for example.

In an aspect, the fundraiser may be an automated and activity-based fundraiser, such as a gameathon. A gameathon may require participants to solicit pledges from potential pledge sponsors (e.g., friends, family and neighbors) for games played in the gameathon. Once the required number of games are played by a participant, the pledges the participant received may be triggered. The gameathon system may send out a pledge payment invoice to the pledge sponsors that made pledges. When the pledge payments have been collected by the system, the system may disburse the funds to the account designated by the participant.

The web page may also provide participants information about match funding available for participants. Match funding may include, but is not limited to, donations from local, regional, state and national corporate and foundation sponsors that participants may earn based on achievements in fundraising and/or performance in game play, as well as other requirements established by the match sponsor. In an aspect, there may be two types of match funding: (1) match funding that participants are automatically eligible to receive provided that the participants meet the fundraising achievements; and (2) matching funding that participants may qualify for based on additional requirements, for example, membership in one or more organizations, a number of times a participant has frequented a sponsor's store, restaurant or other location, and/or the number of games played at a particular game level scoring above a specific percentage.

In one variation, the web page may provide information about how participants' pledges collected rank against other participants. For example, the webpage may illustrate top participants by funds collected from pledge payments. In one variation, the web page may provide information about how participants' game performance rank against other participants. For example, the web page may illustrate top participants by average score percent over all games played. The rankings may be filtered, for example, by grade level, country, state, county, citywide, or zip code. In one aspect, the ranking may be on a school level.

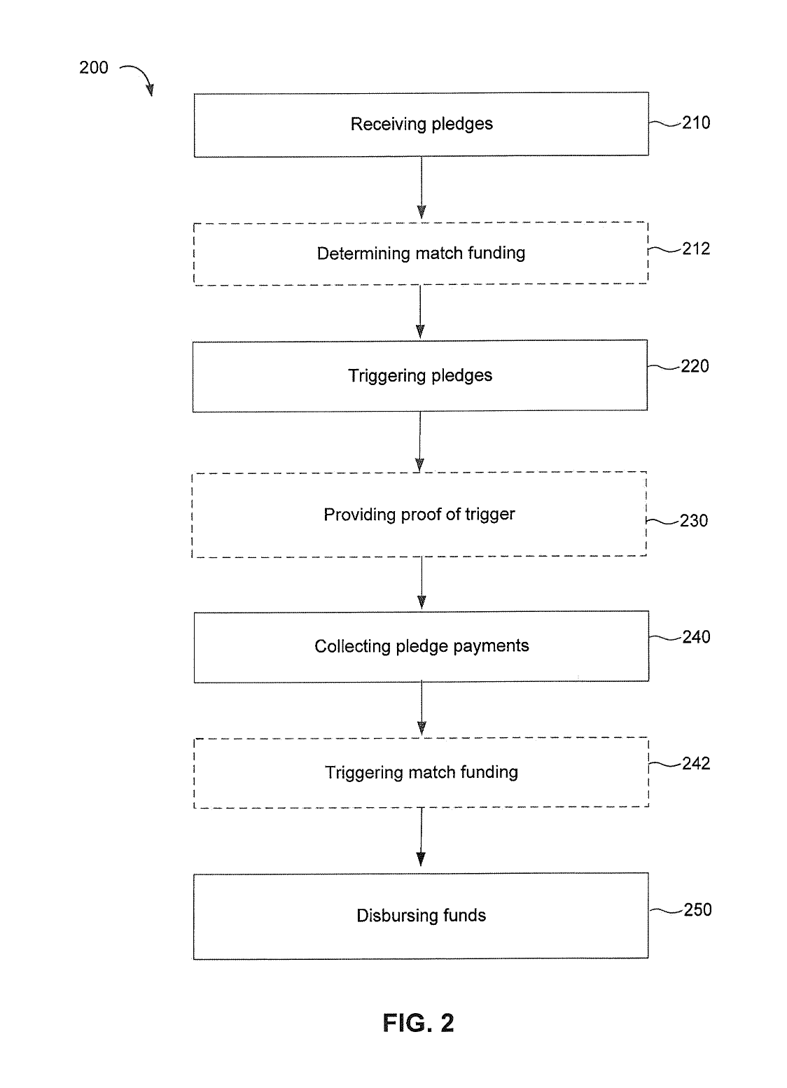

Referring now to FIG. 2, therein shown is a method 200 in accordance with aspects of the present invention. In one aspect, a player or participant may open or link a college savings account at a participating financial institution such as a bank, for example. The participant may join (e.g., for a registration or licensing fee) the gameathon fundraiser. In addition, the participant may select a username and password and may customize an avatar associated with the participant's account. The participant may then begin pledge solicitation from family, friends and neighbors, among other potential pledge sponsors. The method may include receiving pledges 210. In an aspect, participants may solicit pledges online, door-to-door, or otherwise, may input the pledge sponsors' email addresses via the website to solicit pledges through email, may solicit pledges via social media platforms (e.g. Facebook and Twitter), and may solicit pledges via text message, for example. Participants may partially or completely prepare their own pledge solicitation email or other form of message, such as a text, tweet, and/or post. Participants may also use a standard computer-generated pledge solicitation email or other form of message such as a text, tweet or post. In another aspect, a public announcement (e.g., from a known celebrity, charity organization or host sponsor), may identify the fundraising opportunity and the system may receive pledges in response to the public announcement.

The method may optionally include determining match funding 212 availability and eligibility requirements. Match funding may include, but is not limited to, donations from local, regional, state and national corporate and foundation sponsors that participants may earn based on achievements in fundraising and/or performance in game play. In one aspect, participants may be automatically eligible to receive match funding by meeting the requirement of pledge payments collected for the match funding. In another aspect, participants may be eligible for match funding by meeting the requirement of pledge payments collected for the match funding and based on, for example, membership in an organization or a school district, a geographic location (e.g., zip code, county, city, state, country or region), a number of games played at or above a participant's grade level, an average score over a certain number of games (e.g., a participant scored at least an average of 80% over ten games played at or above the participant's grade level), and/or a number of times a participant has frequented a sponsor's store or restaurant, among other requirements. In addition, the system may confirm eligibility for the match funding by receiving information, such as membership information, geographic location information, and a number of times a participant frequented a sponsor's store, restaurant, or other location (e.g., receiving “checkins” from the participant). In addition, the system may confirm eligibility for the match funding, for example, by calculating a number of games played by the participants at a particular game level or above and an average score over a certain number of games played.

In one aspect, the participant may receive a match for the received pledge payment funds. For example a match sponsor, such as a corporation or a foundation, may set conditions for providing matches. The conditions may include providing matches (e.g., full or partial matches) to the first 100 participants who play a certain number of games or to the first 50 participants to raise a preset pledge payment funds amount, for example. Those of ordinary skill in the art will recognize, however, that the match sponsor may provide any other condition for providing matches.

The method may include triggering pledges 220. In an aspect, participants may perform an online task or activity such as play the educational or other game or competition to trigger the pledges. In accordance with one aspect, the system may perform a calculation to determine how many games a participant has to play to trigger a specific pledge. When the participant has played the requisite number of games, the system may trigger the pledges received and issue a pledge payment invoice to the pledge sponsor.

The method may optionally include providing proof-of-trigger 230, which in the case of the gameathon is a proof-of-play, to the pledge sponsor along with the pledge payment invoice when the participant has played the requisite number of games. For example, the system may provide the pledge payment invoice and the optional proof-of play to the pledge sponsor via email or other mechanism, e.g., SMS message or mail, for example, indicating that the participant has played the number of games needed. The pledge sponsor may be invited to make the pledge permanent, by clicking on a link, for example. The pledge sponsor may then access a pledge payment page (or receive it via mail, for example), and may enter a credit card number or provide payment via another mechanism. In an aspect, the system may generate and send a thank you note via email or mail, for example, thanking the donor or pledge sponsor for the payment.

The method may include collecting the pledge payments 240. For example, the system may collect the pledge payments. The pledge payments may be collected, for example, online (using a credit card, a check card, check routing and account information, a paypal account or other account, for example) or via another mechanism, e.g., a mailed check or money order. In an aspect, the method may optionally include triggering match funding 242. Match funding may be determined and collected based on a time-stamp of the payment collection of the required pledge-dollar levels by the financial institution. For example, an example match funding from a sponsor may include a total of $1,000 where the first ten participants to collect $100 of pledges, based on the time-stamp of the payment collection, may receive a $100 match from the sponsor, providing the participant has also met any other match requirements set by the match sponsor. Pledge payments and matching funds may be collected and disbursed by the financial institution associated with the gameathon or by an independent payment gateway enlisted by the host organizer.

The method may also include disbursing funds 250. In an aspect, the system may disburse the pledge payment funds collected and any matching funds earned. The funds may be disbursed to a participant's college savings account or to another account designated by the participant such as a credit, checking, paypal, or money market account, for example, or to an escrow account for future disbursement or to an entity's account the participant has designated, such as for a school, sports team or charitable organization. In one variation, the participant may receive all or a portion or percentage of the funds collected. For example, the participant may receive a portion of the funds in the case when some portion is donated to a charity organization and/or is contributed to a host sponsor and is retained by the web page manager or gameathon fundraiser host organizer as a licensing, maintenance or other fee. Moreover, depending on the type of fundraiser selected, some portion of the funds not provided to the participant may be distributed to a single or multiple parties. Multiple parties may receive a portion in cases where the fundraiser has a tiered structure, for example. The tiered structure may be applicable to fundraisers having a sports league or school district structure, and the funds may be distributed in a tiered manner among the school district, each school, and each classroom in the school.

In one variation, the participant may manage the participant's own pledges, including actions such as: (a) sending/resending pledge requests; (b) viewing all pledges the participant has received; (c) determining the number of games required to trigger all pledges; (d) reviewing how many pledges have been triggered; (e) viewing all pledge payments the participant has received; (f) resending invoices for pledge payments; (g) providing eligibility for all match funds available; (h) monitoring the disbursement of all collected funds; (i) reviewing how much funds the participant or group has raised so far; and (j) viewing performance statistics of the participant or group, among other actions.

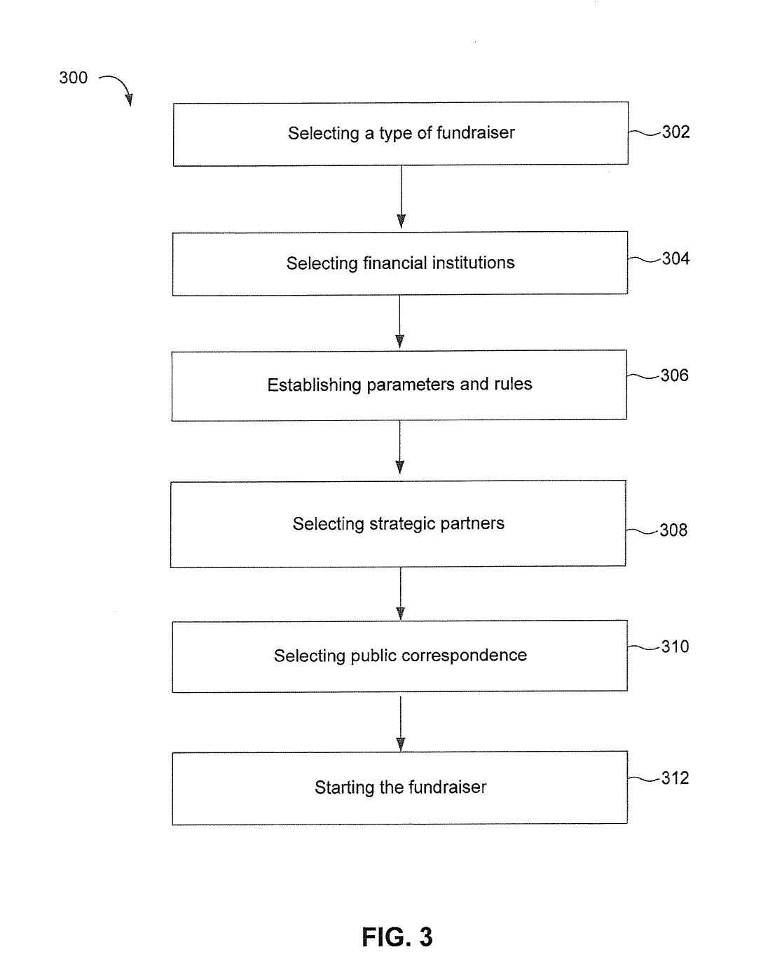

Referring now to FIG. 3, illustrated therein in an example method flow 300 for creating an activity-based fundraiser in accordance with an aspect of the present invention. For example, the activity-based fundraiser may be a gameathon. The method may include selecting a type of fundraiser for a gameathon 302. Fundraisers may include, but are not limited to, a college savings fundraiser, a goal-oriented savings fundraiser for an individual or an organization, a sports team fundraiser, a charity fundraiser, a club fundraiser, an organization fundraiser, a school fundraiser, and a multi-level or tiered fundraiser. In an aspect, an individual, such as an administrator may select a pre-existing fundraiser in the system. An administrator may include, for example, an individual executing, organizing or running the fundraiser, and/or hosting or promoting the fundraiser. In addition, the administrator may have full privileges and rights to the system or limited and/or restricted rights to the system. For example, the system may have a number of fundraisers created that an administrator may select from. In another aspect, an administrator may design a fundraiser for an organization or for the general public. In addition, the system may receive a name from an administrator for the fundraiser.

In addition, the method may include selecting financial institutions for an activity-based fundraiser that may include a gameathon 304. In an aspect, an administrator may select one or more financial institutions to receive the funds raised by participants of the gameathon. Financial institutions may include, but are not limited to, banks including online banks, investment firms, credit unions, credit cards, payment services, savings registries, and online money transfer services. For example, the administrator may select a financial institution from a list of participating financial institutions and/or search the system for a particular partner financial institution. The financial institutions may be filtered, for example, by country, state, county, city and zip code. The financial institutions may be presented by the system with a name and logo of the financial institution along with any contact information the system may have for the financial institution. The system may also allow an administrator to edit a financial institution's information, disable and/or delete a financial institution.

The system may allow an administrator to add a new financial institution. Adding a new financial institution may include inputting, for example, contact information for the financial institution, the financial institution's logo, and zip code coverage of the financial institution. In addition, an administrator may add payment gateway and API credentials for the financial institution to collect and transfer funds from the system to college savings accounts or other such accounts, savings vehicles, or organizations designated by the participant.

The method may also include establishing parameters and rules for the gameathon 306. Parameters and rules may include, but are not limited to, a start date and an end date for the gameathon, a category or type of games for the gameathon, a number of games played that a participant must achieve before triggering a pledge (e.g., a participant must play ten games to earn a $10 pledge, a participant must play five games to earn a $10 pledge), a maximum number of games required to trigger all pledges received (e.g., all pledges greater than $50 may be triggered by 25 games played), pledge amount suggestions, a minimum and maximum pledge value, a time period for sending reminders to pledge sponsors to make pledge payments, and a distribution schedule of the collected funds. The distribution of the collected funds may include, for example, determining how the total collected funds (after any processing fees have been paid) may be divided between the participant's college savings account, a charity (if applicable), a host sponsor (if applicable) and a host organization for the maintenance or licensing fees. In an aspect, the system may receive the parameters for the gameathon, for example, from an administrator.

In addition, the method may include selecting strategic partners for the gameathon 308. Partners may include individuals, corporations, foundations, charity organizations (e.g., Ronald McDonald House Charities), host sponsors (e.g., Boy Scouts), and/or other organizations that may sponsor by promoting the gameathon and/or provide match funding for the gameathon. Match funding may include, but is not limited to, donations from local, regional, state and national partners. Partners may provide requirements for the match funding, such as membership requirements, a total number of games played, a total or minimum amount of pledges collected, and a maximum number of participants that may receive the match funding. In an aspect, the system may receive the requirements for the match funding and provide an output with a total match funding available for the gameathon, including the number and amount of individual matches available. In addition, the system may output for each individual match funding provided by a sponsor, a dollar amount for the individual match funding and the requirements for the match funding. In an aspect, the system may receive requirements to reserve a percentage of the funds collected for its strategic partners. For example, the gameathon may be associated with a partner charity (e.g., Ronald McDonald House) and/or a host sponsor (e.g., Boy Scouts). The partner charity and/or the host sponsor may receive a percentage of the pledge payment and match sponsor funds collected by participants in the gameathon.

The method may also include selecting public correspondence for the gameathon 310. Public correspondence may include, but is not limited to, text, links and logos that may be presented to participants during the gameathon and/or text, links and logos that may be generated by the gameathon, particularly for pledge sponsors. The system may customize the public correspondence depending on the type of fundraiser and/or gameathon. For example, public correspondence may include welcome e-mails with instructions to register for the gameathon, e-mails that are generated and sent to pledge sponsors, instructions for using the gameathon for participants and administrators, parental consent forms for participating participants, pledge request letters, pledge thank you letters, encouragement e-mails, pledge payment request letters, pledge payment thank you letters, and a congratulatory pledge sponsor card to the participant. The system may store the public correspondence associated with the gameathon.

The method may include starting the fundraiser 312. For example, the system may start a gameathon for the fundraiser upon receiving the gameathon information from the administrator by making it accessible for the participants.

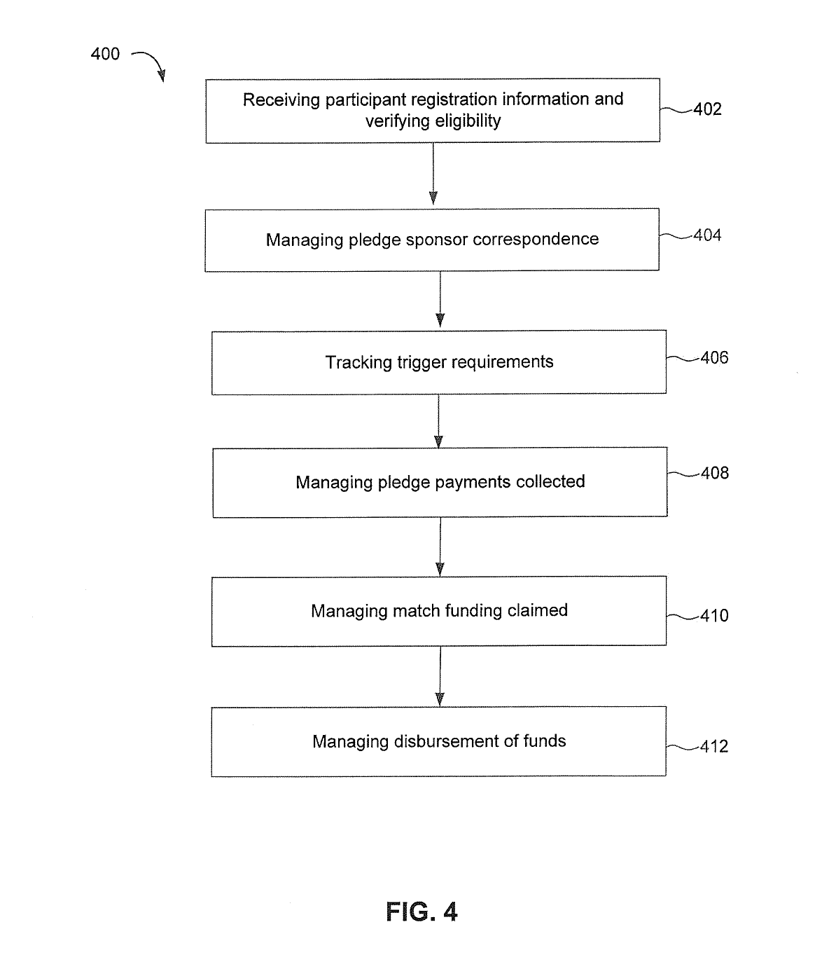

Referring now to FIG. 4, illustrated therein is an example method flow 400 for managing a gameathon in accordance with an aspect of the present invention. In an aspect, the system may manage the gameathon based on the received parameters and rules of the fundraiser. In addition, an individual, such as an administrator may use the administrator portal to manage a single gameathon, to manage a plurality of gameathons, and/or to manage all gameathons occurring on the system. The system may, for example, display information about all gameathons and/or the system may filter the gameathons by country, state, county, city, and zip code so that an administrator may easily track the gameathons or portion of the gameathons.

The method may include receiving participant registration information and verifying eligibility for the gameathon 402. In an aspect, the system may receive a participant's registration information and verify the participant's eligibility for the gameathon. The system may receive, for example, a user name and password for a participant, a registration fee and/or a promotion code (e.g., to waive or reduce the registration fee), parent contact information, and college savings or other account information for the participant. The administrator may receive a report from the system with the registered participants. In addition, the administrator may use the system to edit and/or update a participant's account information.

The method may also include managing pledge sponsor correspondence 404. In an aspect, the system may allow the administrator to select and customize the pledge sponsor correspondence depending on the type of gameathon or fundraiser. For example, the administrator may use the system to provide text, links and logos for the pledge sponsor correspondence and/or edit pledge sponsor correspondence stored on the system. By customizing the pledge sponsor correspondence, the number of pledges for each participant for a particular gameathon may be optimized.

The system may also provide the administrator with a summary of the pledge requests sent by participants in the gameathons. For example, the summary may include a total number of pledge requests sent out by participants and the total number and amount of pledges received. In an aspect, the system may perform a calculation to determine the number of games required to trigger each pledge for all participants in all gameathons and to trigger all pledges for all participants in all gameathons.

In addition, the method may include tracking trigger requirements for the gameathon 406. For example, the system may track the trigger requirements for each participant in all gameathons by presenting the number of games required to trigger all pledges, the number of games already played, and the number and amount of pledges triggered by the games already played. Once a pledge has been triggered by the games played requirement, the system may send the pledge sponsor a pledge payment invoice and a proof-of-play report notifying the pledge sponsor that the participant has met the game play requirement to trigger his pledge. In an aspect, the administrator may receive a report from the system summarizing the total number of games played by the participants and the total number of pledges triggered by the games played. If a discrepancy occurs between a number of games played and triggering a pledge, the administrator may use the system to reach a resolution for the discrepancy. For example, the administrator may update a proof-of-play report and/or generate and send a pledge payment invoice notifying the pledge sponsor that the participant has met the game play requirements to trigger the pledge.

The method may also include managing pledge payments collected by the gameathon 408. In an aspect, the system may provide an administrator a summary of the pledge payments invoiced and/or pledge payments collected by the gameathon. For example, the summary may include the total pledge payments invoiced and the total pledge payments collected from the pledges for participants in the gameathons. In addition, pledge payments invoiced may be for pledges that have been triggered by participants that have played a required number of games to trigger the funds pledged (e.g., an invoice has been sent to the pledge sponsor). The system may designate the pledge payment funds as pending once the pledge invoice and proof-of-play have been transmitted to the pledge sponsor. If the pledge payment has not been made within a predetermined period of time, the system may designate the pledge payment as past due and may automatically resend the pledge payment invoice prior to the end of the gameathon. The administrator may receive a report from the system summarizing the pledge payments invoiced and the total pledge payments collected. In addition, the administrator may use the system to resend the pledge payment invoices prior to the end of the gameathon.

The summary may also include how the funds may be distributed, for example, between the participants' college savings accounts, a host sponsor, a charity organization, and a host organization for the licensing or maintenance fees. The system may calculate the portion of pledge payment funds for each participant that will be distributed for each entity.

The method may also include managing match funding claimed for the gameathon 410. The system may allow an administrator to view all match funding available for all participants across all gameathons or across a specific gameathon. The system may provide an administrator with a match funding summary, for each match sponsor for each gameathon and for all gameathons, with the total match funds available, the number and amount of an individual match, an amount of total match funding claimed by participants, and an amount of total match funding, if any, that remains unclaimed. For example, the administrator may receive a report with the match funding available, the matching funding claimed and the matching funding unclaimed for the gameathons.

In addition, the administrator may use the system to add a new sponsor to the system. Adding a new sponsor may include, for example, a zip code range or geography area that the matches may cover, and any rules for a participant to obtain an individual match. Rules for a participant to obtain an individual match may include, but are not limited to, a number of participants that may receive a match, a value of an individual match, an amount of funds a participant may need to collect before a match may be earned, and game play performance, among other requirements.

In an aspect, the system may automatically award a participant an individual match funding when the participant achieves the requirements for a particular match fund. For example, the system may automatically update a participant's fundraising account with the match funding pledged and collected. In addition, the system may automatically update the match fund summary for the match sponsors indicating an amount of match funding collected by the participant. The system may automatically transfer the funds from the sponsor's account or other account to the financial institution associated with the participant's account for disbursement to the participant's college savings account. For example, the administrator may receive a report from the system summarizing the match funding collected by the participants. If a discrepancy occurs with the match funding, e.g., a participant should have received the match funding but the system did not automatically update the match fund, the administrator may use the system to provide the match funding to the participant, to update the participant's fundraising account, and/or to resolve the discrepancy.

Optionally, the method may also include managing charity organization, host sponsor, or host organization information. For example, the system may allow an administrator to manage any charity organizations associated with the gameathons. Charity organizations may include an established charity (e.g., Ronald McDonald House, Wounded Warriors) or particular host sponsor organizations of which the participants are members (e.g., Junior Achievement, 4H, and Scouts). For example, the administrator may use the system to edit and/or delete a charity or host sponsor organization. In addition, the administrator may use the system to add a charity or host sponsor organization and select a percentage of funds the charity and/or host sponsor organization may receive from the participants in a gameathon.

The method may also include managing disbursement of funds for the gameathon 412. For example, the system may transfer the collected pledge payment funds and/or the claimed matching funds to the participant's account, the charity organization account, the host sponsor account, and/or the host organization account for licensing or maintenance fees according to the percentage each account receives. In an aspect, the system may communicate with the payment gateway of the financial institution to provide the financial institution with each participant's and organization's name, account information, and an amount of funds to transfer. The administrator may receive a fund deposit report from the system where the administrator may view all the funds pledged and invoiced and of that what amount has been collected and deposited in the various accounts. In addition, the administrator may use the system to resolve any discrepancies that may arise in the disbursement of funds.

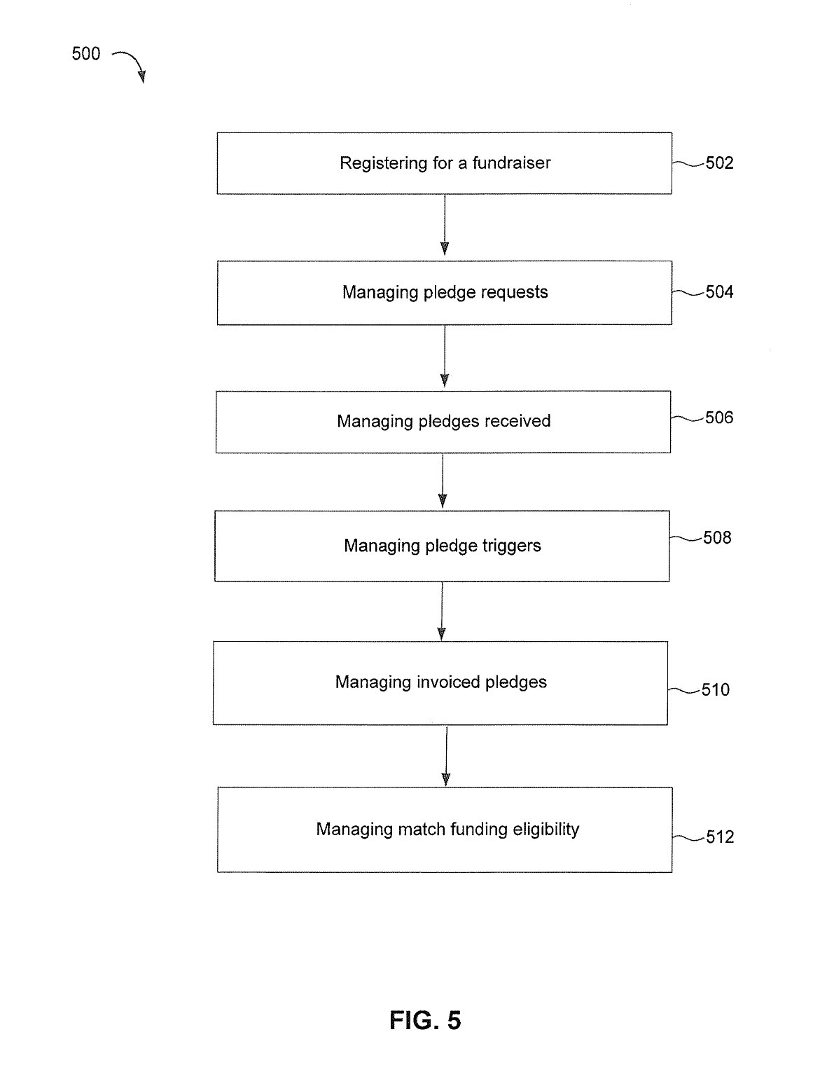

Referring now to FIG. 5, illustrated therein is an example method flow 500 for managing a fundraiser in accordance with an aspect of the present invention. For example, an individual, such as a participant may use the online component to manage a fundraiser, such as a single gameathon.

The method may include registering for a fundraiser 502. For example, the system may allow the participant to register for a fundraiser. In an aspect, the participant may use the system to register for a gameathon fundraiser. The participant may select a username and password and may customize an avatar associated with the participant's account. In addition, the participant may create a profile with information, such as, but not limited to, the participant's name, age, grade level, gender, and parent or guardian contact information.

In an aspect, after a participant registers for a gameathon, a participant may open a college savings account or other account with a partner financial institution or may link an existing college savings account or other account associated with a partner financial institution to the participant's gameathon, so the funds raised during the gameathon may be automatically deposited into the participant's savings account or other account. For example, the system may direct the participant to an interface where the participant may open a college savings account or other account with a partner financial institution. In addition, the system may allow the participant to link an existing college savings account or other account associated with a partner financial institution to the gameathon.

The method may include managing pledge requests 504. For example, the system may allow the participant to manage pledge requests to maximize the number of pledges the participant may receive. The participant may use the system to personalize pledge request correspondence and/or identify potential pledge sponsors. The participant may also use the system to send pledge requests to potential pledge sponsors at any time during his fundraiser. In addition, the participant may use the system to resend pledge requests to individuals who have not made pledges.

The method may also include managing pledges received 506. In an aspect, the system may allow a participant to manage the pledges received. For example, the system may provide the participant with a summary of the pledges received including pledge information, such as, but not limited to, pledge date, pledge dollar amount, last name of the pledge sponsor, and trigger status. As such, the user may use the system to identify a number of pledges received and a number of games required to trigger the pledges made.

In addition, the method may include managing pledge triggers 508. For example, the system may allow a participant to manage pledge triggers for pledges received. In an aspect, the pledge triggers may include a number of games the participant may need to play to trigger the pledges received. The system may provide a participant with a report indicating a total number of games the participant has played, a total number of games the participant needs to play to trigger pledges made, a score of the games played, and a level of the games played. The participant may use the report generated by the system to maximize the amount of funds the participant is eligible to receive by playing the required number of games to trigger the pledges made.

The method may include managing invoiced pledges 510. In an aspect, the system may provide a participant with a pledge invoice report summarizing a number of pledges made, an amount pledged, funds invoiced, funds collected, and amounts past due. The participant may use the pledge invoice report to manage invoiced pledges by resending pledge payment requests to the pledge sponsors who have not yet made pledge payments. In addition, the participant may view the pledges that are past due and may use the system to continually resend reminders to the pledge sponsors that have past due invoices.

The method may also include managing match funding 512. For example, the system may provide the participant with eligibility requirements for match funding and the participant may use the system to determine any match funding the participant may be eligible to receive. In addition, the participant may use the system to enter in the required information to become eligible for the match funding. As such, the participant may use the system to maximize the match funding the participant may receive by verifying eligibility for the match funding, playing a required number of games to trigger the match funding, meeting any additional requirements set by the match sponsor, and being among the first to collect a required amount of funds to receive the match funding.

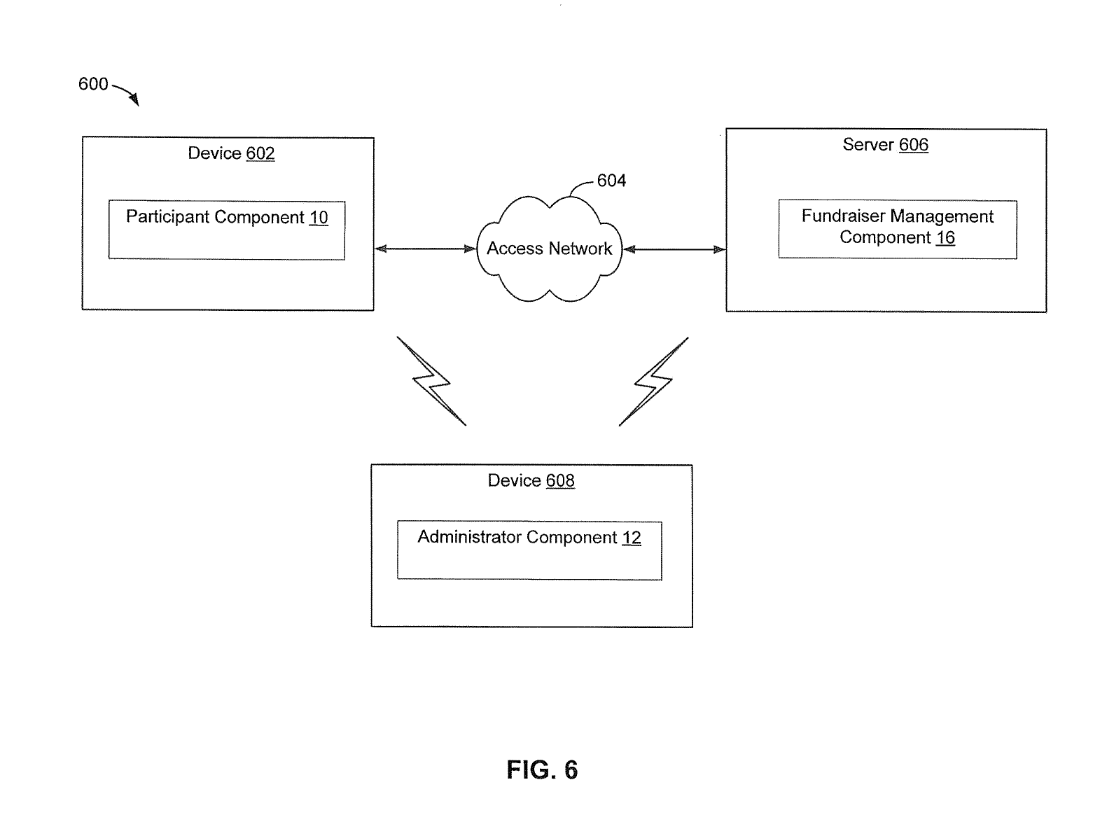

Referring now to FIG. 6, illustrated therein is an example connectivity system 600 in accordance with an aspect of the present invention. System 600 may include one or more devices 602 and 608 communicating through one or more access networks 604 with one or more servers and/or computing devices 606. Devices 602 and 608 may include, for example, a cellular telephone, a navigation system, a computing device, a camera, a personal digital assistant (PDA), a music device, a gaming device or a handheld device having wireless connection or wired capability, among other devices. Server/computing device 606 may include any mobile or fixed computing device coupled to a network. Sever/computing device 606 may include, but is not limited to, a computing device, a server, a cellular telephone, a camera, a PDA, a music device, a gaming device, a navigation system, or a handheld device having wireless connection capability, among other devices. Furthermore, access network 604 may provide one or more types of communication connections or other couplings, such as any suitable type of wireless airlink, to devices 602, 608 and server 606.

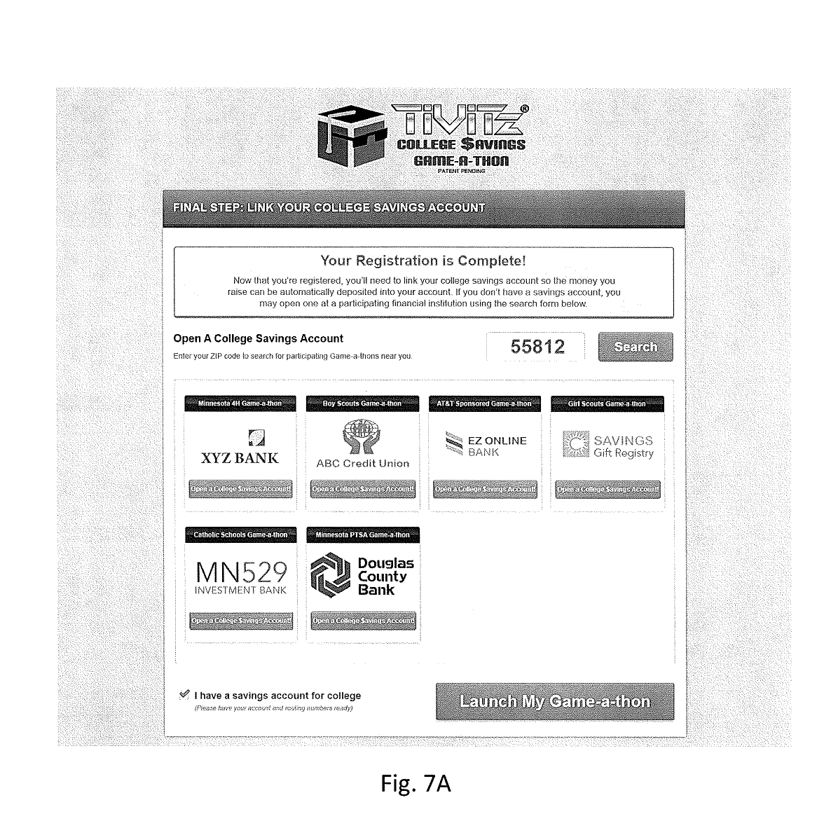

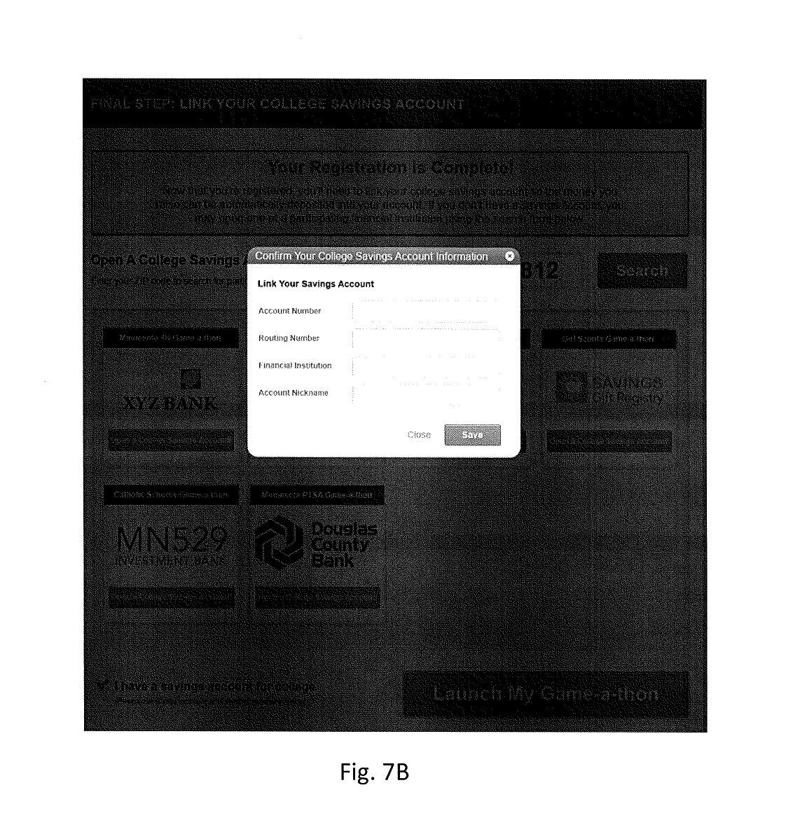

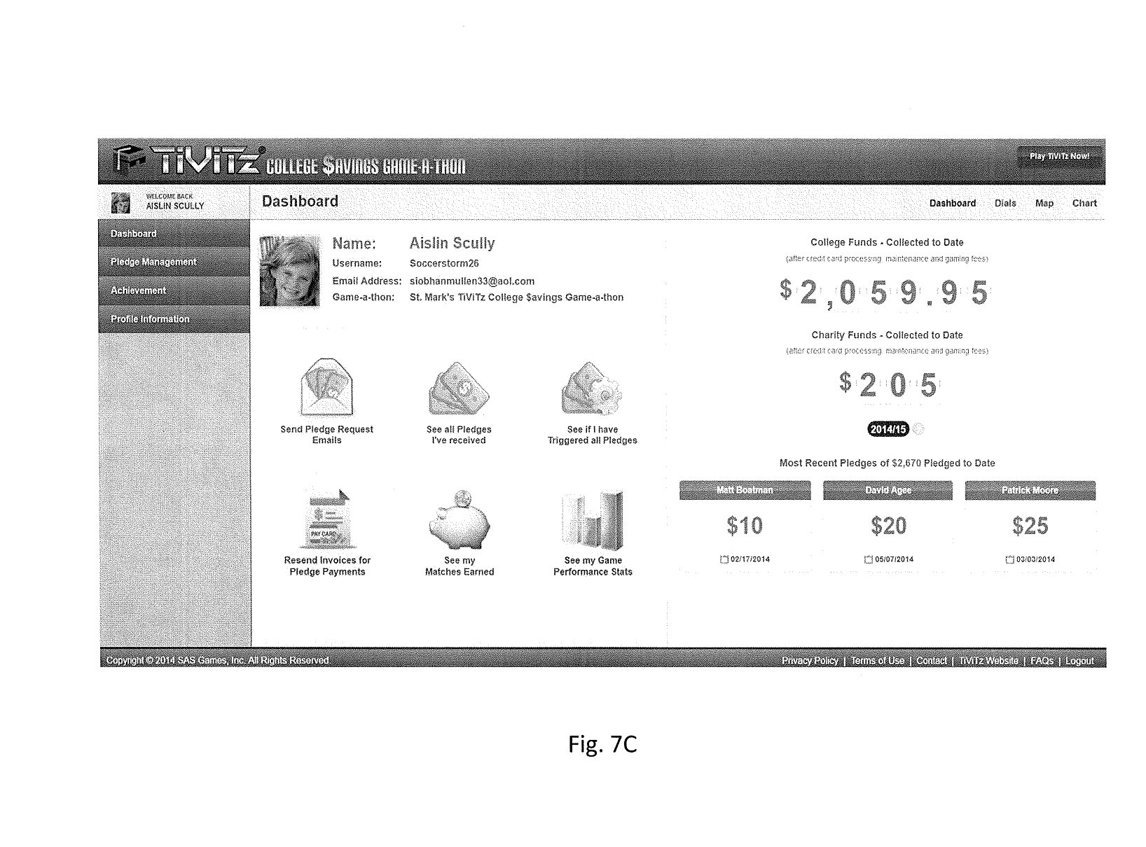

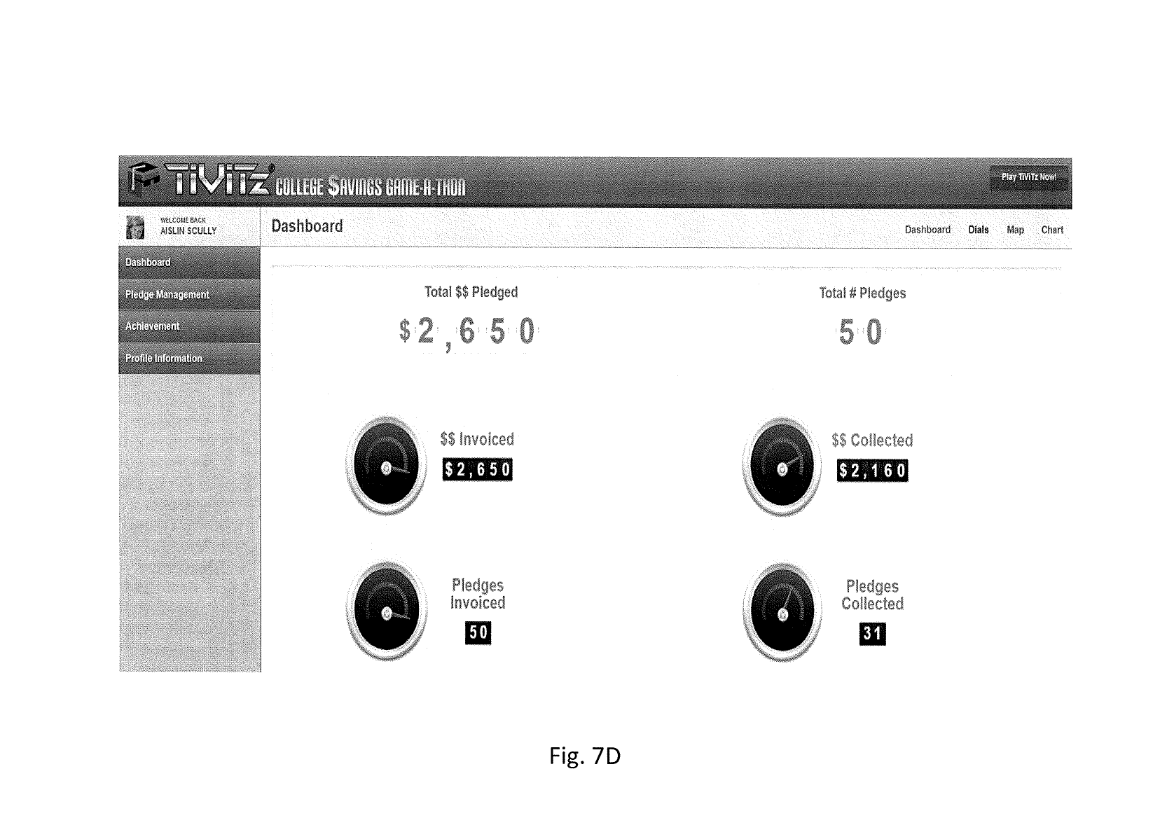

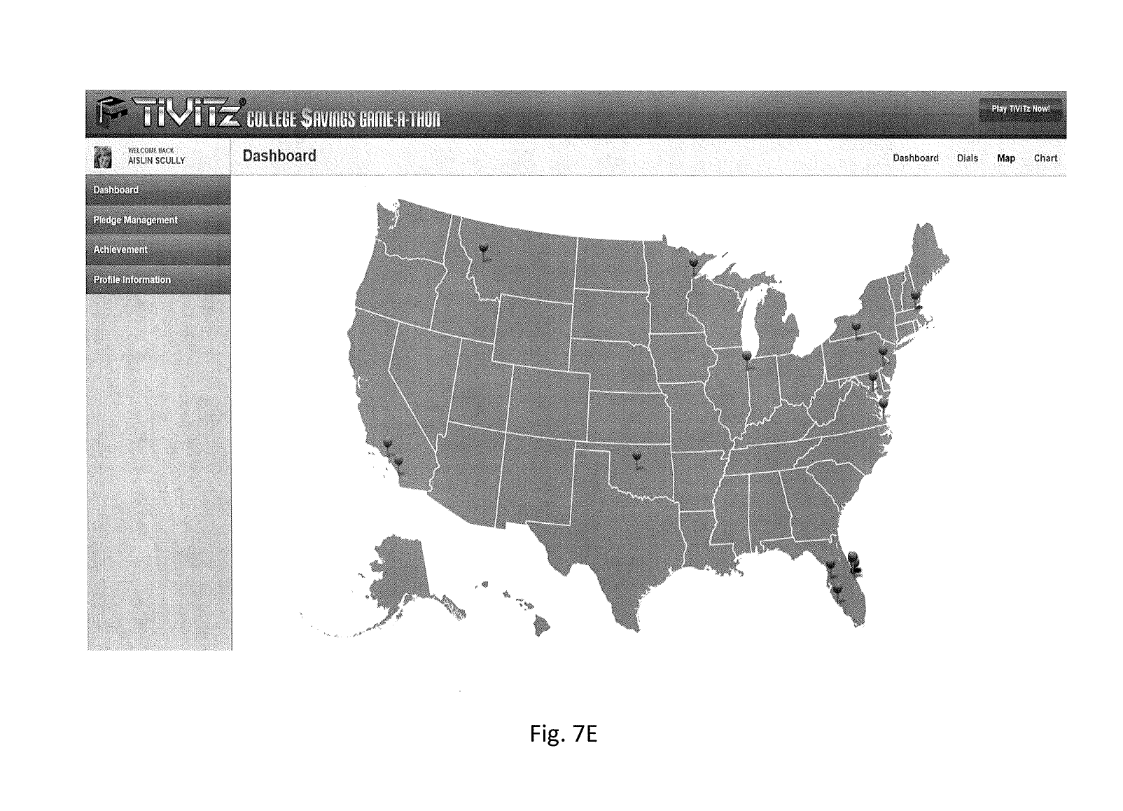

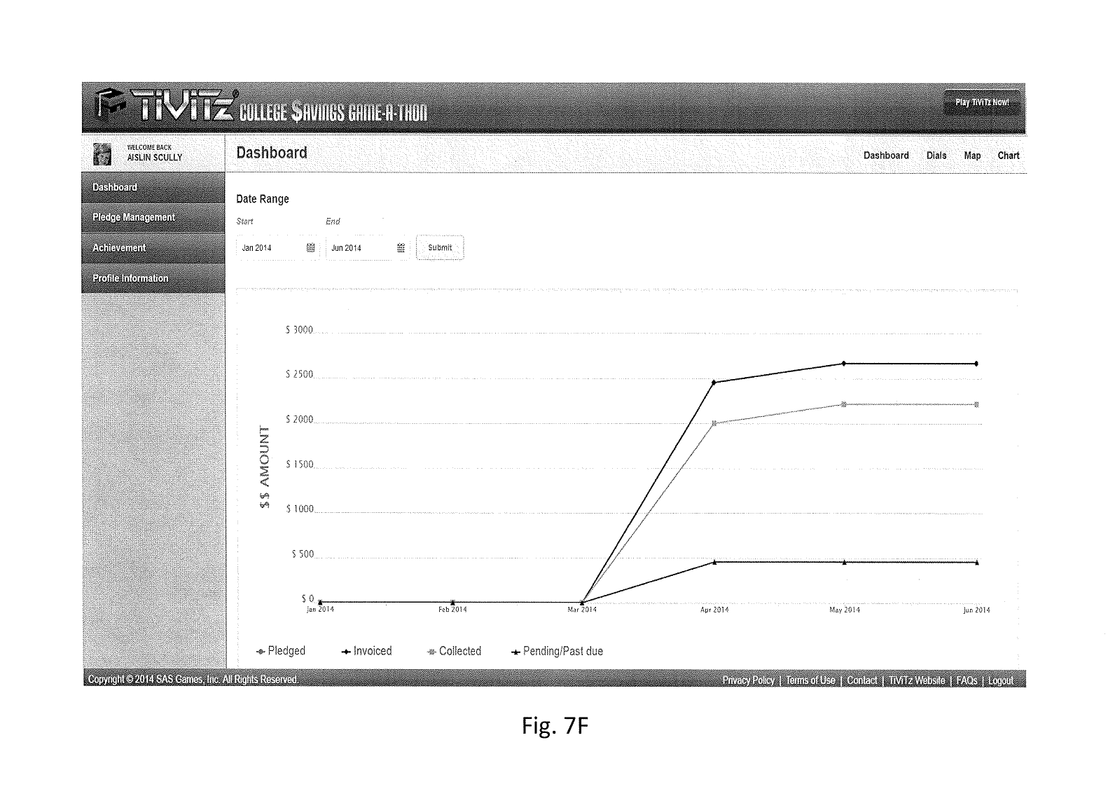

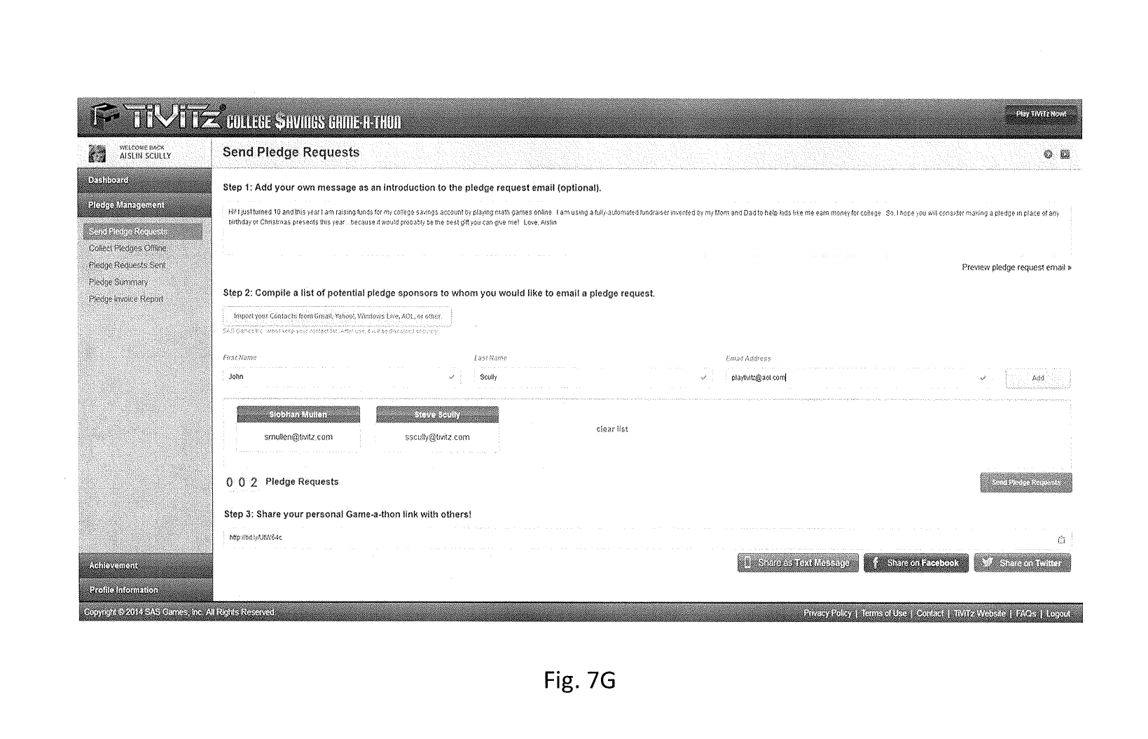

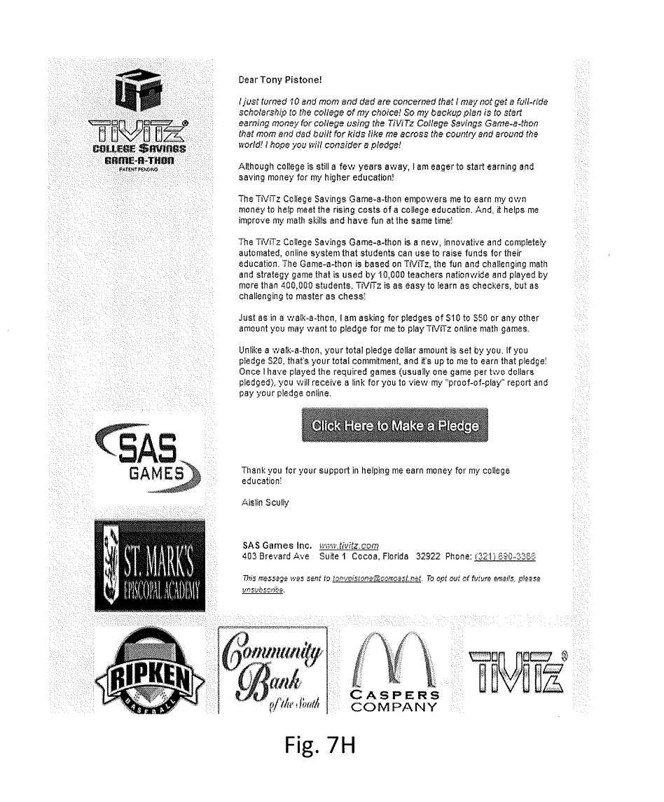

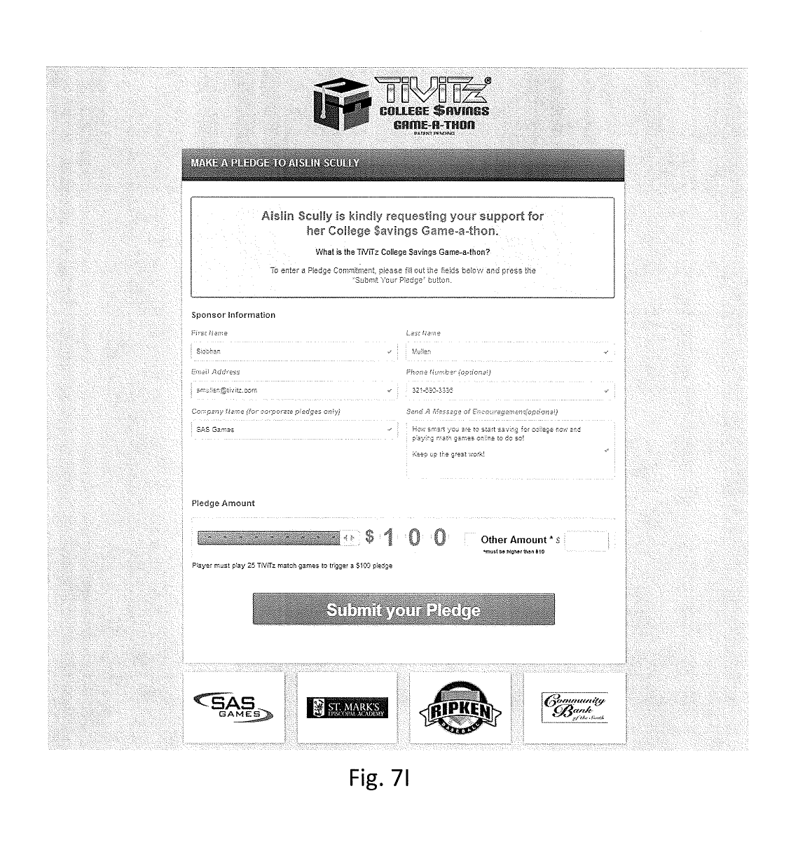

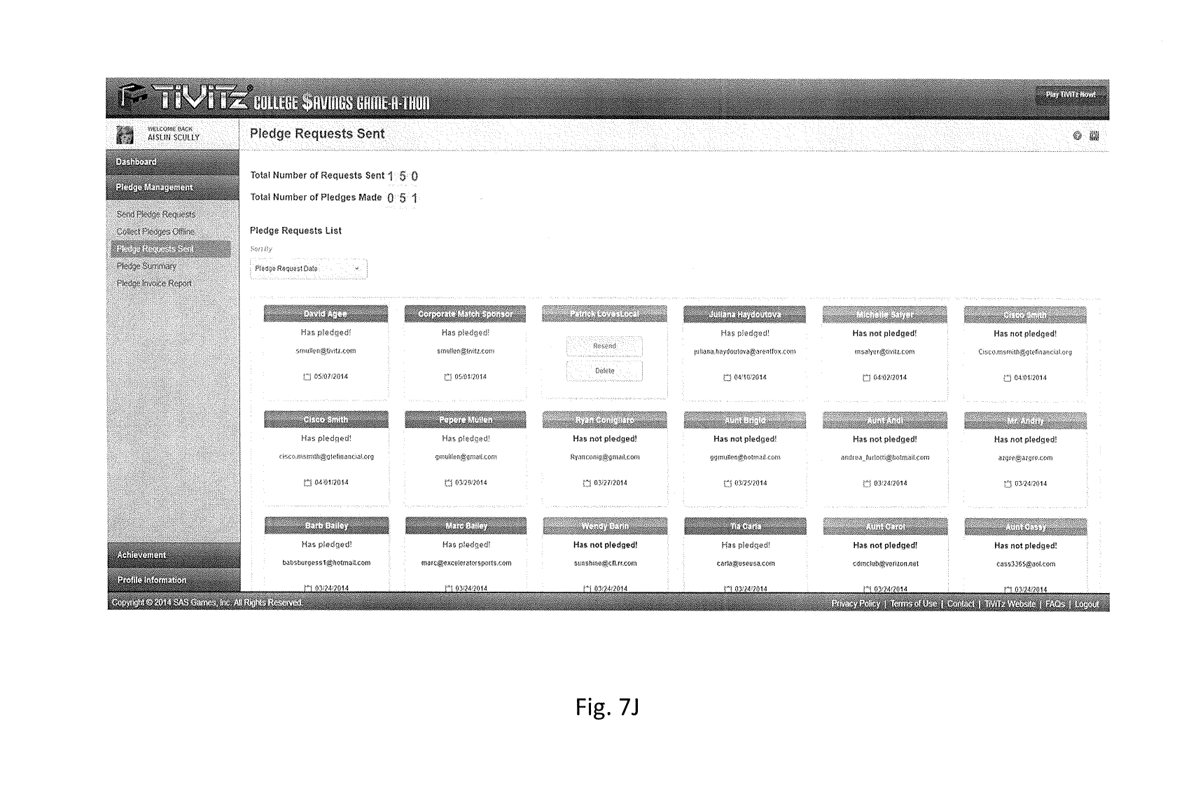

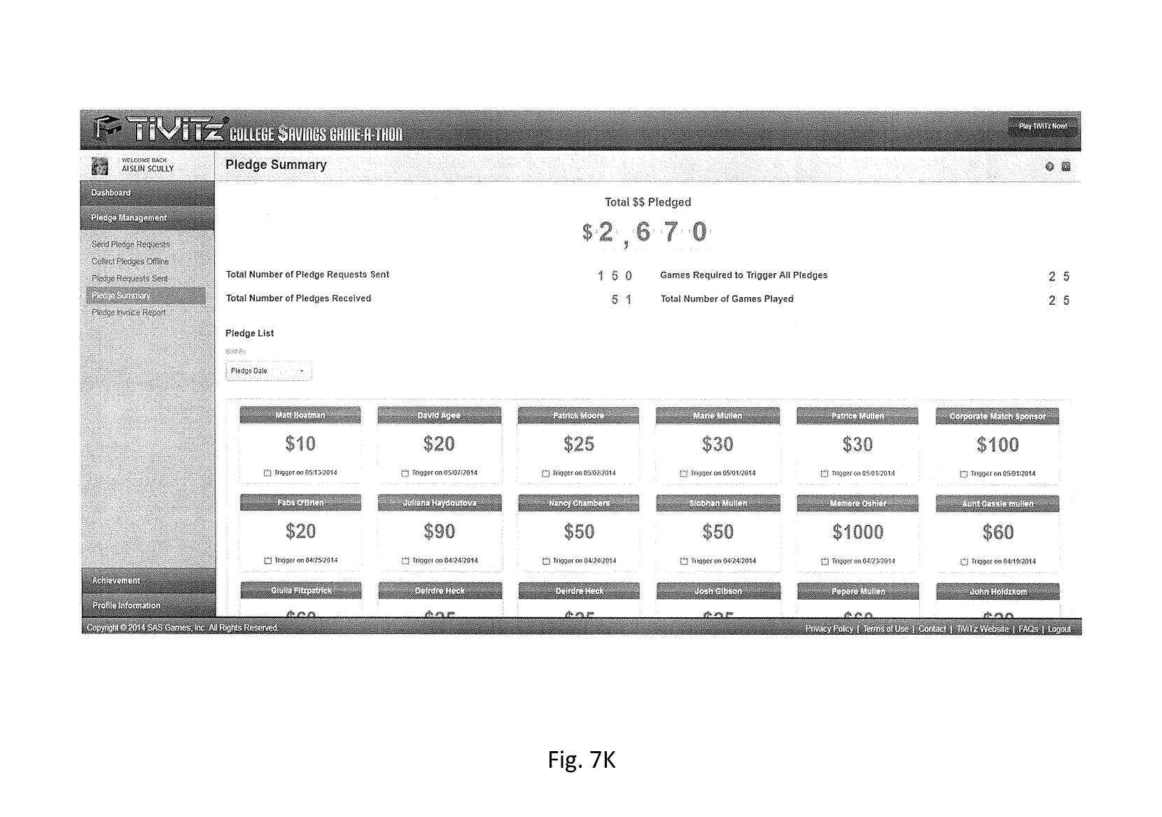

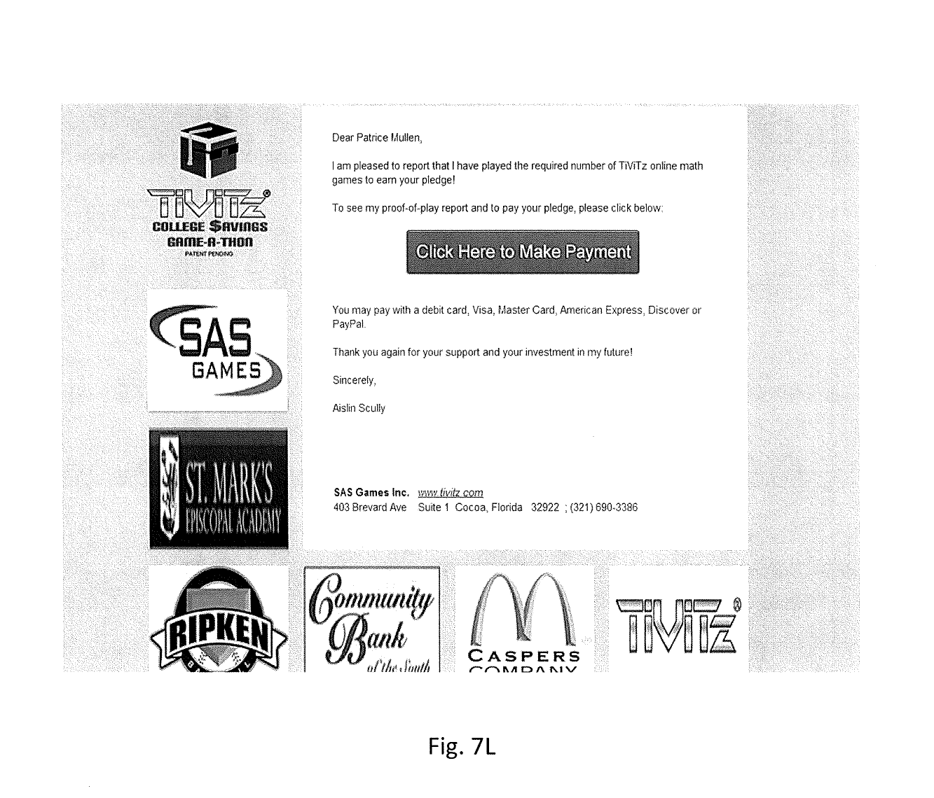

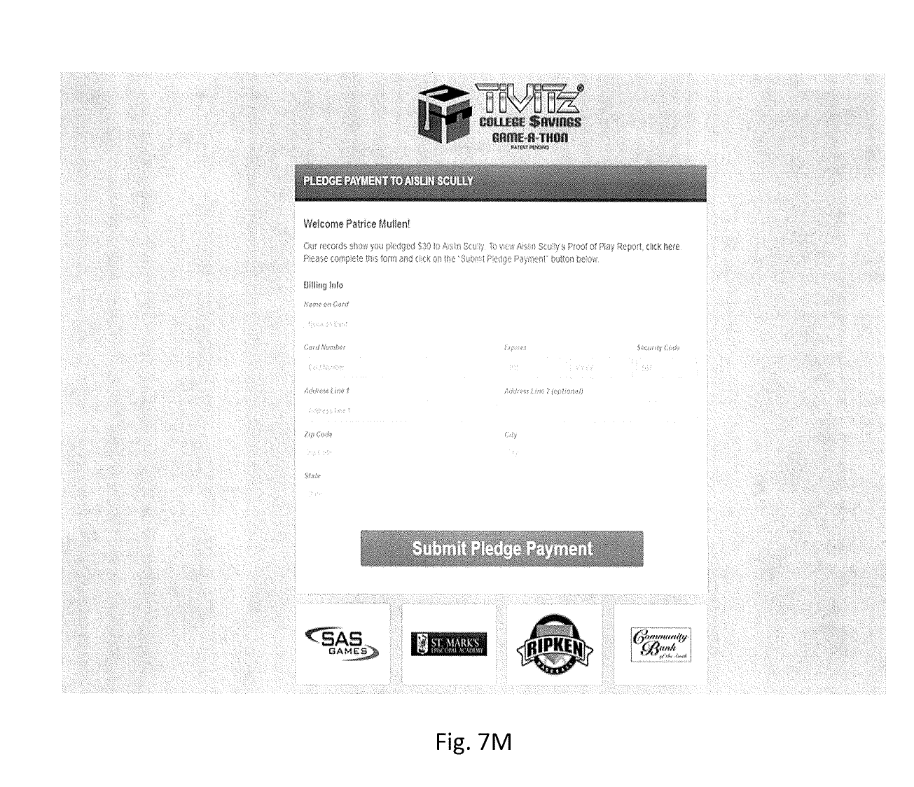

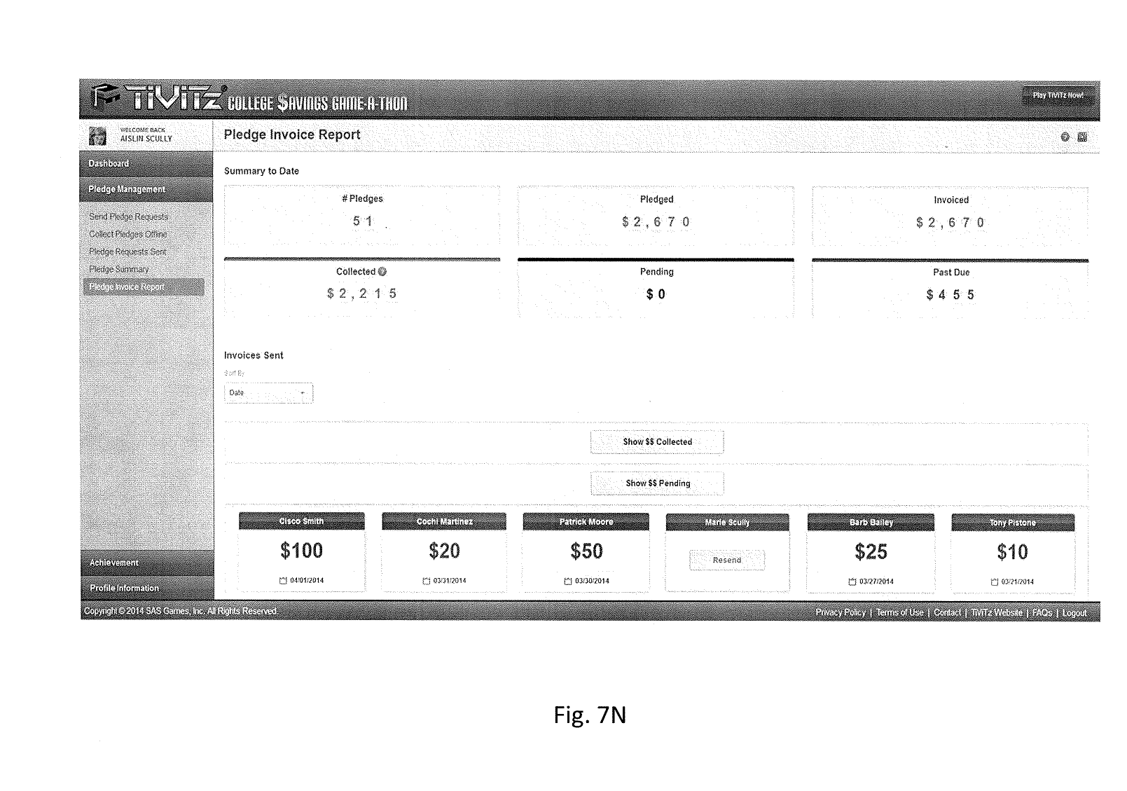

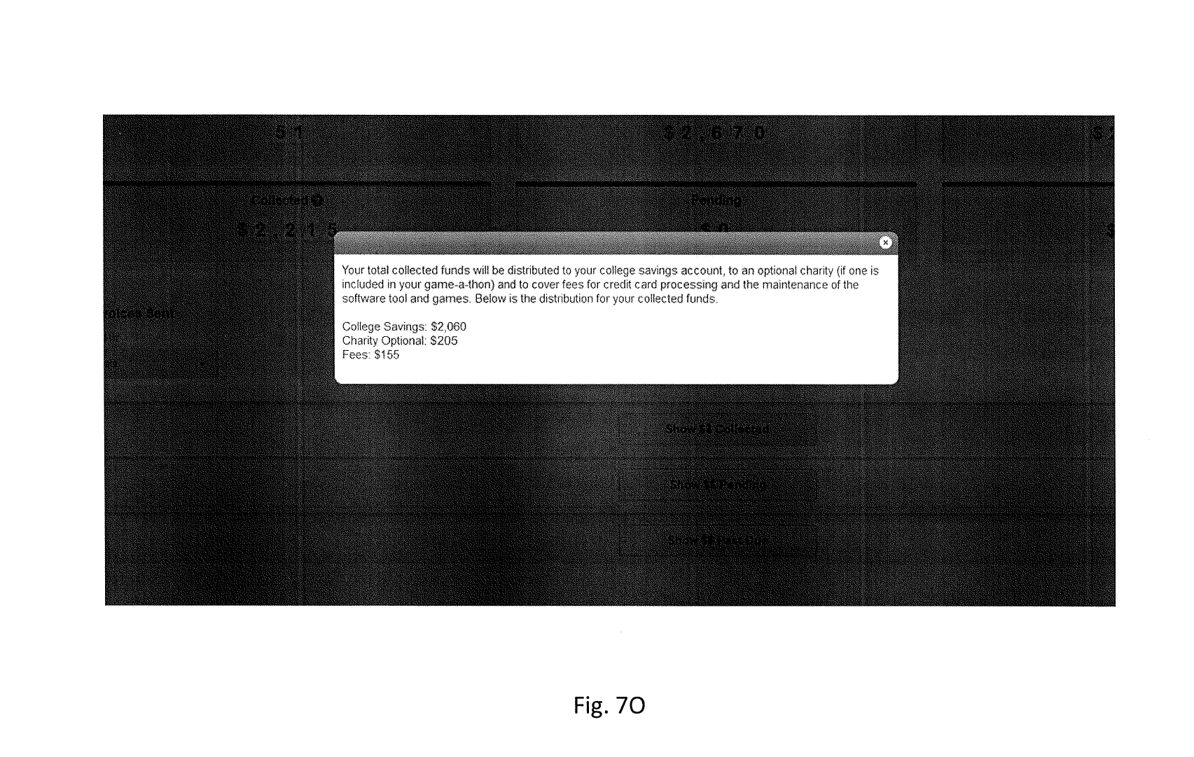

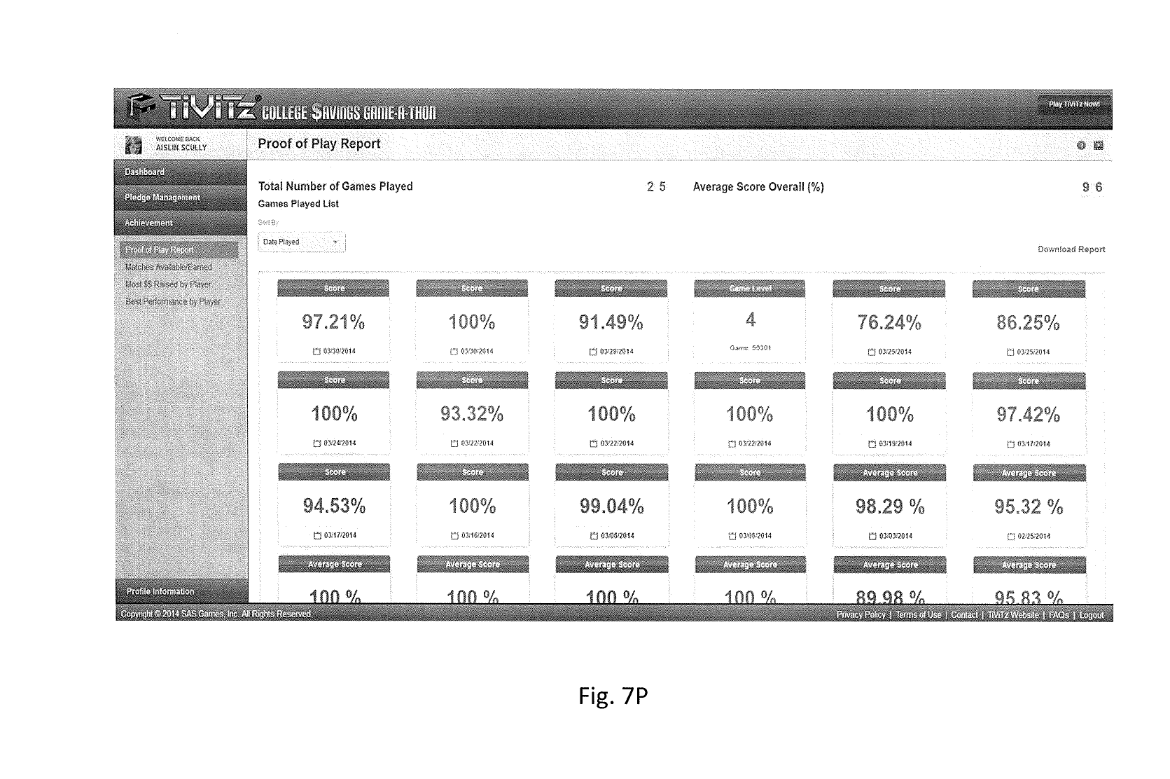

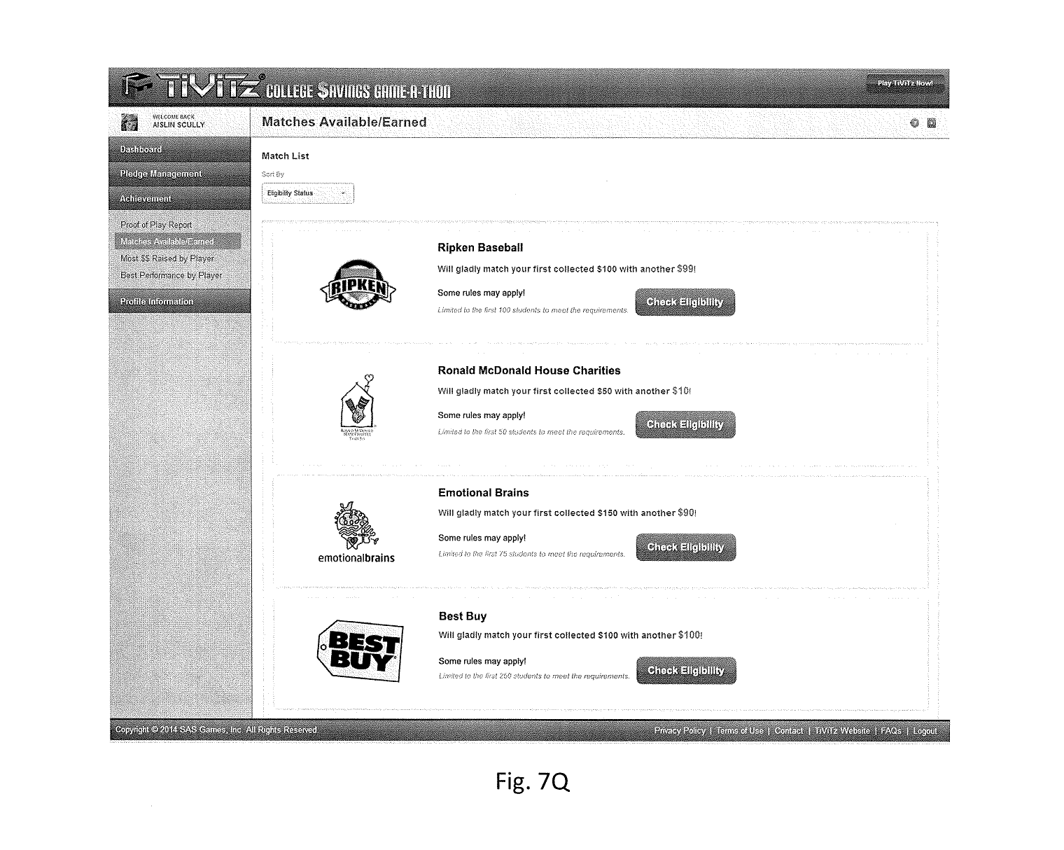

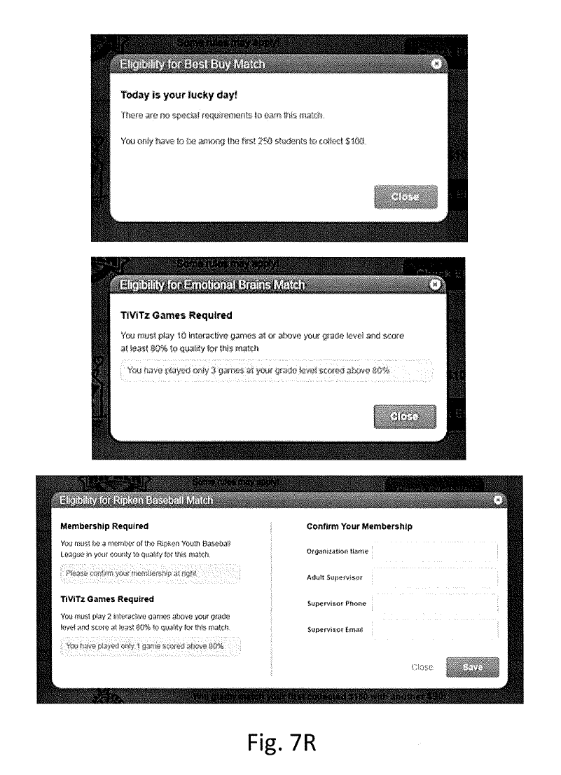

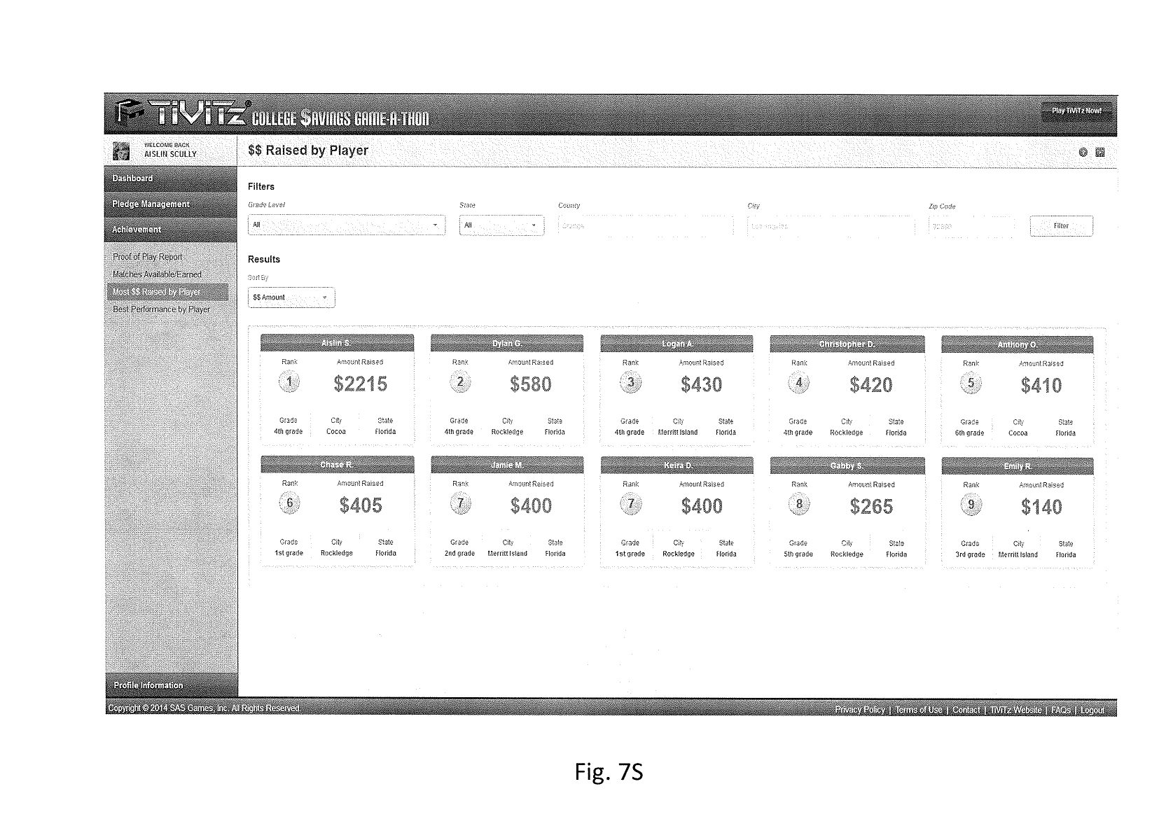

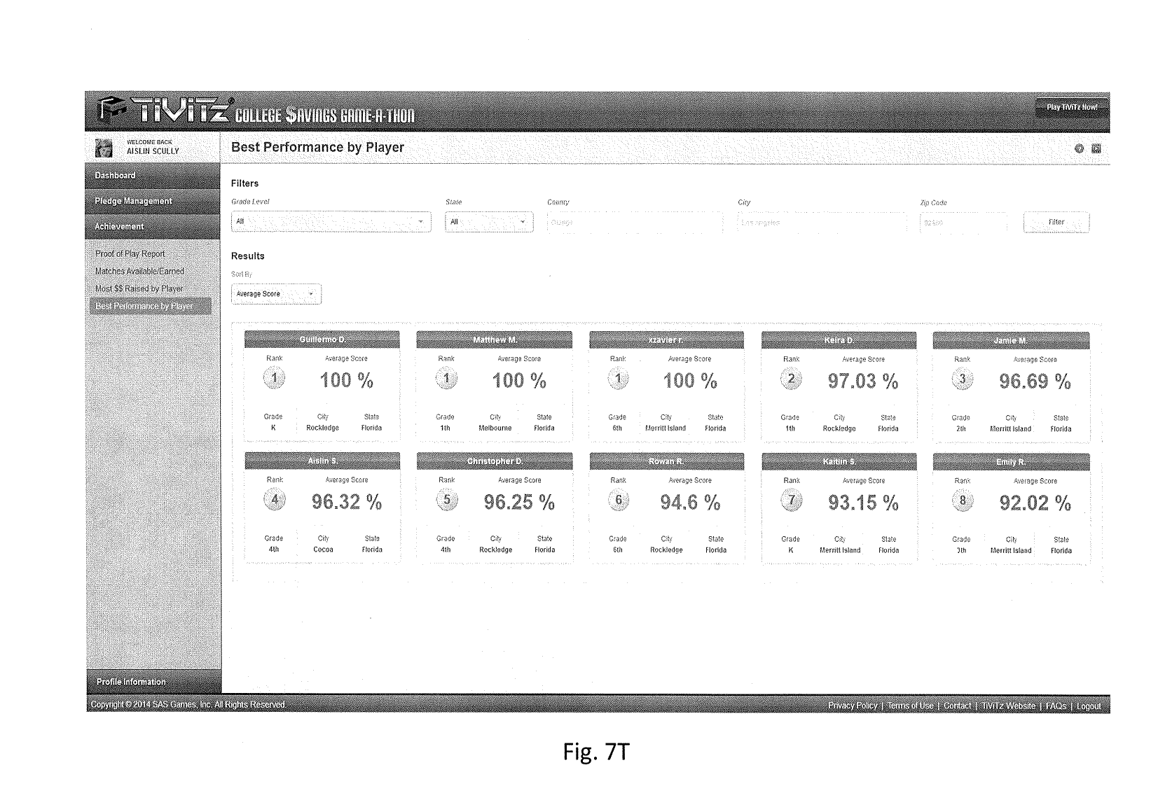

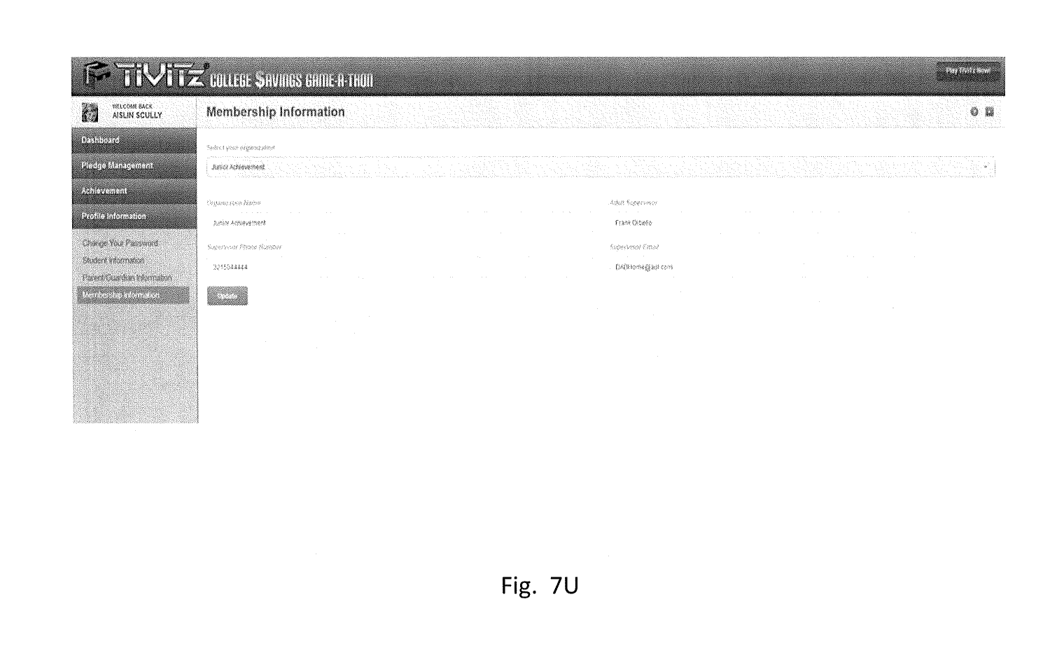

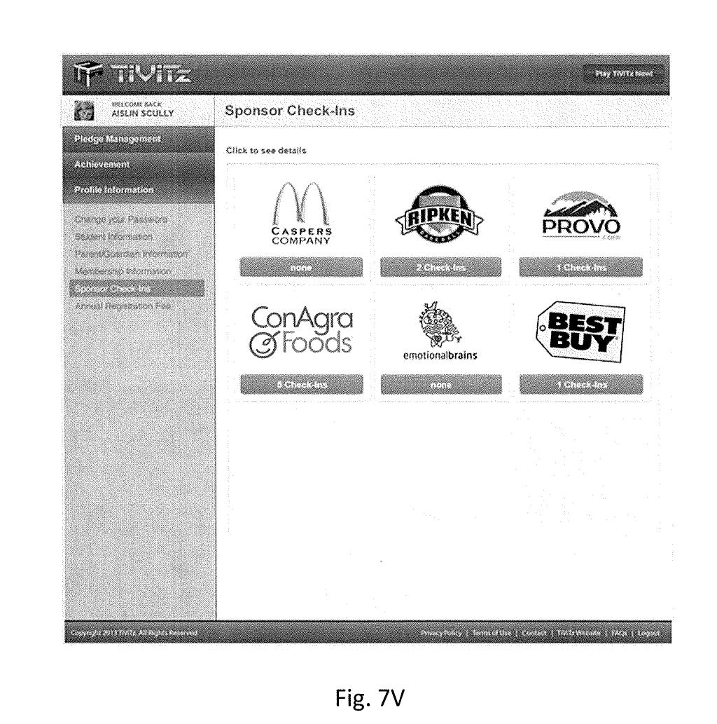

Device 602 may include a participant component 10, such as the online portal discussed in further detail in FIG. 1, FIG. 5 and FIGS. 7A-7V, configured to allow a user of device 602 to play online games, play online competitions, and/or participate in online fundraising. Participant component 10 may interface with a fundraiser management component 16 on server 606.

Device 608 may include an administrator component 12 configured to allow a user, such as an administrator, to manage online games and online competitions, to create fundraisers, such as gameathons and/or manage fundraisers running on the system, as discussed in more detail in FIGS. 2, 3, 4, and 8A-8AB. Administrator component 12 may interface with a fundraiser management component 16 on server 606.

Fundraiser management component 16 may receive fundraiser information for the various online games, online competitions, and online fundraisers, such as gameathons from the administrator component 12 and may store the received fundraiser information, for example, in a data repository. For example, fundraiser management component 16 may receive a name for the fundraiser, parameters and rules for the fundraiser, financial institutions associated with the fundraiser, strategic partners (e.g., match sponsors, charity organizations, and/or host sponsor organizations) associated with the fundraiser, and any public correspondence for the fundraiser. Fundraiser management component 16 may conduct the fundraiser based upon, for example, the fundraiser information received from administrator component 12.

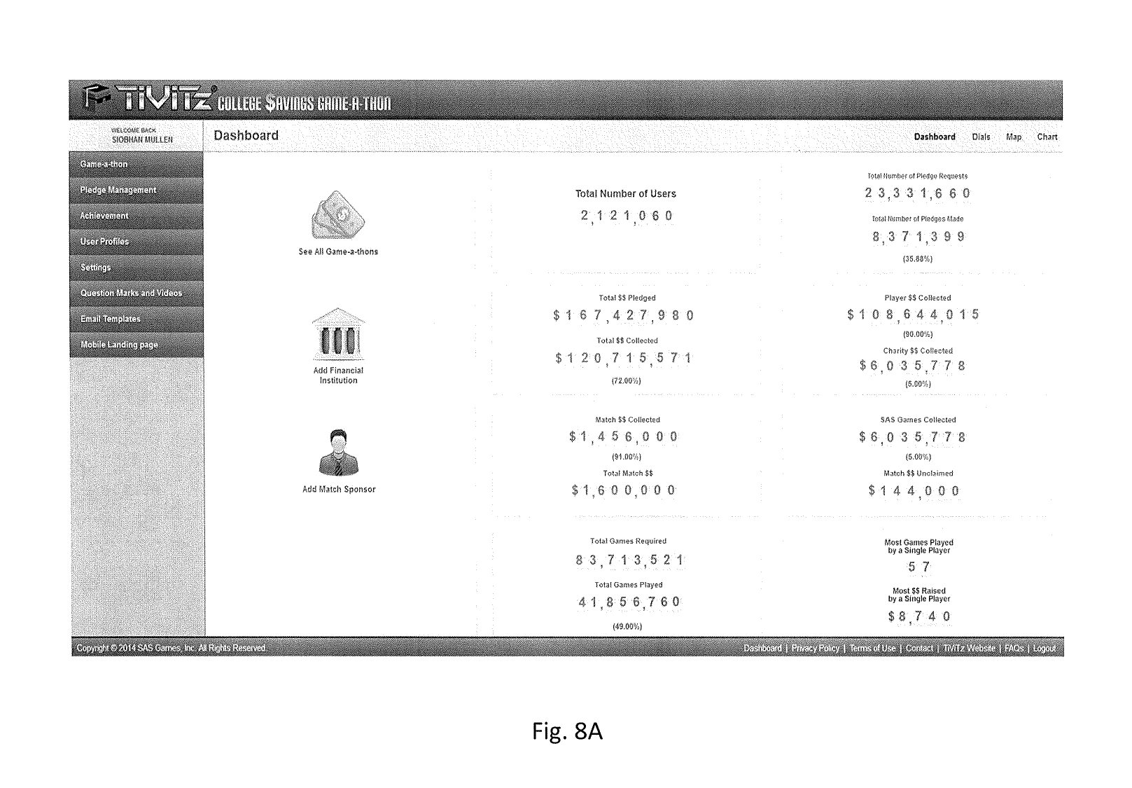

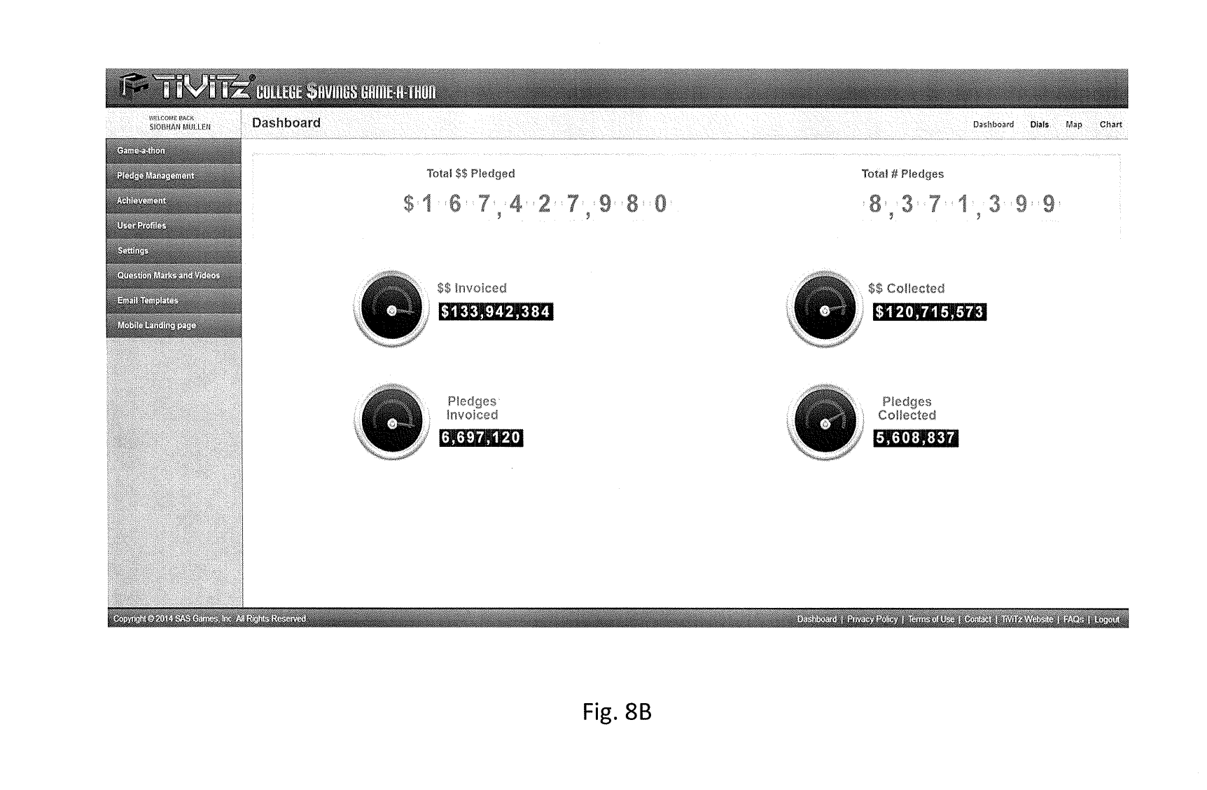

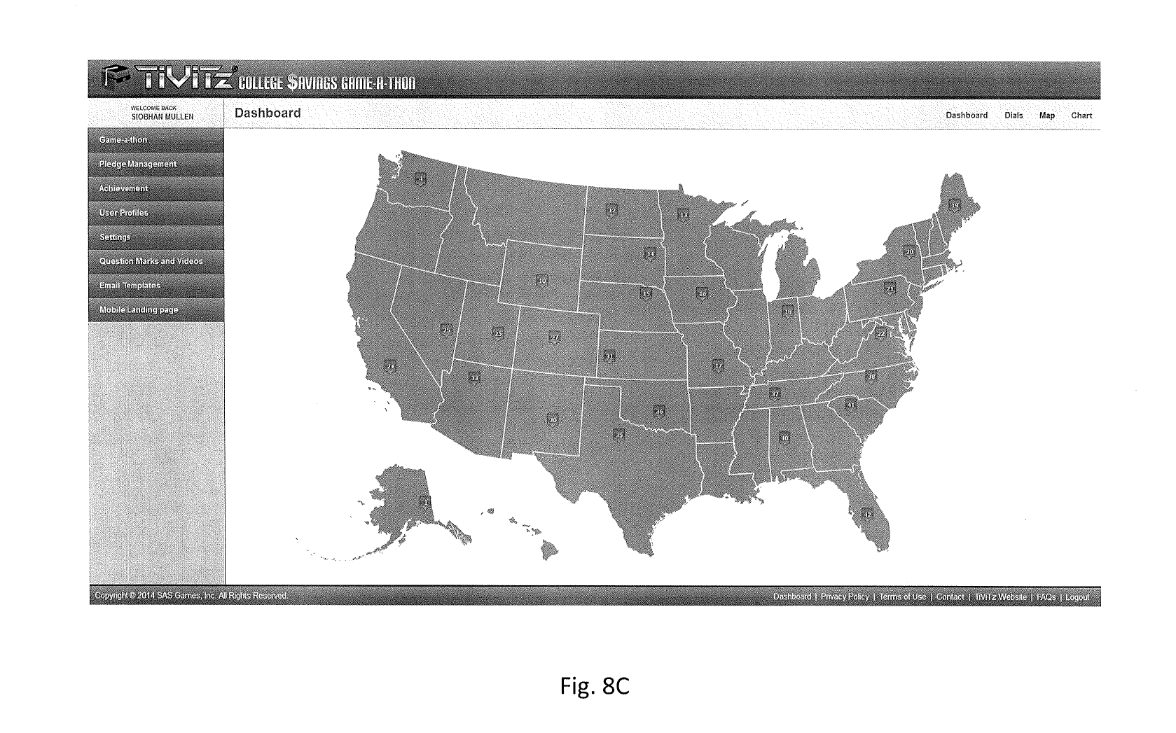

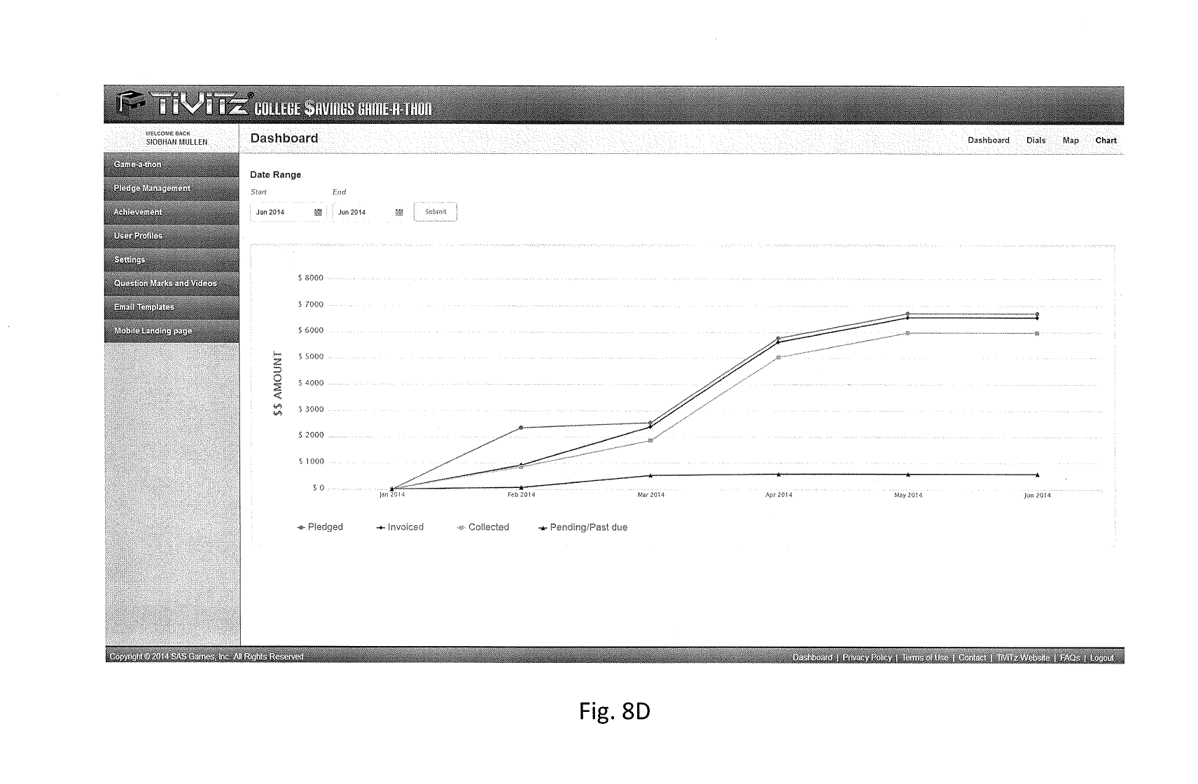

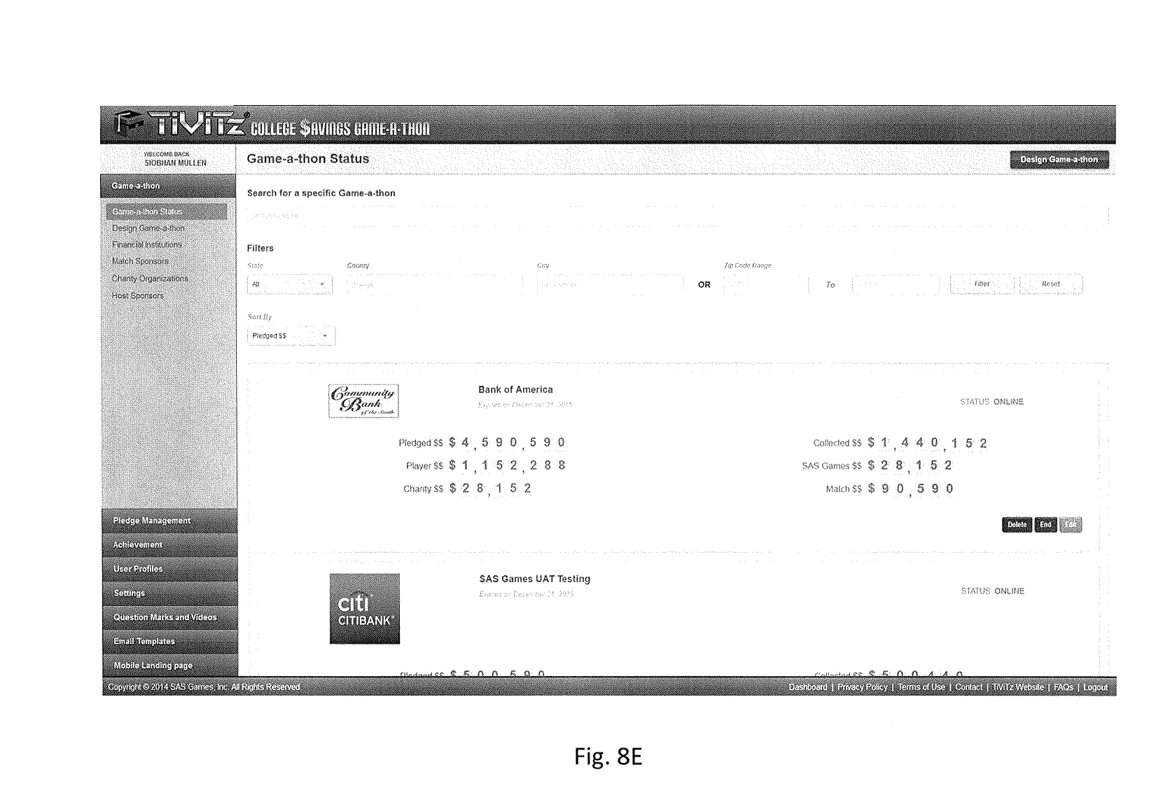

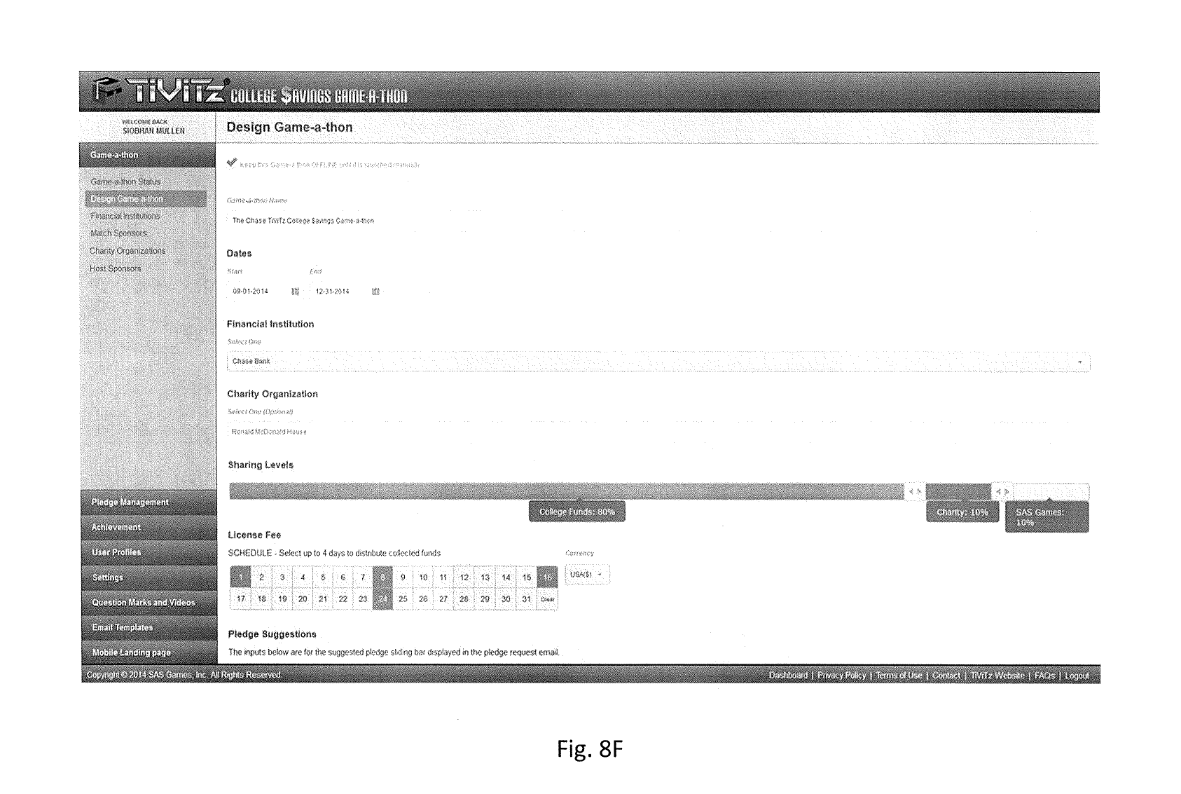

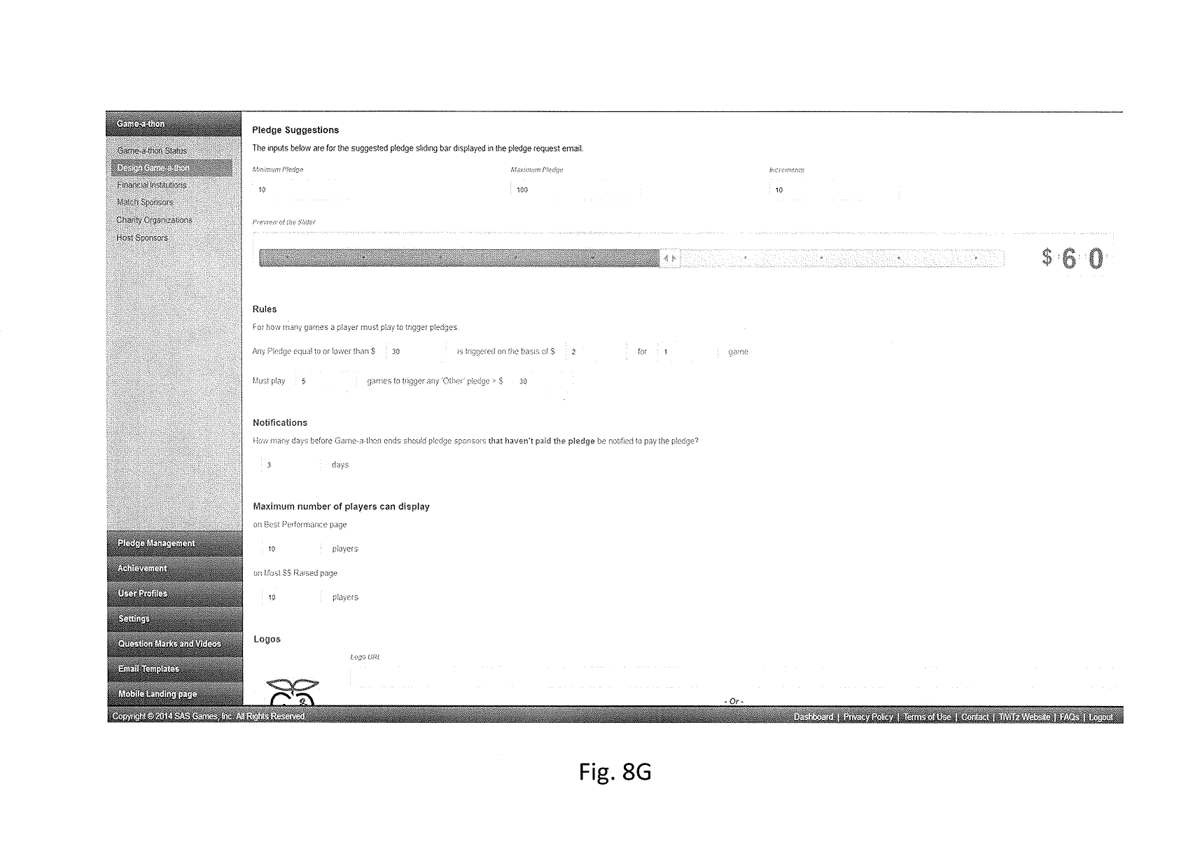

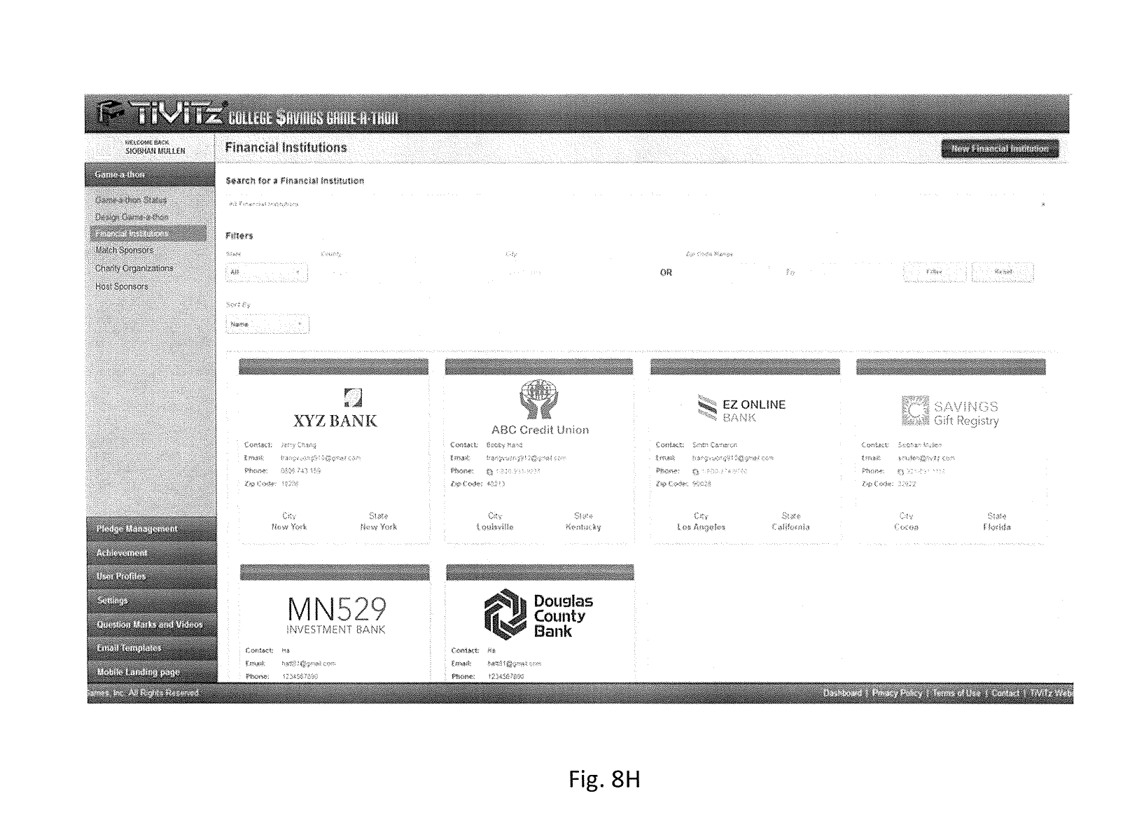

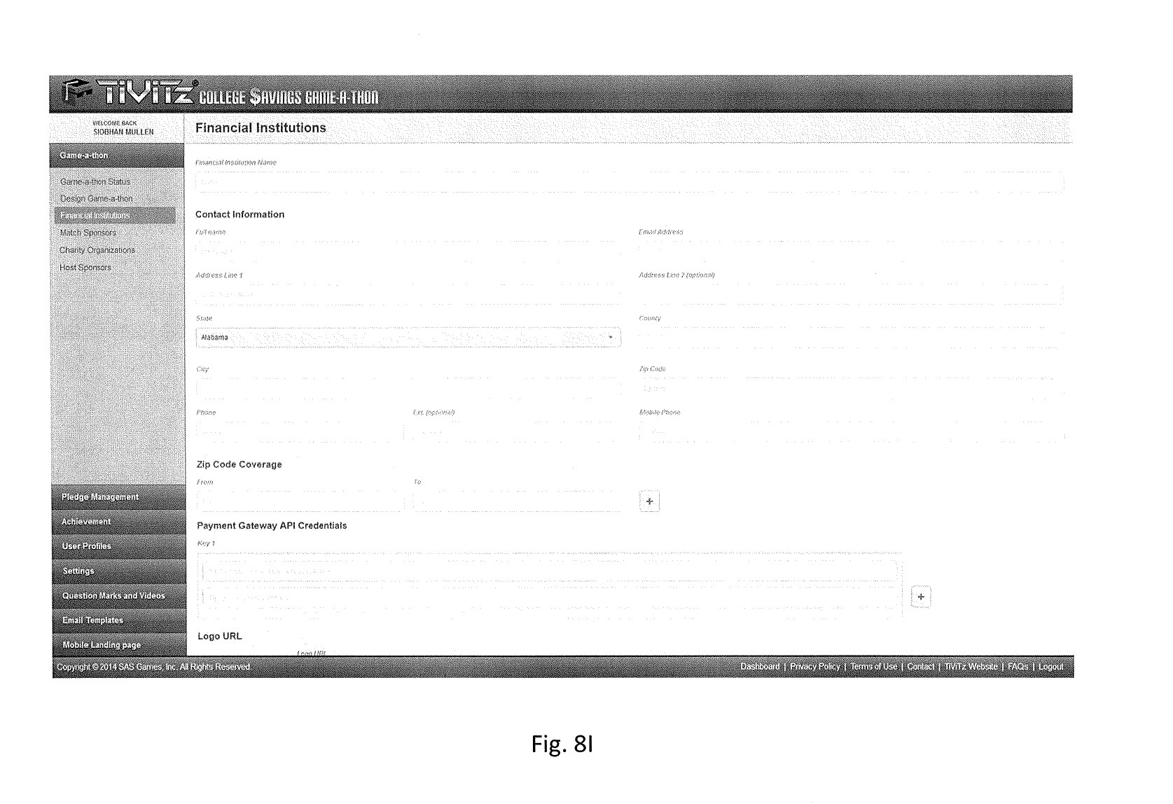

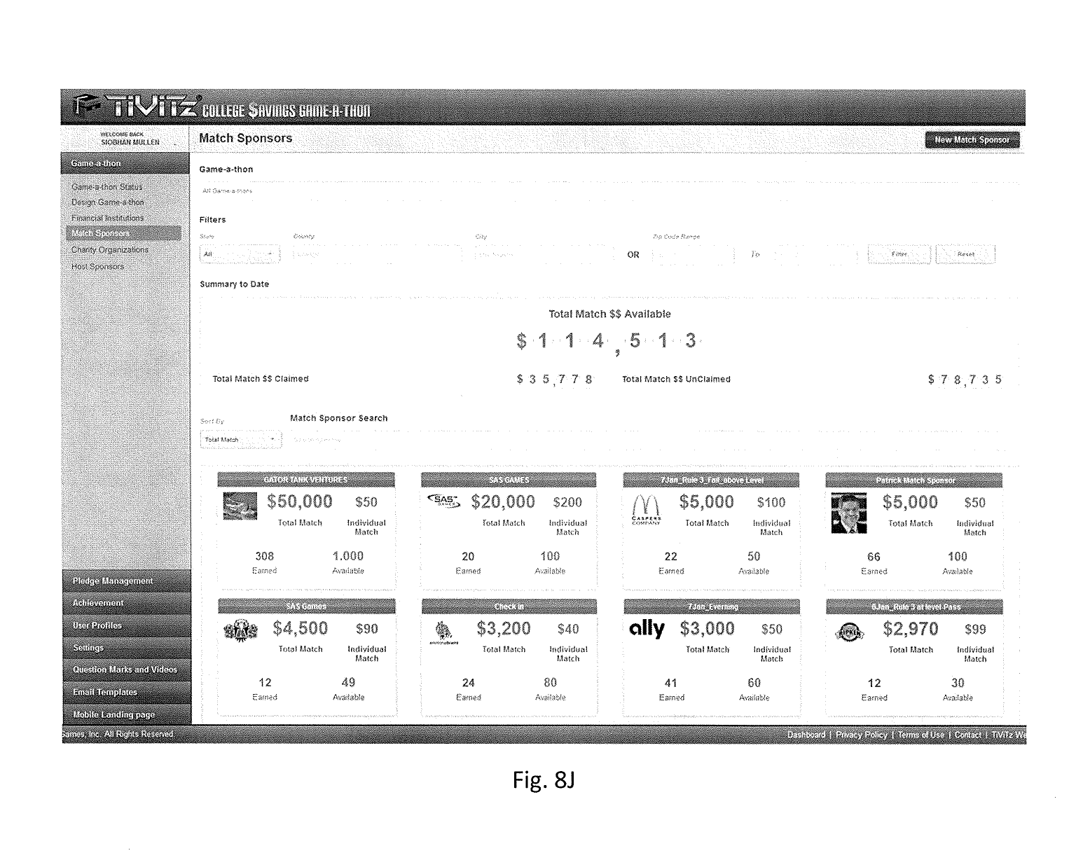

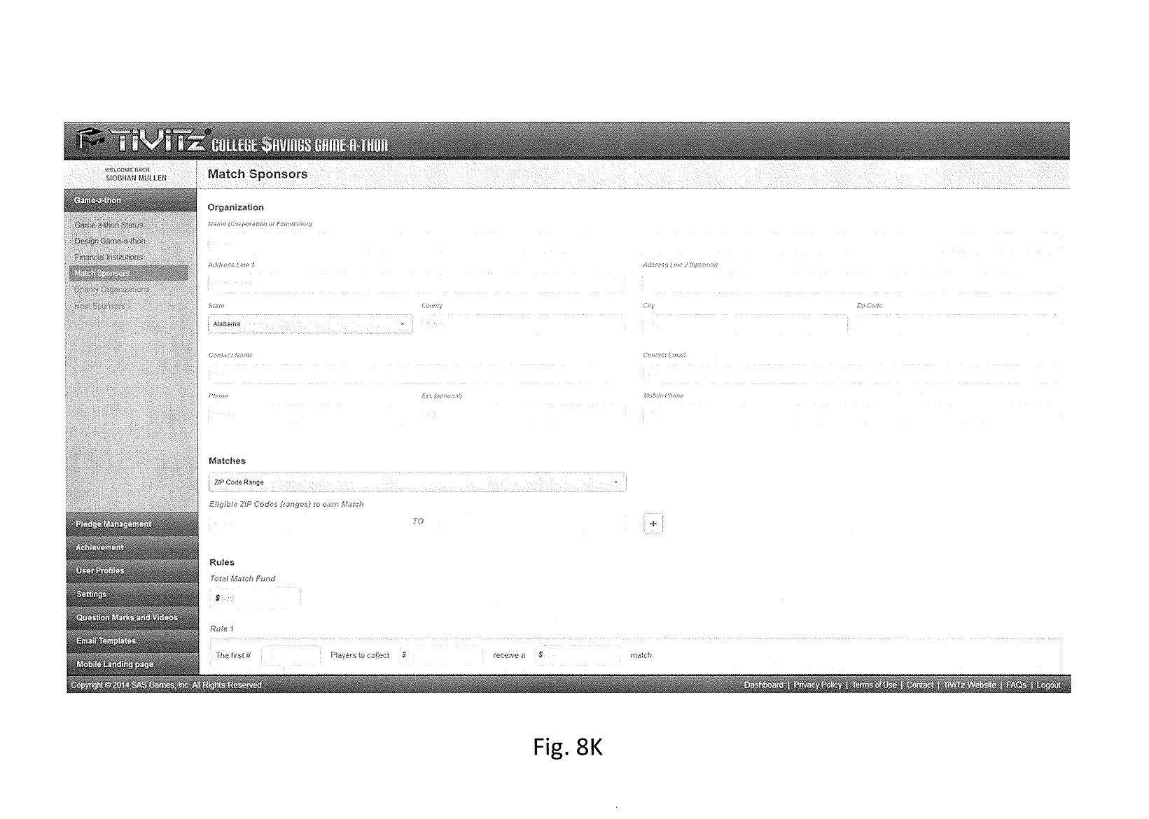

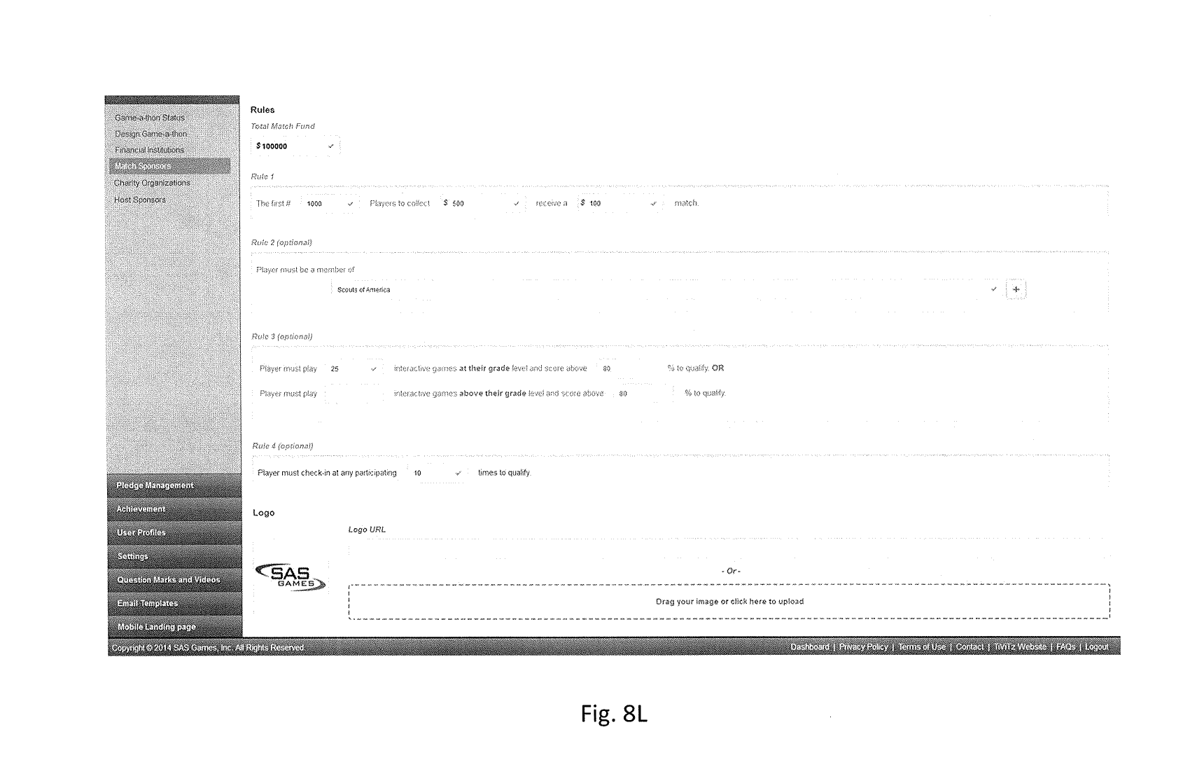

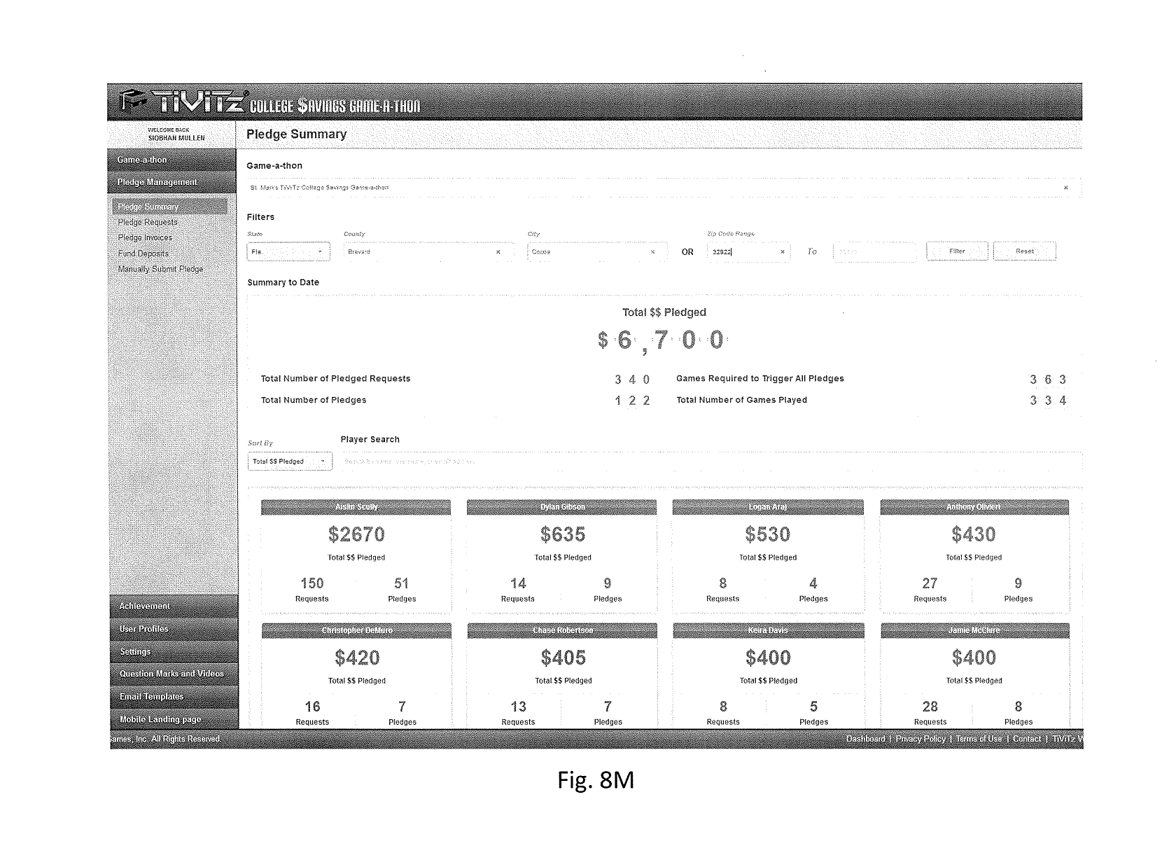

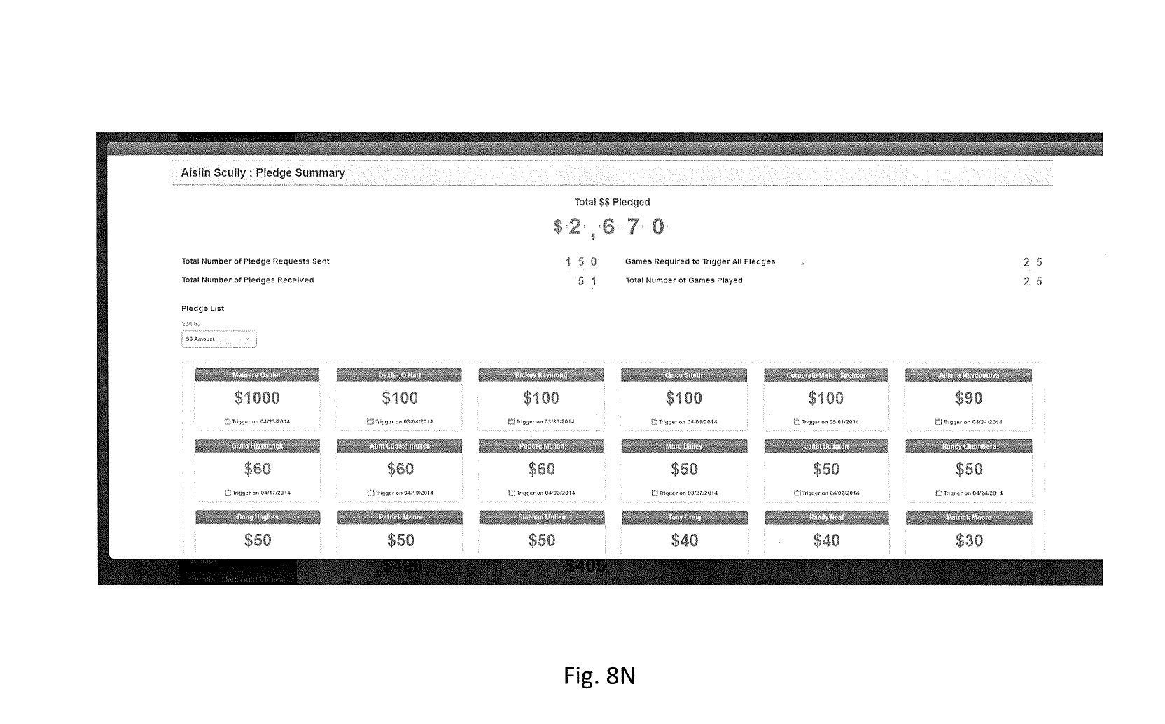

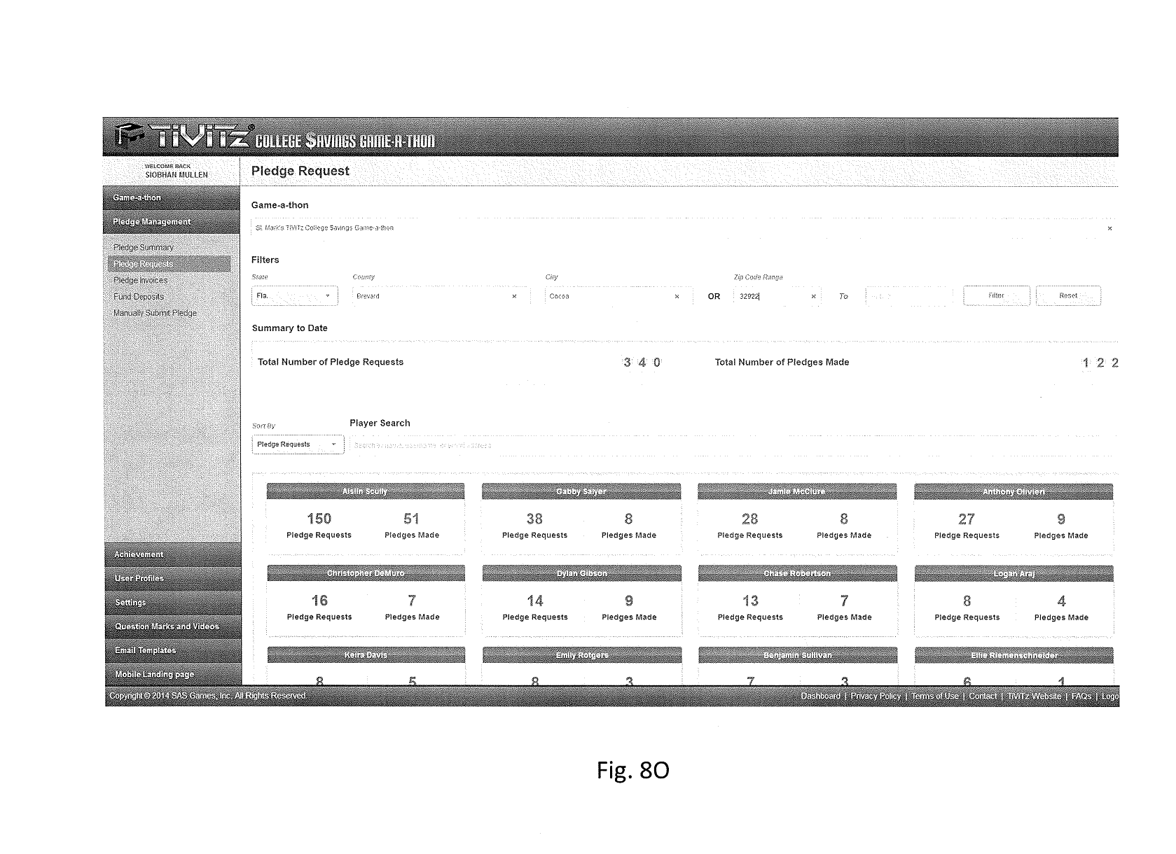

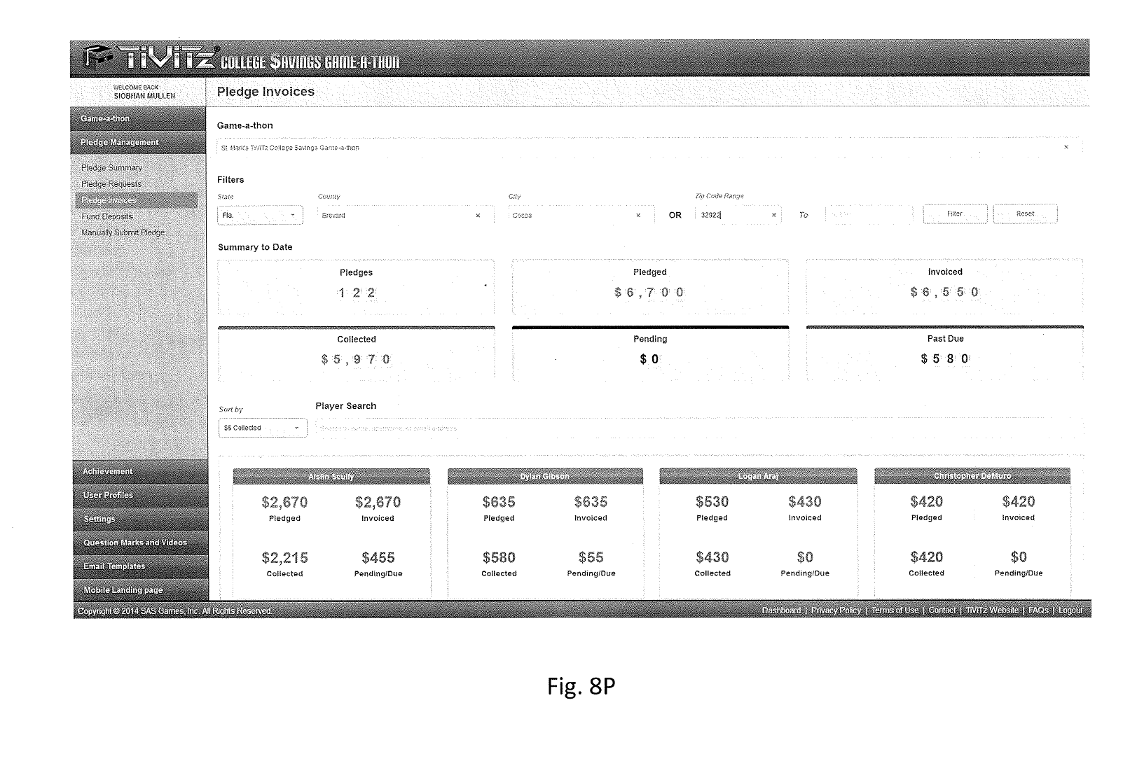

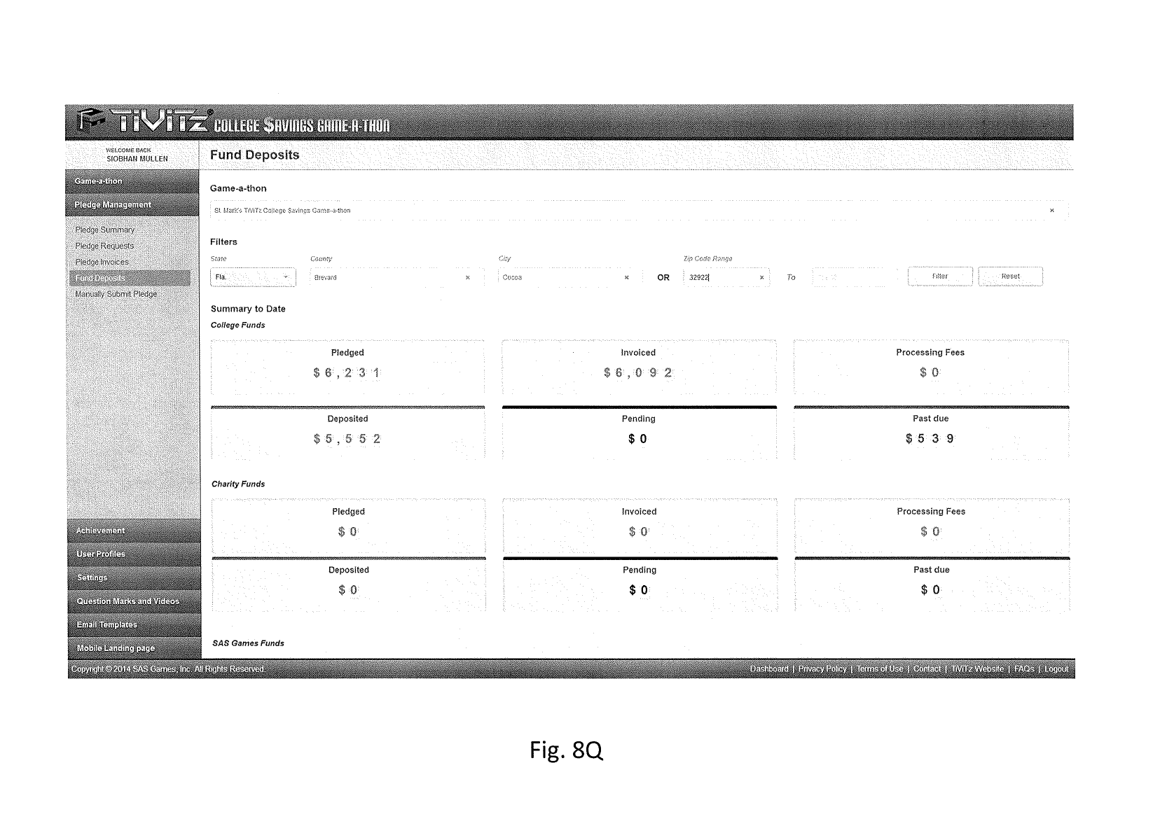

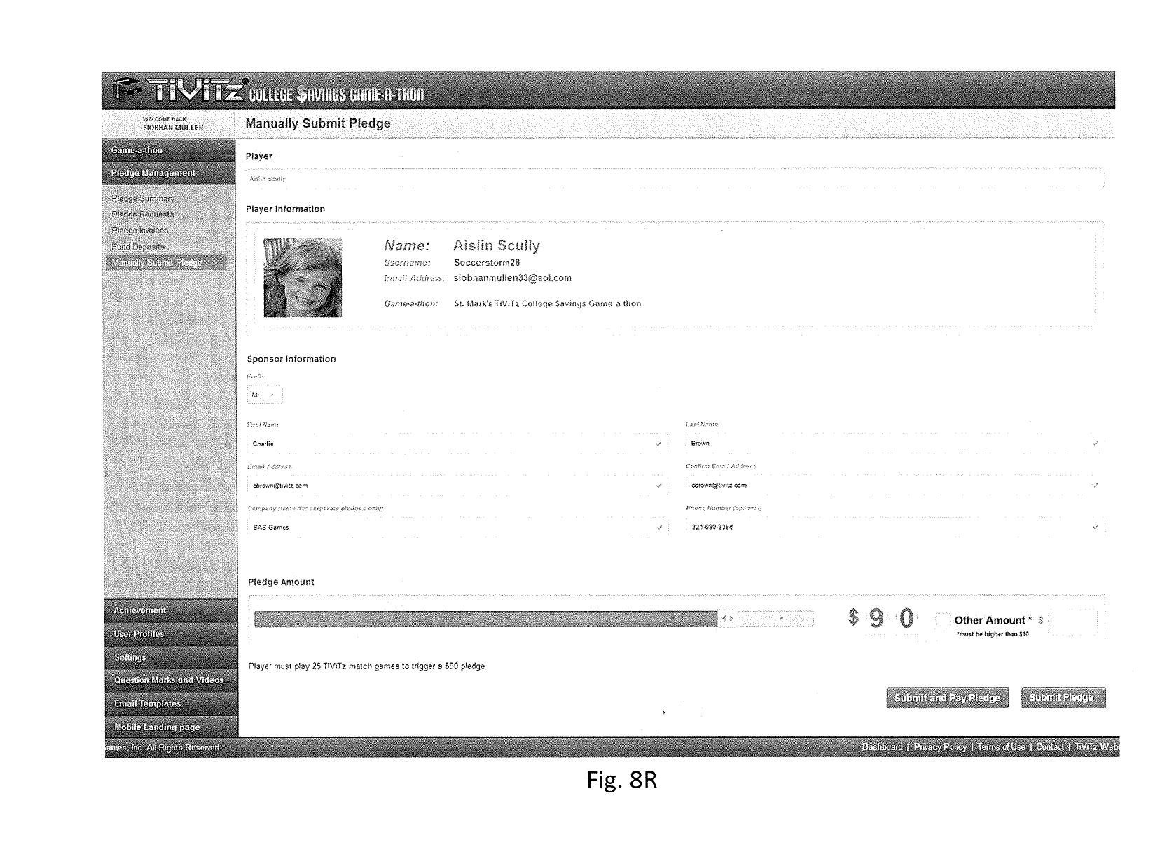

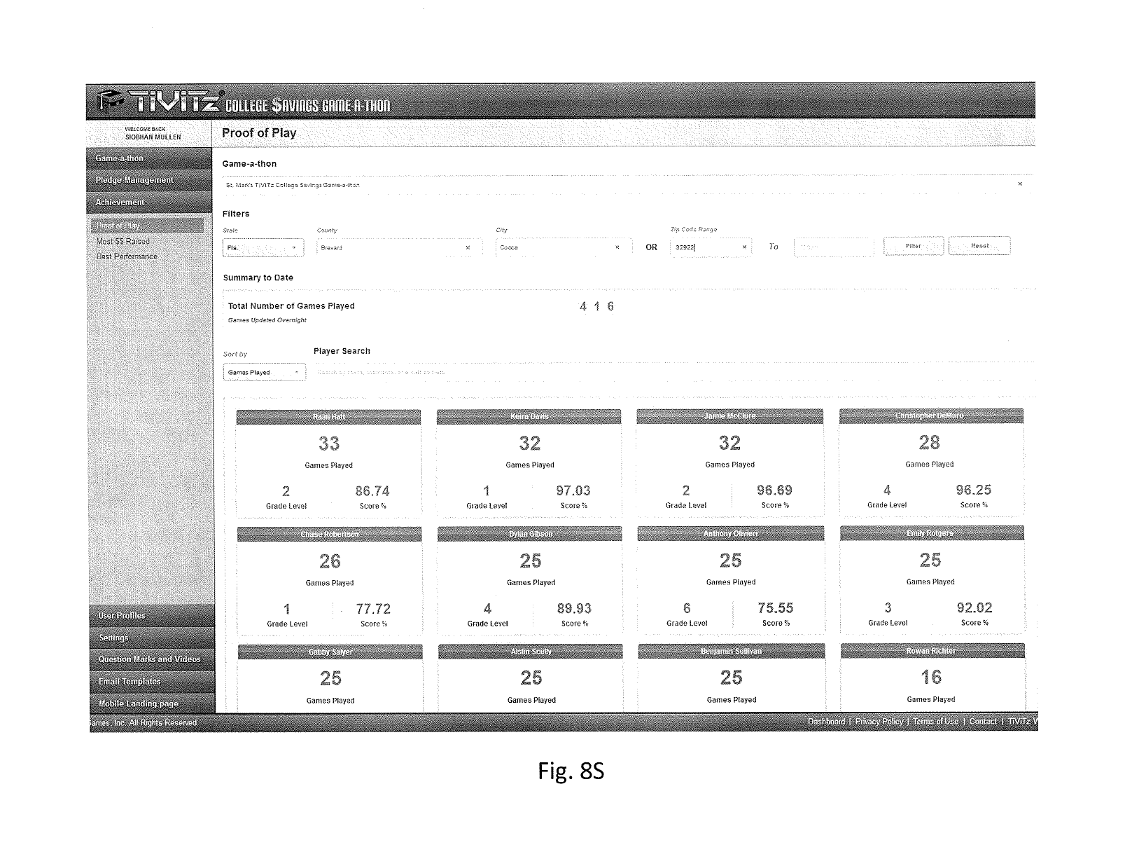

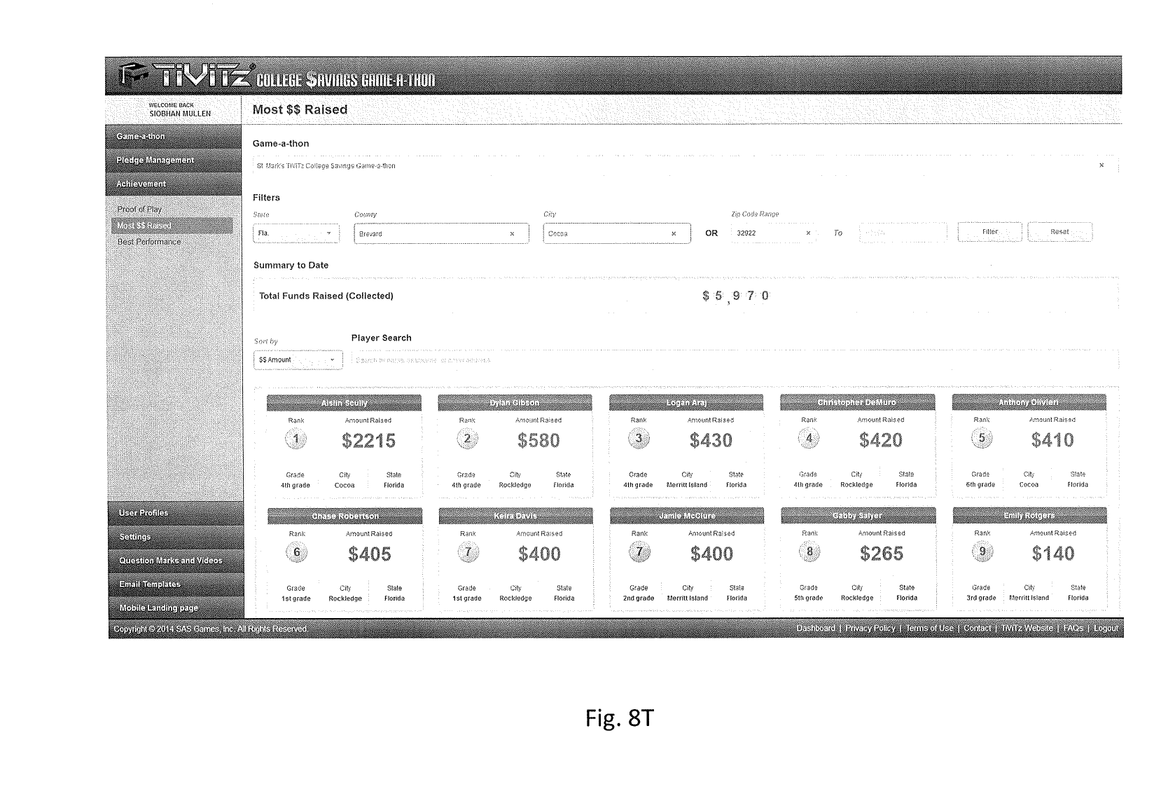

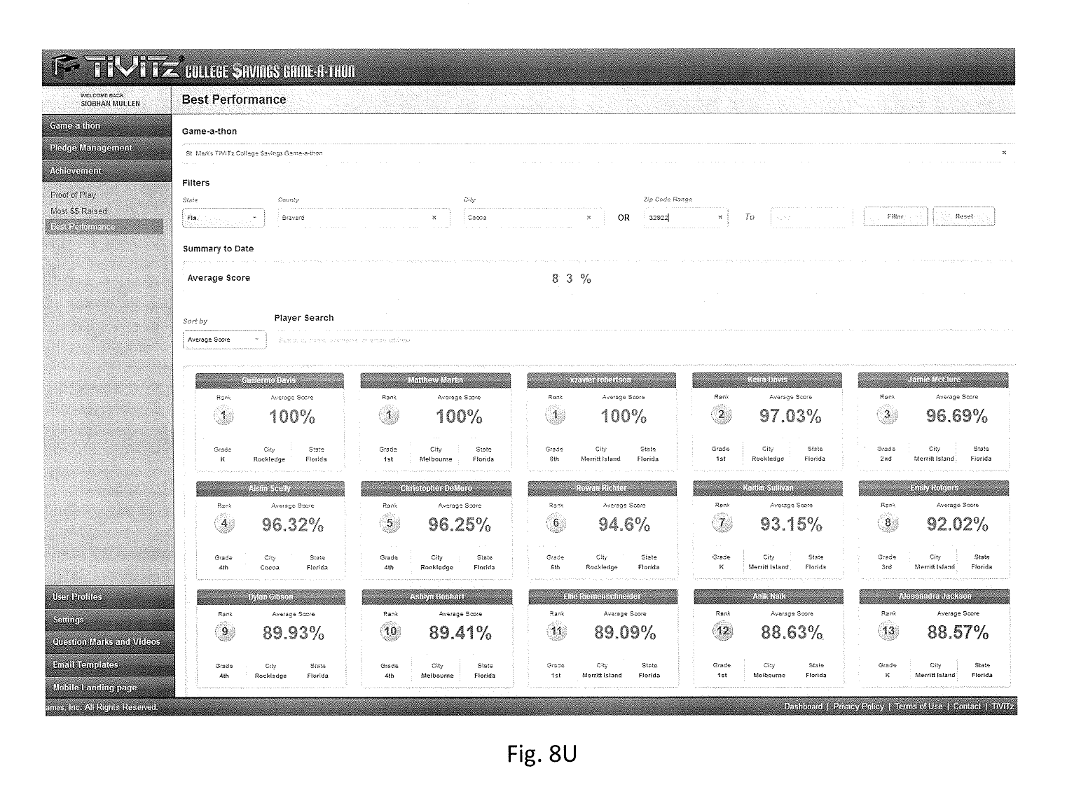

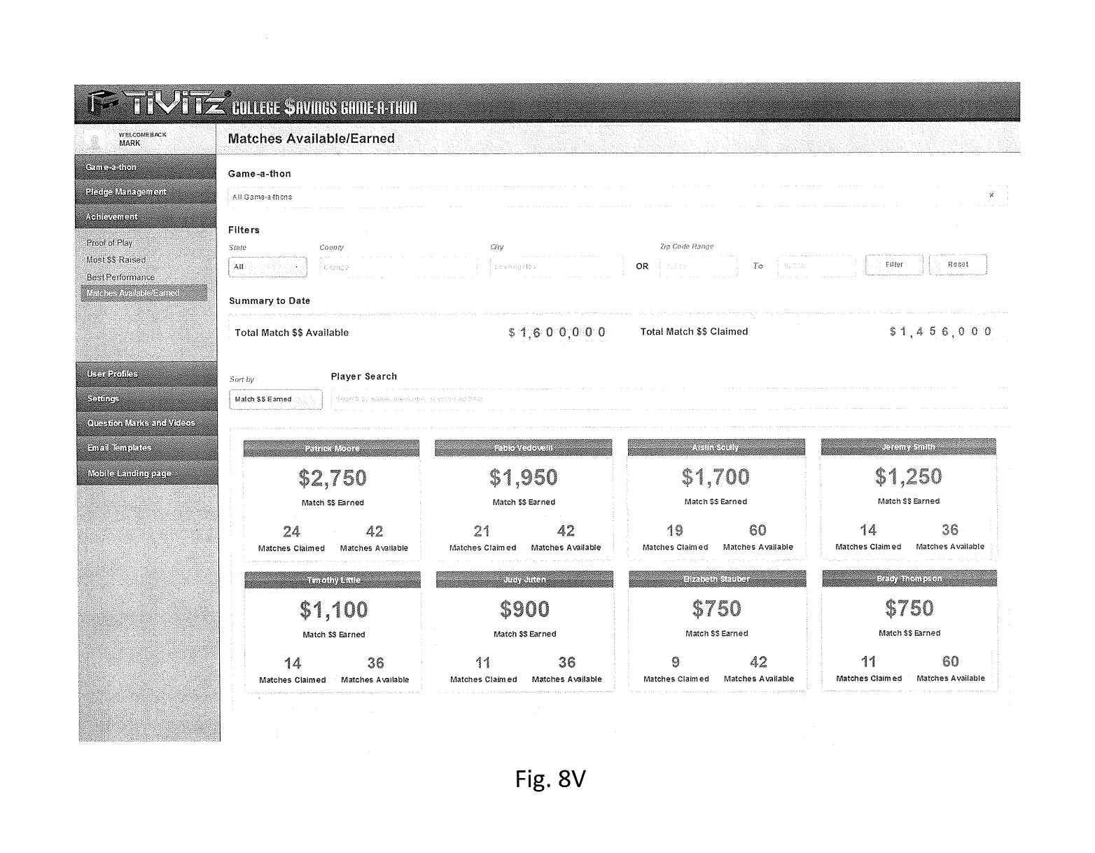

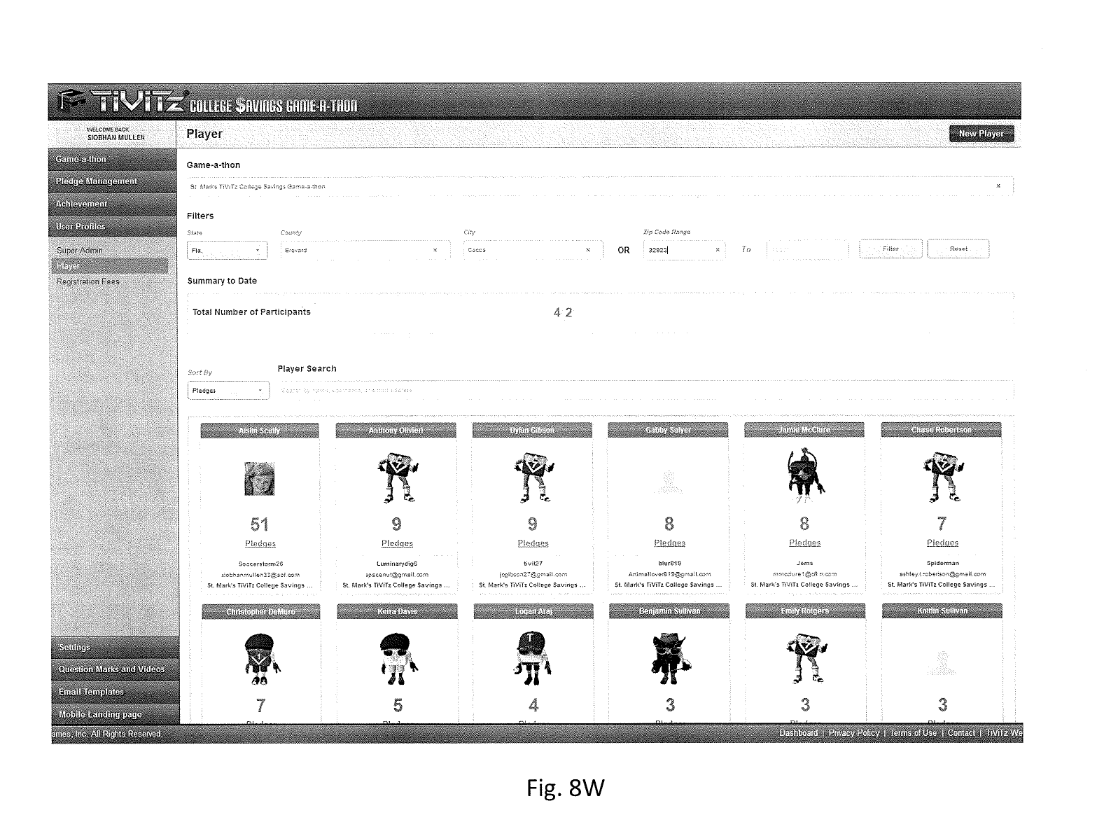

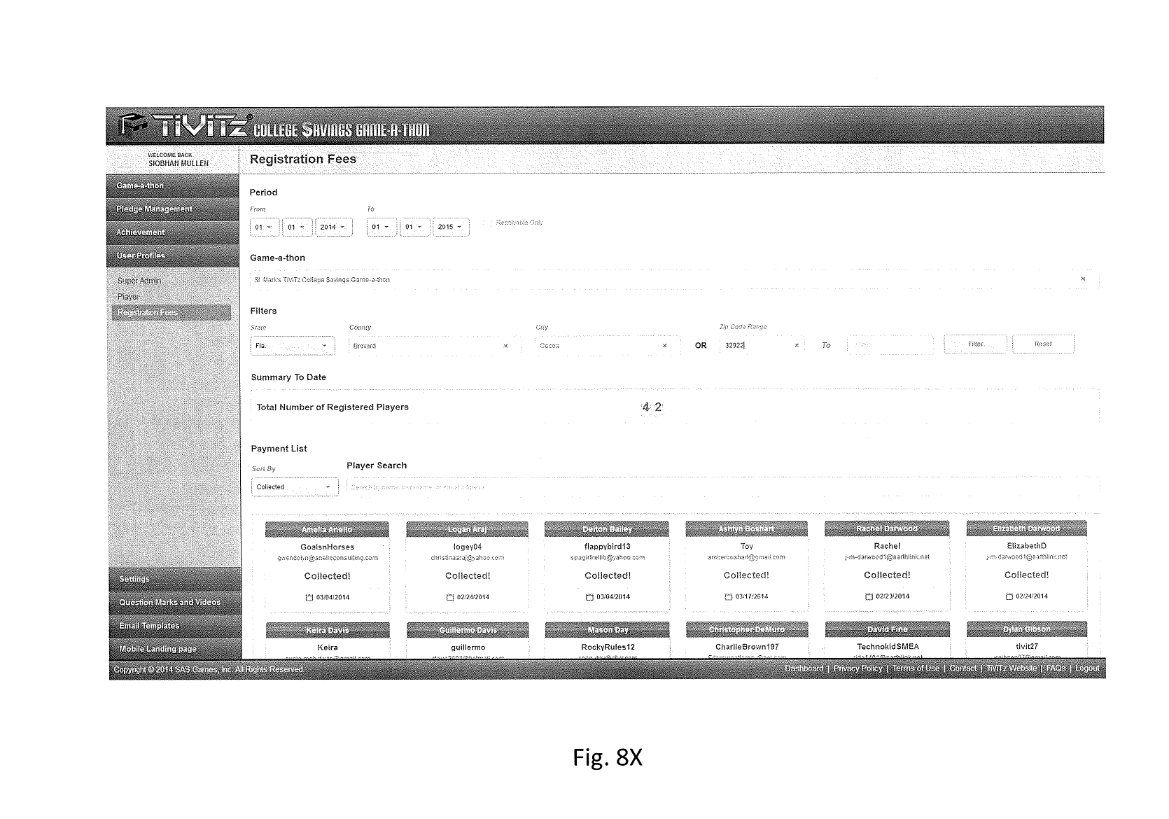

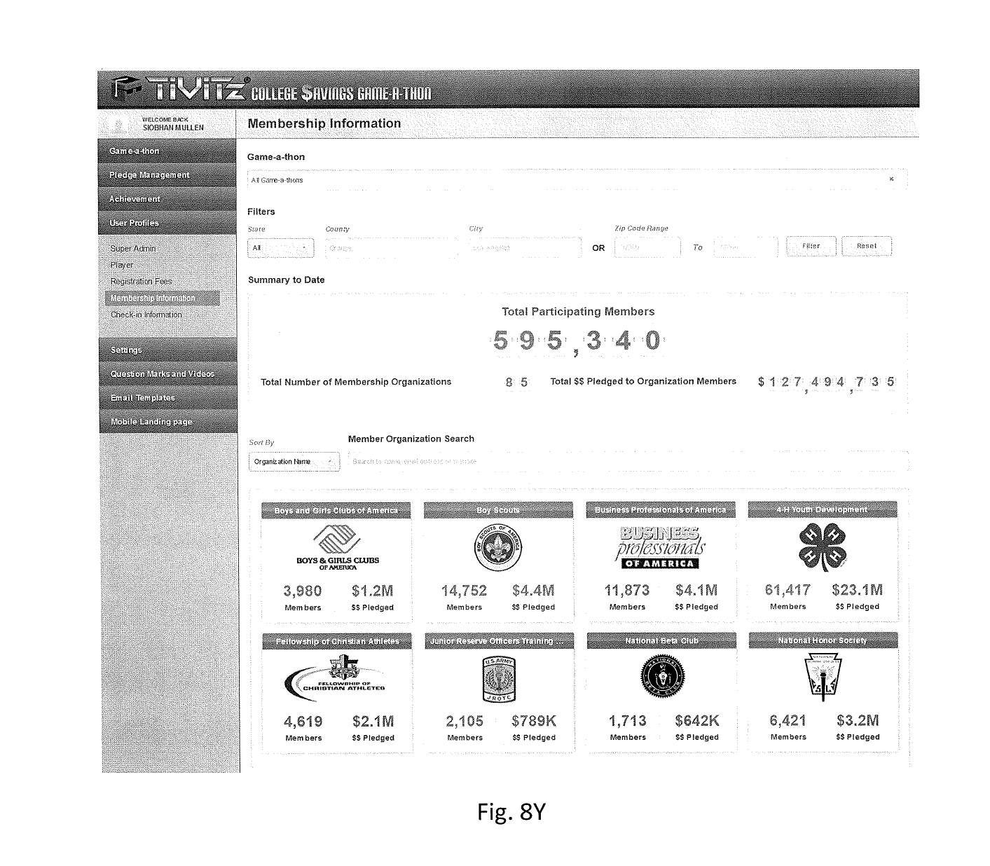

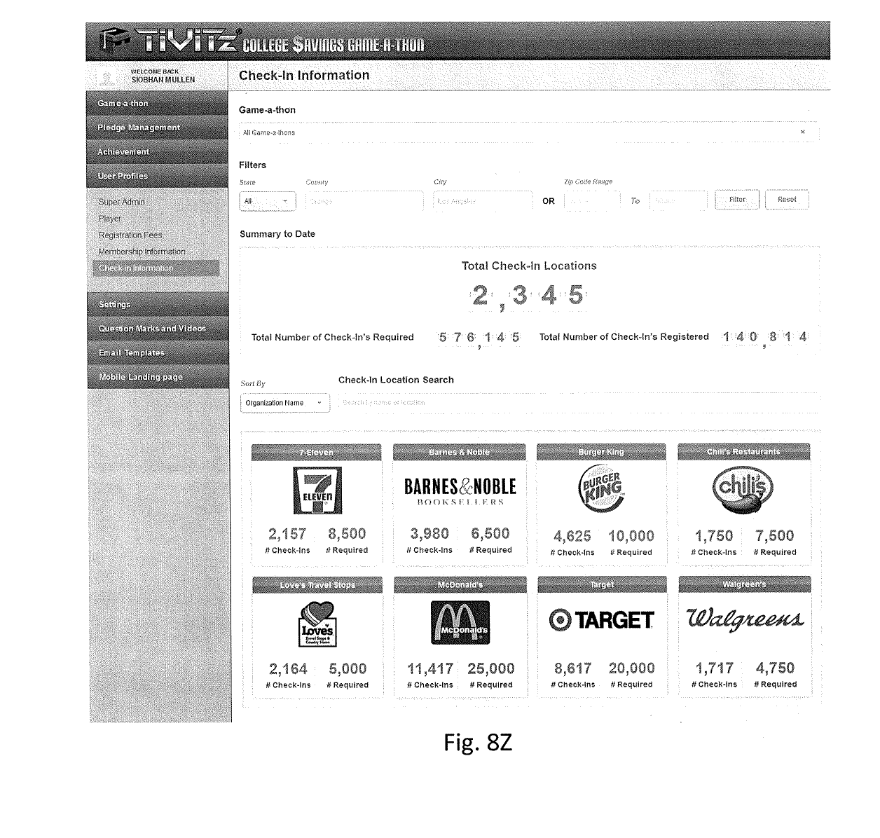

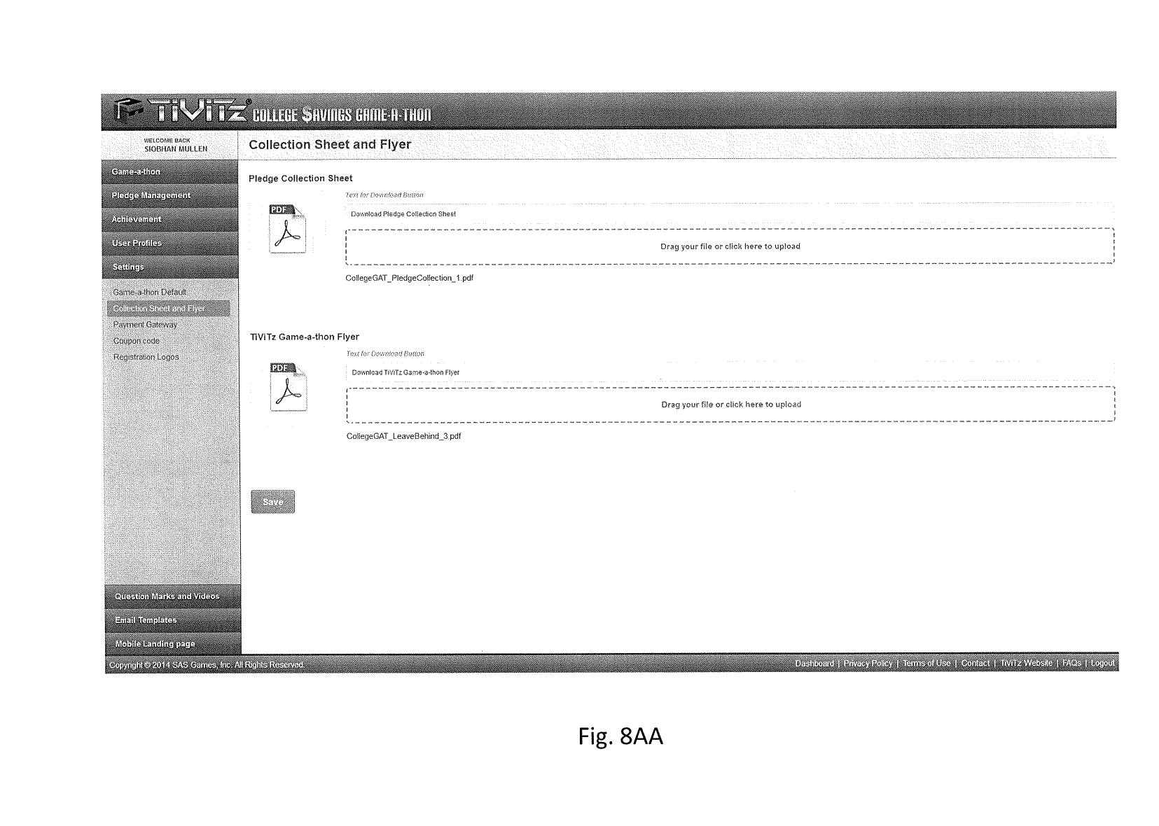

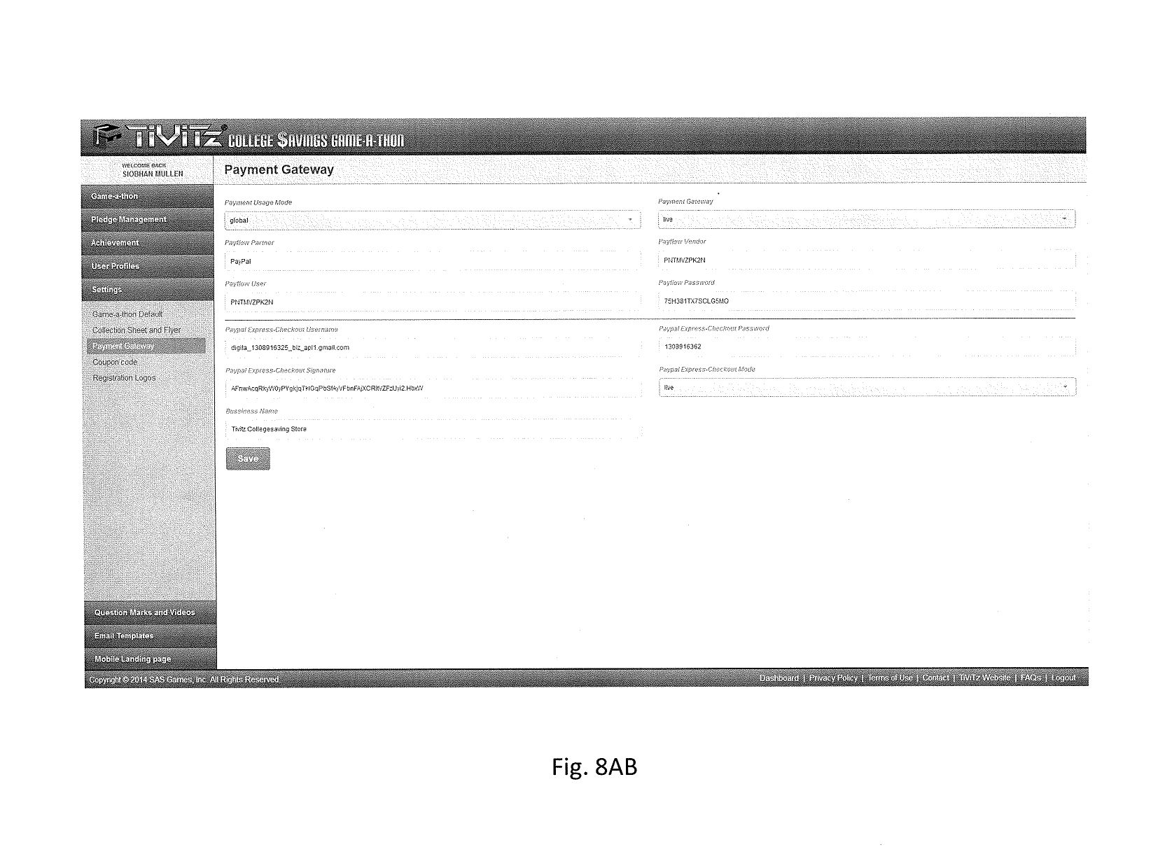

In addition, fundraiser management component 16 may receive participant information from one or more online components 10. For example, fundraiser management component 16 may receive participant registration information, pledges sent, pledges received, a total number of games played, a score for the games, a grade level for the game, match funds requested, and a number of pledges invoiced. Fundraiser management component 16 may perform one or more calculations on the participant information received and may generate reports for presentation on the participant component 10 and/or administrator component 12 based upon the calculations. For example, the reports may include a total number of funds collected, a total number of match funds collected, a total number of pledges outstanding, location of the pledge sponsors, and an average score of the games. A variety of reports may be generated by fundraiser management component 16, as illustrated, for example, in FIGS. 7A-7V and 8A-8AB.

Referring now to FIGS. 7A-7V, illustrated therein are example graphical user interfaces (GUI) screens illustrating exemplary implementations of participant interfaces in accordance with aspects of the present invention. In an aspect, after a participant registers for a gameathon, for example, using one or more registration interfaces, and prior to launching a gameathon, a participant may open a college savings account with a partner financial institution or may link an existing college savings account associated with a partner financial institution to the participant's gameathon so the funds raised during the gameathon may be automatically deposited into the participant's savings account. After the registration process, the participant may be directed to an interface, as illustrated in 7A, where the participant may open a college savings account with a partner financial institution or may link an existing college savings account associated with a partner financial institution to the gameathon. For example, the interface may be entitled “Final Step: Link Your College Savings Account.” For a participant to open a college savings account, the system may require that the participant enter a zip code and search for a gameathon with available partner financial institutions that service the zip code entered. The financial institutions associated with gameathons that the participant may be able to select from may include, for example, banks that may offer traditional savings accounts such as IRAs, credit unions that may offer savings accounts such as Uniform Gifts to Minors Act (UGMA)s or Uniform Transfers to Minors Act (UTMA)s, online banks that may offer savings vehicles such as trust funds, savings gift registries that may place funds in an account such as an escrow account until the funds are transferred to a college savings account, and investment banks that may place funds in savings accounts such as a money market account or 529 account.

Once a gameathon has been selected, the participant may be directed to an online site to open a college savings account. Alternatively, the participant may visit a participating financial institution associated with the selected gameathon to open a college savings account in person. After the participant has opened a college savings account or has an existing college savings account with a partner financial institution, the participant may launch the gameathon by logging into the website, for example, with the participant's username and password. A pop up interface, as illustrated in FIG. 7B, may appear requesting the participant to enter in the participant's college savings account information. The college savings account information may include, but is not limited to, account number, routing number, financial institution name, and account nickname. The college savings account information may be saved in the participant's profile and the participant may be directed to a personalized dashboard.

For example, FIG. 7C illustrates an example dashboard where a user, such as a participant or player may track the participant's gameathon's progress at a glance. The participant may use the navigational tabs (Dashboard, Pledge Management, Achievement, Profile Information) on the left and/or the participant may click on any one of the icons in the middle of the interface which represent an operation. The icons may allow the participant, for example, to view all of the participant's pledges, send more pledge requests, determine whether any pledges are triggered, resend any invoices not paid, view whether the participant earned any matches, and view how the participant compares against the other players. In the right panel, the participant may view the current year's college funds raised and collected to date less any processing and maintenance fees. Below the college funds, the current year's charity funds earned and collected may also be displayed. The participant may also select the arrow to view a total from a previous year or view a grand total collected over all years of participation using the gameathons. In addition, the most recent pledges of the total pledge amount to date may also be displayed, so that the participant may easily view any new pledges received.

FIG. 7D illustrates an example interface where a participant may view at a glance the total number of pledges and the total money pledged to date and of the total money pledged to date how much has been triggered by playing the required number of games. Triggered means that the invoice for pledge payment has been sent to the pledge sponsor. The money collected includes the total amount of triggered pledges that have been paid by the pledge sponsors to date, as well as the total amount of any match funding earned by the participant. This may also be viewed by number of pledges rather than by a dollar amount.

FIG. 7E illustrates an example interface illustrating the locations of pledge sponsors who have made pledges to the participant, so that a participant may easily view locations from where the pledges are coming. When a participant clicks on a particular state, the system zooms in on that state for a more detailed view of the state and of the locations of the pledge sponsors within that state. Illustrated in FIG. 7F is an example chart comparing the money pledged with the pledges triggered and/or invoiced, with the money collected and with the pledges still pending payment.

FIG. 7G illustrates an example pledge request management interface that allows the participant to solicit pledges for games played online by sending out pledge requests to potential pledge sponsors through multiple formats. The participant may add and view a personal message and greeting as an introduction to a standard pledge request email describing the gameathon. In addition, the participant may upload one or more email address books and/or add email addresses one at a time to solicit pledges. The participant may send personalized pledge requests to all or a portion of the friends and family email addresses appearing in the window. In addition, the participant may share a gameathon pledge link with friends and family directly through e-mail, Facebook, Twitter or any other social platform. A participant may send new pledge request emails at any time during the gameathon. A participant may also send out pledge requests via text message and/or collect pledges offline and input the pledge amount along with the pledge sponsor's email address for notification when the required games have triggered that pledge.

FIG. 7H illustrates an example pledge request e-mail. The pledge request e-mail may contain a summary description of the gameathon with a link to the website for additional information. The pledge request may also include a personalized introduction paragraph and greeting that may be sent to all of a participant's potential pledge sponsors or may be personalized to each potential pledge sponsor. The main description explaining the fundraiser of the pledge request e-mail may be customized by the administrator in the gameathon design. Logos may appear around the letter for sponsors of the gameathon or for charity organizations associated with the gameathon, as well as for corporate or foundation match sponsors providing match funding available for that particular participant based on the participant's zip code. When the pledge request email is received, the potential pledge sponsor may click on the blue “Click Here to Make a Pledge” button to make a pledge, as illustrated in FIG. 7I. A personalized pledge page for the participant may appear along with the pledge sponsor information pre-populated by the system. The pledge sponsor may slide the pledge amount bar for the pledge sponsor's selected pledge or enter another pledge amount. When the pledge sponsor selects a pledge amount, the number of games required to trigger the pledge appear below the bar. The pledge sponsor also has an option of sending a message of encouragement to the participant before submitting the pledge.

FIG. 7J illustrates an example interface summarizing the total number of pledge requests sent as well as the total number of pledges received and may include the percentage pledges received are of pledge requests sent to the pledge sponsors. The pledge requests list may illustrate all pledge requests sent, sorted by most recent date that the individual pledge request was sent to the pledge sponsor. The participant may also sort the pledge request sent pledge sponsor cards by ‘Pledged’ and ‘Not Pledged’ and by ‘Last Name’ of the pledge sponsor, for example. In addition, the participant may resend and/or delete any pledge requests sent. When a pledge request is resent to the pledge sponsor, the new date is also indicated on the card.

FIG. 7K illustrates an example pledge summary interface illustrating the total amount of money pledged to the participant, as well as the total number of pledge requests sent, total number of pledges received, and the number of games required to trigger all pledges and the total number of games played to date. The interface may also illustrate what percent pledges received are of pledge requests sent and what percent the number of games played is of games required to trigger all pledges. The pledge summary may be sorted, for example, by date, last name (of the pledge sponsor), dollar amount and trigger status. Trigger status may depict whether the required games have been played to trigger the pledge and whether the pledge payment invoice has been sent to the pledge sponsor.

FIG. 7L illustrates an example pledge payment request e-mail, text or other form of message. Once the participant has played enough games to trigger a pledge sponsor's pledge, a pledge payment request email may be automatically sent to the pledge sponsor. The pledge payment request may inform the pledge sponsor that the student has played the required games to trigger his pledge. The pledge sponsor may click on the “Click Here to Make a Payment” to see the participant's proof-of-play report, as illustrated, for example in FIG. 7P and to pay his pledge payment, as illustrated, for example in FIG. 7M. A pledge sponsor may be able to make his pledge payment using a credit card, debit card, checking account or account information and paypal account or other similar account, depending on the pledge sponsor's selection of payment method. After submitting a pledge payment, a pledge sponsor may also send a personalized congratulatory card to the participant. Logos on the pledge payment request and the pledge payment form may be the same logos customized for that participant in all pledge sponsor correspondence.

FIG. 7N illustrates an example pledge invoice report summarizing to date the total number of pledges, total dollar amounts pledged, total dollar amounts invoiced, total dollar amounts collected, total dollar amounts pending and total dollar amounts past due to date. Once pledges have been invoiced, a participant may view all pledge payment invoices collected, all pledge payment invoices pending, and all pledge payment invoices past due more than a defined period as a parameter of the gameathon, such as two weeks. A participant may also view and sort the pledge payment invoices in each category by, for example, date, last name and dollar amount. In addition, a participant may resend or delete any pending and/or past due pledge payment invoices. The participant may also view how the funds collected to date are distributed over the participant's college savings account, any charity organizations, any host sponsors, and a host organization for licensing or maintenance fees, as illustrated in FIG. 7O.

FIG. 7P illustrates example proof of play report pages illustrating the total number of games played by the participant and the participant's average score percent over all games played. The participant may also view and sort the games, for example, by score percent (percent of maximum score possible), date played, game level, and game sheet number. The proof-of-play report may demonstrate to the pledge sponsor that the participant has played the required games to trigger the pledge sponsor's pledge. In addition, additional information, such as a score percent of each game as well as a game level of each game may be needed to trigger any matching funds. If the participant has already played the maximum number of games required to trigger all of the participant's pledges, pledge payment invoices triggered as a result of required games played may be delayed an amount of time set as a parameter of the gameathon.

FIG. 7Q illustrates an example interface for match funding available in the participant's zip code. The participant may be automatically eligible for match funding and/or the participant may need to confirm eligibility for the match funding. The participant may click the ‘Check Eligibility’ button and may enter any necessary information to confirm eligibility for each match sponsor card. Information such as additional requirements to earn the match funding may also be displayed that may direct the participant to take other action to be eligible for the match funding. A participant may sort match funding available shown on the match sponsor cards, for example, by eligibility status, match sponsor name and individual match amount.

FIG. 7R illustrates example pop-up interfaces that may occur when the participant selects the “Check Eligibility” button. One interface indicates that no additional requirements are necessary to earn match funds beyond the fundraising requirement indicated on the match sponsor card. One interface indicates an additional requirement based on participant game play performance, for example, to be calculated by the system, is required to earn match funds. One interface indicates that an additional requirement of the participant providing information, such as membership in a children's organization is required to earn match funds. Once the participant provides the requested information, the information may be saved to the participant's profile and the participant is eligible for that match funding.

When a participant meets the requirements on the face of the match sponsor card, as well as any additional requirements for the match sponsor, the system may notify the participant that the participant has earned the match funding by email, text or other message. The system may also update an individual match from that match Sponsor in the participant's pledges and collected totals, as well as appearing on the participant's dashboard. The system may also indicate another individual match claimed from that particular match sponsor's account, so that the funds can be made available for the participant's college savings account.

FIG. 7S is an example interface illustrating top players by dollar amount collected from pledge payments in the participant's gameathon or across the country in all gameathons. For example, a participant may filter the top students by grade level, country, state, county, city or zip. A participant may also view and sort the filtered results by dollar amount, grade, city or state. The number of top players presented to the participant may be set by the administrator in the gameathon parameters.

In addition, the system may include an interface, as depicted in FIG. 7T, with the top players by game play performance in the participant's gameathon or across the country in all gameathons. Each game played may have a highest possible score (100%) and all games played by each of the top players may be averaged as a percentage of the highest score for an overall “Average Score.” Each player card may also have the total number of games played for the average score. For example, to qualify as a top player, the player must have at least played the number of games necessary to trigger all pledges in his gameathon. Results may be filtered, for example, by grade level, country, state, county, or zip code. The filtered results may then be sorted by average score, grade, city or state.

FIG. 7U illustrates an example membership information interface where a participant may select one or more organizations from, for example, a pull-down menu. The organizations included in the pull-down menu may include organizations in which the participant previously confirmed their membership to be eligible for match funding. The fields may be prefilled from the confirmation of eligibility for match funding. The existing information may be edited at any time.

FIG. 7V illustrates an example match sponsor check-in interface illustrating a number of check-ins that a participant made at local establishments or other locations associated with a corporate or foundation match sponsor. For example, the match funding may require a number of ‘check-ins’ for eligibility in addition to other requirements and to fundraising performance. In an aspect, the participant may use a wireless device, such as a smartphone or tablet and a QR code reader application. The participant may scan or otherwise read the QR code at the establishment or other location, sign-in with a username and password, and the system may update the sponsor check-ins overnight for display. When a certain number of check-ins are reached the participant may qualify for match funding.

In another aspect, a participant may receive a “Foursquare” alert or similar type of alert when entering a store, restaurant, or other location associated with a match sponsor stating, for example, “purchase an entrée valued at $12 or more and receive 250 MyCollegeSavingsRewards points.” MyCollegeSavingsRewards points may be accumulated, and when a participant's reward points reach a certain number, a participant may qualify for match funding. In still another aspect, a participant may purchase items such as cereal, toys and other products that may contain a MyCollegeSavingsRewards code to be entered into a gameathon interface to redeem for reward points that may be totaled to qualify for match funding.

Referring now to FIGS. 8A-8AB, illustrated therein are example graphical user interfaces (GUI) screens illustrating exemplary implementations of aspects of the present invention. FIG. 8A illustrates an example dashboard that allows an administrator user of the system to track all gameathons, for example, at a glance. The administrator may use the navigational tabs (e.g., Dashboard, Game-a-thon, Pledge Management, Achievement, User Profiles, Settings, Question Marks and Videos, Email Templates, Mobile Landing Page) on the left and/or the administrator may click on any one of the icons. The icons may allow the administrator to view each registered gameathon, add additional partner financial institutions for specific gameathons and add additional corporate and foundation match sponsors for specific gameathons, as well as add additional charity organizations and host sponsors. In the right panel at the top, the administrator may view the total number of participants in all gameathons, as well as the total number of pledge requests sent out by the participants in all gameathons and of those the total number of pledges made. The administrator may also view the summary of the total funds pledged and total funds collected from the pledges by all participants in all gameathons, as well as what portion of those collected funds may be distributed to the participants' college savings and to charity organizations. The administrator may also view the collected funds distributed to the company or organization hosting the gameathon, as well as the total match funds available for all gameathons and of those match funds available the amount of funds that has been claimed and the amount of funds that remains unclaimed. The administrator may also be able to view the number of games required be played by all participants in all gameathons to trigger all pledges, as well as the total games played to date by those participants. The administrator may also view the most games played by a single participant, as well as the most funds raised by a single participant.

FIG. 8B illustrates an example interface with a summary of the total number of pledges and the total amount of funds pledged to date across all gameathons (for all participants) and of the total amount of funds pledged how much has been triggered by playing the required number of games. Triggered may include the invoice for pledge payment has been sent to the pledge sponsor. For example, the “$$ Invoiced” may represent the total funds pledged that have been triggered. The “$$ Collected” may represent the total amount of triggered pledges that have been paid by the pledge sponsors to date. The total amount of triggered pledges and collected pledges may also be illustrated by a number of pledges rather than a dollar amount.

FIG. 8C illustrates an example map with the location of pledge sponsors across all gameathons who have made pledges to participants. As such, the administrator may view at a glance from where pledges are coming. The map may include icon or abbreviation to designate number of pledges by thousands, ten thousands, hundred thousands and millions. In addition, the map may include a zoom capability so the administrator may click on a state for more detail of the state to view pledges by city and region in much more detail and not just by state.

FIG. 8D illustrates an example chart comparing the total funds pledged across all gameathons with the total funds that have been triggered/invoiced across all gameathons, with the total funds that have been collected across all gameathons and with the total funds still pending payment across all gameathons. The administrator may be able to view this comparison by month or cumulatively over all gameathons.

FIG. 8E illustrates an example gameathon status interface that may allow an administrator to view all registered gameathons or to search for a specific gameathon. The administrator may filter registered gameathons by country, state, county, city and zip code and may be able to sort the results of the filter. Each gameathon card may display the name of the gameathon, a logo of an associated financial institution, a logo of an associated charity organization or a logo of an associated host sponsor, as well as a status of the gameathon (e.g., active with an expiration date). The card for a gameathon may provide the administrator information, such as the total funds pledged and the total match funds contributed, as well as the total amount of funds collected, including pledged funds and match funds, and the funds distributed to the participants' accounts, to any charity organizations, to any host sponsors and to a corporation or host organization executing the gameathon for any licensing or maintenance fees.

FIG. 8F illustrates an example interface for designing a gameathon. For example, the administrator may design a new gameathon for the general public or for a specific group, such as a children's organization. The administrator may select a name for the gameathon and may select a financial institution that will be associated with the gameathon, as well as determining the start and end dates for the fundraiser. The administrator may also select a charity organization that may be associated with the gameathon, such as Ronald McDonald House, for which the participants may raise funds in addition to for their college savings. In addition, the administrator may be able to select a specific entity or children's organization, also referred to as a host sponsor, such as Scouts or 4H, to be associated with the gameathon for which the participants may raise funds in addition to for their college savings. The “Sharing Levels” may allow the administrator to determine how the total collected funds of the specific gameathon will be divided (after processing fees) between the participants' college savings accounts, the charity organization (if applicable), the host sponsor (if applicable) and the corporation or host organization executing the gameathon. The distribution of funds may be scheduled by the administrator, for example, up to four times per month. In addition, the administrator may set the percentage of the funds collected that cover the processing fees and determine how the selected percentage may be spread over the receiving entities. The administrator may also set the amount of the registration fee for a particular gameathon.

FIG. 8G illustrates an example interface where an administrator may set the pledge amount suggestions that will appear in the pledge solicitation emails or other message types to the pledge sponsors and on the “Make a Pledge” page from the link in the solicitation email or other message. The administrator may select the minimum and maximum pledge amounts that may appear on the sliding bar with the increments the pledge sponsor may view. The administrator may also set a number of games played that are required to trigger the pledges. The number of games played may be based on a formula. For example, the formula may determine what number of games played may trigger a value of pledge dollars. The administrator may also set a maximum number of games played that are required to trigger all pledges above a certain amount. The administrator may also determine an additional number of games played that may be necessary to trigger a larger than maximum pledge based, for example, on the incremental size of the pledge. The administrator may also determine a certain number of days before a gameathon ends to send notifications to all pledge sponsors that have not yet paid their invoices to remind the pledge sponsors to make a pledge payment. The administrator may also input any number, for example, up to ten corporate, partner or sponsor logos that may include the financial institution, any charity organizations and any host sponsors associated with the gameathon and that will appear on all the pledge sponsor correspondence for that gameathon. Any remaining logo positions may be filled by match sponsor logos.

FIG. 8H illustrates an example interface that allows an administrator to view the partner financial institutions available for a gameathon and/or to search for a specific financial institution that may be available for a gameathon. Financial institutions may include banks, credit unions, online banks, investment banks and savings registries, among others. The financial institutions may be filtered by country, state, county, city and zip code. The financial institution cards may include information, such as the name and logo of the entity along with the contact and headquarters information. The administrator may be able to add a new financial institution, as illustrated in FIG. 8I. In addition to the information presented on the financial institution cards for a new financial institution, the administrator may also input the zip code coverage for providing financial services such as college savings accounts and the payment gateway information for collecting and transferring funds to designated accounts for the participants of the gameathon.

FIG. 8J illustrates an example interface where an administrator may view all match sponsors across all gameathons or across a specific gameathon. The match sponsors may be filtered by country, state, county, city and zip code. The “Summary to Date” may illustrate the total match funds available as a result of that filter and of the total match funds available how many funds have been claimed and the amount of funds that remain unclaimed. The administrator may also search for a particular match sponsor. The match sponsor cards may include the name and logo of the entity, the total match funds available from that match sponsor across all gameathons or for a specific gameathon depending on the filter, the value of an individual match, how many individual matches are available to make up the total match fund, how many of those individual matches have been claimed and how many remain unclaimed. The match sponsor cards may also include an ability to download a QR code, or other relevant info such as MyCollegeSavingsRewards codes, which may be used on promotional materials for that particular match sponsor and may be included in any requirements involved to obtain a match.

FIGS. 8K and 8L illustrate example interfaces for an administrator to add a new match sponsor. For example, the administrator may input the corporate or foundation organization contact information, as well as the zip code range that the matches will cover. The administrator may also input the match sponsor's rules for a participant to obtain one of its individual matches. Rules may include, for example, a number of participants that will receive a match, the value of an individual match, the amount of funds the participant needs to collect from pledge sponsors before a match can be triggered or earned, membership in a particular organization (e.g., Scouts, 4H), completion of a certain number of games at the participant's grade level, completion of a certain number of games above the participant's grade level, a score average above a certain percent across a certain number of games played, visitation (check ins) by the participant a certain number of times at a match sponsor's place of business or other designated location (e.g., McDonald's, 7-11 stores), as well as any other forms of proof of trigger for the requirements of the match funding. The administrator may also be able to input the match sponsor's logo to appear in the pledge sponsor correspondence.

The administrator may also input new charity organizations that may be displayed in a similar manner to the match sponsors under a “Charity Organizations” subtab. The charity organization interface may allow an administrator to view the partner charity organizations associated with a gameathon and/or to search for a specific charity organization that may be associated with a gameathon. The charity organizations may be filtered, for example, by country, state, county, city and zip code. Based on the filter, the “Summary to Date” may include all funds collected for all charity organizations across all gameathons or a specific gameathon, as well as a percentage of total funds collected. The resulting charity organization cards may include information, such as the name and logo of the entity along with the contact and headquarters information, as well as all funds collected to date by that charity organization and also as a percentage of total funds collected by the gameathon.

The administrator may also input new host sponsors that may be displayed in a similar manner to the match sponsors under a “Host Sponsors” subtab. The host sponsor interface may allow an administrator to view the partner host sponsors associated with a gameathon and/or to search for a specific host sponsors that may be associated with a gameathon. The host sponsors may be filtered by country, state, county, city and zip code, for example. Based on the filter, the “Summary to Date” may include all funds collected for host sponsors across all gameathons or a specific gameathon, as well as a percentage of total funds collected. The resulting host sponsors cards may include information, such as the name and logo of the entity along with the contact and headquarters information, as well as all funds collected to date by that host sponsor and also as a percentage of total funds collected by the gameathon.

FIG. 8M illustrates an example pledge summary interface that may allow an administrator to view all registered gameathons and/or search for a specific gameathon. The administrator may filter gameathons, for example, by country, state, county, city and zip code. In the “Summary to Date” of the filtered results, the administrator may view at a glance the total funds pledged to the participants, as well as the total number of pledge requests sent, total number of pledges received (as well as by percentage of pledge requests sent, which may also appear on the Dashboard for all gameathons), games required to trigger all pledges and total games played to date (as well as by percentage of games required to trigger all pledges, which may also appear on the Dashboard for all gameathons). In an aspect, the Summary to Date may present player cards based on the filter. Each player card may show the total funds pledged to an individual participant, as well as the number of pledge requests sent out by the participant and a number of pledges received by the participant (and may also be shown by percentage of pledge requests sent). The administrator may also view and sort player cards by name, total pledged, pledge requests and pledges made, for example. When the administrator selects a player card and/or searches for a specific participant, the participant's individual pledge summary report appears, which may be the same pledge summary the participant may view as illustrated in FIG. 8N.

FIG. 8O illustrates example pledge requests interfaces that may allow the administrator to view the pledge requests of all registered gameathons and/or to search for a specific gameathon. The administrator may also filter registered gameathons by country, state, county, city and zip code. In the “Summary to Date” of the filtered results, the administrator my view at a glance the total number of pledge requests sent and the total number of pledges received (and may also be shown by percentage of pledge requests sent, as may be shown on the Dashboard for all gameathons). The results below the Summary to Date may return player cards based on the filter. Each player card may show the number of pledge requests sent by a participant and of those pledge requests sent the number of pledges received (and may also be shown by percentage of pledge requests sent). The administrator may also sort player cards by name, pledge requests and pledges made. When the administrator selects a player card and/or searches for a specific participant, the participant's individual pledge request sent report appears, which may be the same pledge request sent the participant may view as illustrated in FIG. 7J.

FIG. 8P illustrates an example pledge invoice interface that may allow an administrator to view the pledge invoice report of all gameathons and/or to search for a specific gameathon. The administrator may filter the gameathons by country, state, county, city and zip code, for example. In the “Summary to Date” of the filtered results, the administrator may view the total number of pledges and total amount of funds that have been pledged to the participants, as well as what funds have been triggered/invoiced by games played (which may include a percentage of all funds pledged). The administrator may also view of the triggered/invoiced pledges the amount collected (as well as by percentage of pledges invoiced), the amount waiting payment (as well as by percentage of pledges invoiced), and the amount that has not been paid and is past due (as well as by percentage of pledges invoiced). The administrator may also view the distribution of the funds collected to all receiving entities such as the participants' college savings, any associated charity organization, any associated host sponsor and the host organization for any licensing or maintenance fees. The results below the “Summary to Date” may return player cards based on the filter. Each player card may illustrate the total funds pledged to that participant, as well as the amount triggered/invoiced, the amount collected and is the amount pending payment. The administrator may sort player cards, for example, by name, total pledged, total invoiced, total collected, total pending. When the administrator selects a player card and/or searches for a specific participant, the participant's individual pledge invoice report appears, which may be the same pledge invoice the participant may view as illustrated in FIG. 7N.

FIG. 8Q illustrates an example interface for viewing a fund deposit report of all gameathons and/or search for a specific gameathon. The administrator may filter gameathons by country, state, county, city and zip code and then sort the fund deposit report results of the filter. In the “Summary to Date” of the filtered results, the administrator may view the total funds pledged and the total funds invoiced (e.g., triggered by game play requirements) and of the total funds invoiced (by dollar amount and by percentage) what amount has been collected/deposited (by dollar amount and by percentage) and what amounts are pending or past due (by dollar amount and by percentage). For example, the totals for each category may be presented as amount and as percentages for the participants' college funds, charity organizations, host sponsors and the host organization executing the gameathon. The processing fees (e.g., credit card processing, bank processing and software maintenance) are calculated as a percentage of funds collected and may be spread by percentage over all receiving entities of the collected funds. In an aspect, both percentages may be a default setting of the gameathon or customized by the administrator. In addition, the system may provide the pledge sponsors an opportunity to pay the processing fees when making their pledge payments, so that the receiving entities may receive their portion of the full amount pledged.

FIG. 8R illustrates an interface that may allow an administrator to search for a specific participant in any gameathon and retrieve the participant's information, such as, name, username, email address and gameathon with the ability to make a pledge to the participant. The administrator may make a manual pledge, without solicitation, in the name of any particular pledge sponsor, match sponsor, host sponsor or in the name of the host organization executing the gameathon or of any other entity. The administrator may also have the ability to pay that pledge immediately. This submit pledge operation may be used for a dispute settlement, missing pledge payment, missing match sponsor payment, technology issue and/or other negotiation.

FIG. 8S illustrates an interface with a proof of play report. The administrator may view the proof of play report of all registered gameathons displayed and/or search for a specific gameathon. The administrator may also filter registered gameathons by country, state, county, city and zip code and then sort the proof of play report results of the filter, for example. Based on the filtered results, the administrator may view the total number of games played by all participating players, as well as the average score over all games for all participating players, in the “Summary to Date.” The results below the “Summary to Date” may return player cards based on the filter. Each player card may show the total number of games played, the grade level of the participant, and the average score over all games played at the participant's game level or above. The administrator may sort player cards, for example, by games played, grade level and score. In an aspect, when the administrator selects a player card or a pledge sponsor clicks on “Proof of Play” in a pledge payment request email or other message, a report for the participant with all games played since the gameathon began on a specific date may be displayed as indicated in FIG. 7P. Thus, the pledge sponsor may understand without looking at all the dates that the student did not ‘wait’ for all pledges to be made to start playing games. If the participant has already played the maximum number of games required to trigger all the participant's pledges, pledge payment invoices triggered as a result of required games played may be delayed. Delivery schedule of pledge payment invoices may be determined by the administrator as a parameter of the gameathon.

FIG. 8T illustrates an example interface that allows the administrator to view the most money raised report of all gameathons and/or search for a specific gameathon. The administrator may also filter gameathons, for example, by country, state, county, city and zip code and sort the most money raised report results of the filter. Based on the filtered results, the administrator may view the total funds collected by all participating players in the “Summary to Date.” The results below the “Summary to Date” may return ranked player cards based on the filter. The number of player cards returned may be set by the administrator. Each player card may illustrate the participant's ranking and total funds raised (e.g., collected), as well as, for example, the participant's grade level, city and state. The administrator may sort player cards by money amount, grade, city and state, for example. In an aspect, when the administrator selects a player card and/or searches for a specific participant, the participant's individual pledge invoice report may be the same pledge invoice report the participant may view as indicated in FIG. 7N

FIG. 8U illustrates an example interface where an administrator may view a best performance report of all gameathons and/or search for a specific gameathon. The administrator may filter the gameathons by country, state, county, city and zip code and then sort the best performance report results of the filter, for example. Based on the filtered results, the administrator may view the average score over all games played, as well as the total number of all games played by all participating players in the “Summary to Date.” The results below the “Summary to Date” return ranked player cards based on the filter. The number of player cards returned may be set by the administrator. Each player card may illustrate, for example, the participant's ranking and average score over all games and number of games played, as well as the participant's grade level, city and state. The administrator may sort player cards, for example, by dollar amount games played, grade, city and state. In an aspect, a participant must have played the maximum number of games required to trigger all pledges in a gameathon in order to be included in the best performance report. In an aspect, when the administrator selects a player card and/or searches for a specific participant, the participant's individual proof of play report may be the same proof of play report the participant may view as indicated in FIG. 7P.

FIG. 8V illustrates an example interface where an administrator may view the matches available and earned for all gameathons and/or search for a specific gameathon. The administrator may filter the gameathons by country, state, county, city and zip code and may sort the matches available and earned as results of the filter, for example. Based on the filtered results, the administrator may view the total match funds available, as well as the total match funds claimed and unclaimed, and the total number of individual matches available, as well as the number of individual matches claimed and unclaimed, by all participating participants in the “Summary to Date.” The results below the “Summary to Date” may return player cards based on the filter. The player cards may illustrate, for example, the total match funds and the number of individual match funds available to the participant and the total match funds and the number of individual match funds earned by the participant based on the participant's zip code. The administrator may sort the player cards, for example, by name, match funds available, match funds earned, number of individual match funds available and number of individual match funds earned. In an aspect, when the administrator selects a player card and/or searches for a specific participant, a pop-up interface may be provided with a list of all individual match funds available to the participant and all individual match funds earned by the participant.

FIG. 8W illustrates an example interface that allows an administrator to view the participant profiles of the gameathons and/or search for a specific gameathon. The administrator may, for example, filter registered gameathons by country, state, county, city and zip code and sort the participant profile results of the filter. The “Summary to Date” may allow the administrator to view the total number of all participating participants. The results below the “Summary to Date” may return player cards based on the filter. The player card may illustrate participant information, such as, the participant's name, username, gameathon, email address and number of pledges.

A participant's profile can be deleted and/or edited by the administrator. When the administrator selects to edit the participant profile, for example, by selecting an edit link on the backside of the player card and/or searches for a specific participant, participant's individual participant profile report may be retrieved. The participant profile may be the same participant profile that the participant may view including, for example, account information, student information, parent/guardian contact information, savings account information, membership information, “check in” accounting, and matches earned information.

FIG. 8X illustrates an example interface for viewing the registration fees of all gameathons and/or searching for a specific gameathon. For example, the administrator may filter gameathons by country, state, county, city and zip code and sort the registration fee results. Based on the filtered results, the “Summary to Date” may allow the administrator to view the total number of participating participants, as well as the total dollar amount of registration fees paid by the participants. The results below the “Summary to Date” may return player cards based on the filter. Each player card may illustrate the participant's name, gameathon, username, email address, registration fee status (e.g., collected or pending) and date of payment. In an aspect, the administrator may set the registration fee as a setting for each gameathon and/or the registration fee may be included as a default setting for a gameathon. For example, the registration may be an annual fee of ten dollars or any other amount. The administration may provide the participant an option to waive the registration fee and have the registration fee be removed from the first collected pledges. In addition, the administrator may be able to view whether the registration fee for a particular gameathon has been paid, for example, by a host sponsor or children's organization for all participating participants that are members of that organization.

FIG. 8Y illustrates an example interface where an administrator may view the membership information for all gameathons and/or search for a specific gameathon. The administrator may filter the gameathons by country, state, county, city and zip code and may sort membership information results of the filter, for example. Based on the filtered results, the administrator may view the number of membership organizations, as well as the total number of gameathon participants that are members in those membership organizations in the “Summary to Date”. The results below the “Summary to Date” may return all associated membership organizations based on the filter. The membership organization cards may illustrate, for example, the total number of gameathon participants that are members of its organization. The administrator may sort the membership organization cards, for example, by name and number of gameathon participant members.

FIG. 8Z illustrates an example interface where an administrator may view the check-in information for all gameathons and/or search for a specific gameathon. The administrator may filter the gameathons by country, state, county, city and zip code and sort the check-in information results of the filter, for example. Based on the filtered results, the administrator may view the total number of check-in locations required by match sponsors, to trigger all matches and the total number of check-ins registered by all participating participants in the “Summary to Date.” The results below the “Summary to Date” may return check-in location cards with the associated match sponsors based on the filter. The check-in location cards may illustrate, for example, the number of check-ins required to trigger all matches for that check-in location and the number of check-ins registered by all participating participants for that check-in location. The administrator may sort the check-in location, for example, by location name, check-ins required and check-ins registered.

FIG. 8AA illustrates an example interface where an administrator may edit the existing collection sheet and flyer, upload new documents, and/or change the title of available documents in the participant application. The documents may be used by the participants to solicit pledges door-to-door from family, friends and neighbors and/or collect email addresses to manually input pledge amounts.

FIG. 8AB illustrates an example interface where payment gateway information for gameathons may be stored. For example, the administrator may be able to select a gameathon by using the standard filter for this application and view the gateway information for the associated and/or selected financial institution for that gameathon. Administrators may select an independent payment gateway of a financial institution or other entity that is different from that of the specific financial institution associated with a particular gameathon.

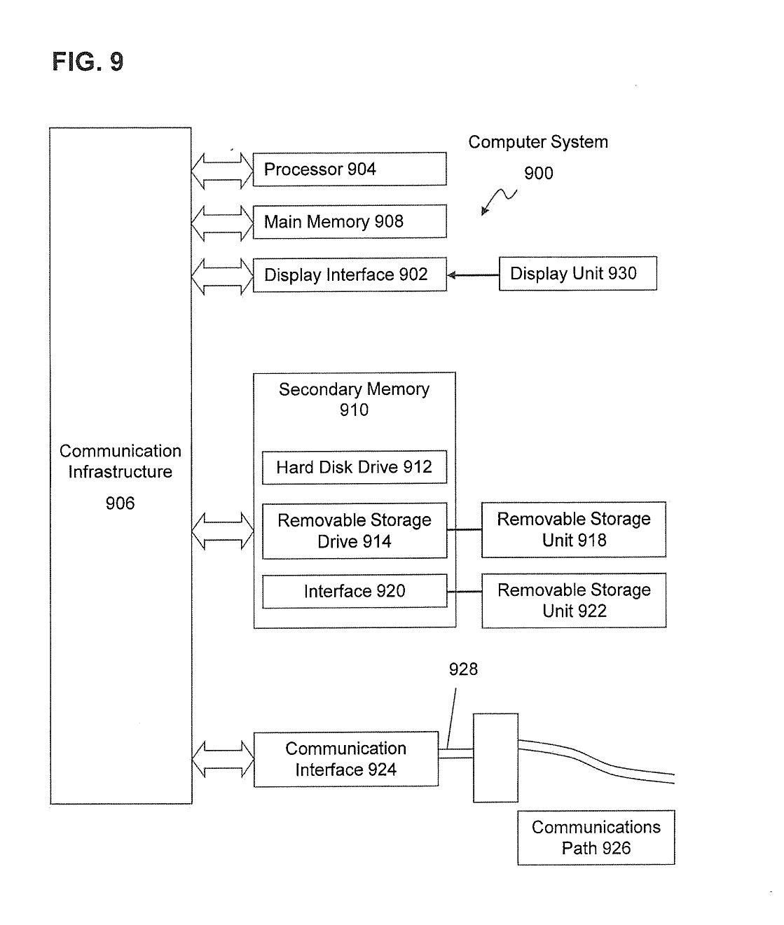

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 900 is shown in FIG. 9.

Computer system 900 includes one or more processors, such as processor 904. The processor 904 is connected to a communication infrastructure 906 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, a universal serial bus (USB) flash drive, etc. The removable storage drive 914 reads from and/or writes to a removable storage unit 918 in a well-known manner. Removable storage unit 918 represents a floppy disk, magnetic tape, optical disk, USB flash drive, etc., which is read by and written to removable storage drive 914. As will be appreciated, the removable storage unit 918 includes a computer usable storage medium having stored therein computer software and/or data.

Alternative aspects of the present invention may include secondary memory 910 and may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features in accordance with aspects of the present invention, as discussed herein. In particular, the computer programs, when executed, enable the processor 904 to perform the features in accordance with aspects of the present invention. Accordingly, such computer programs represent controllers of the computer system 900.

In an aspect of the present invention where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, the invention is implemented using a combination of both hardware and software.

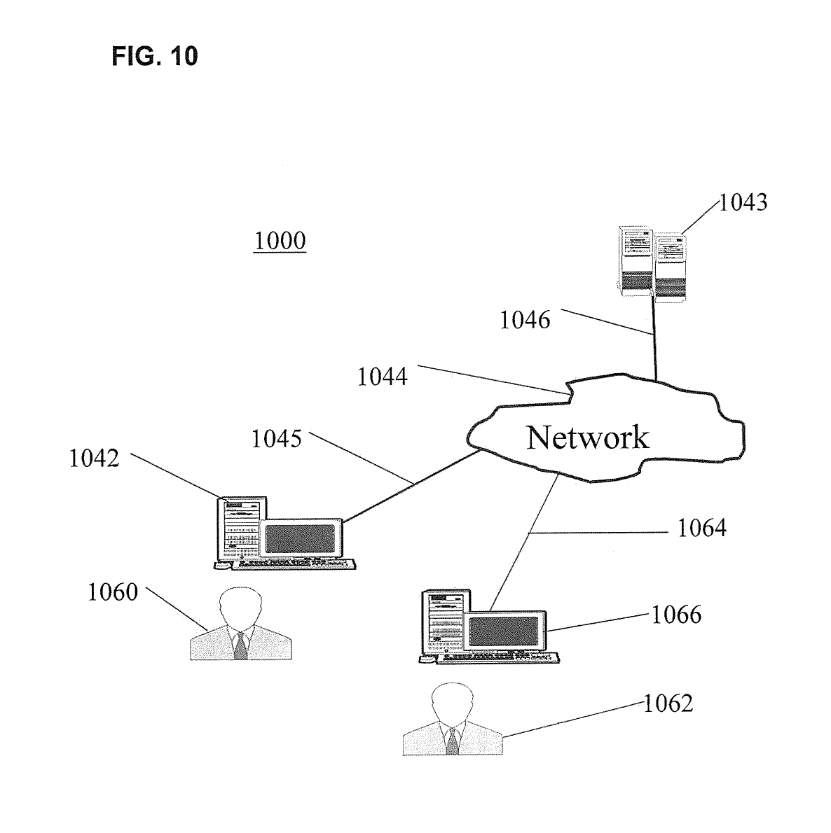

FIG. 10 shows a communication system 1000 usable in accordance with aspects of the present invention. The communication system 1000 includes one or more accessors 1060, 1062 (also referred to interchangeably herein as one or more “users”) and one or more terminals 1042, 1066. In one aspect of the present invention, data for use is, for example, input and/or accessed by accessors 1060, 1064 via terminals 1042, 1066, such as personal computers (PCs), minicomputers or tablet computers, mainframe computers, microcomputers, telephonic devices, or wireless devices, such as personal digital assistants (“PDAs”) or a hand-held wireless devices coupled to a server 1043, such as a PC, minicomputer or tablet computer, mainframe computer, microcomputer, or other device having a processor and a repository for data and/or connection to a repository for data, via, for example, a network 1044, such as the Internet or an intranet, and couplings 1045, 1046, 1044. The couplings 1045, 1046, 1064 include, for example, wired, wireless, or fiberoptic links. In another aspect of the present invention, the method and system of the present invention operate in a stand-alone environment, such as on a single terminal.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

1. A method for an online fundraiser, comprising:
receiving a solicited pledge;
receiving an indication that the pledge has been triggered;
collecting payment of the pledge; and
disbursing the collected payment.

2. The method of claim 1, wherein the solicited pledge is solicited over a network.

3. The method of claim 1, further comprising:
receiving a registration for soliciting pledges.

4. The method of claim 1, wherein the collected payment is disbursed to an account.

5. The method of claim 4, wherein the account is a savings vehicle.

6. The method of claim 5, wherein the savings vehicle is a 529 Plan, a Coverdell Education Savings Account, a Uniform Gifts to Minors Act (UGMA) account, a Uniform Transfers to Minors Act (UTMA) account, or an Individual Retirement Account (IRA).

7. The method of claim 1, wherein a portion of the disbursed collected payment is disbursed to one selected from a group consisting of a single party and multiple parties.

8. The method of claim 7, wherein the percentage is disbursed to multiple parties in a tiered manner.

9. The method of claim 1, wherein the indication that the pledge has been triggered comprises playing a game, competing in a competition, completing a survey, or checking in at a location.

10. The method of claim 1, further comprising:
receiving, from a match sponsor, conditions for matching pledges.

11. The method of claim 1, wherein collecting payment of the pledge may be managed by a solicitor of the pledge or a participant.

12. The method of claim 1, further comprising:
receiving proof of collected payment of the pledge.

13. The method of claim 1, further comprising:
providing proof that the pledge has been triggered and providing an invoice for payment of the pledge.

14. A system for an online fundraiser, comprising:
a component comprising hardware configured to receive a solicited pledge;
a component comprising hardware configured to receive an indication that the pledge has been triggered;
a component comprising hardware configured to collect payment of the pledge; and
a component comprising hardware configured to disburse the collected payment.

15. An apparatus for an online fundraiser, comprising:
a memory in communication with a processor
wherein the processor is configured to:
receive a solicited pledge;
receive an indication that the pledge has been triggered;
collect payment of the pledge; and
disburse the collected payment.

16. The system of claim 15, wherein the solicited pledge is solicited over a network.

17. The system of claim 15, wherein the collected payment is disbursed to an account.

18. The system of claim 15, wherein the indication that the pledge has been triggered comprises playing a game, competing in a competition, completing a survey, or checking in at a location.

19. The system of claim 15, wherein the processor is further configured to:
receive, from a match sponsor, conditions for matching pledges.

20. A computer program product, comprising:
a computer-readable medium comprising:
at least one instruction for causing a computer to receive a solicited pledge;
at least one instruction for causing the computer to receive an indication that the pledge has been triggered;
at least one instruction for causing the computer to collect payment of the pledge; and
at least one instruction for causing the computer to disburse the collected payment.
